(19) United States
(12) Patent Application Publication
(10) Pub. No.: US 2021/0209197 A1
(43) Pub. Date: Jul. 8, 2021

(54) APPARATUS AND METHOD FOR FRAND LICENSING AND TRANSACTION COSTS FOR MORE INDIVIDUAL LICENSE AGREEMENTS THROUGH SMART CONTRACTS ON THE BASIS OF BLOCKCHAIN TECHNOLOGY

(71) Applicant: JONAS BLOCK, DUSSELDORF (DE)

(72) Inventor: JONAS BLOCK, DUSSELDORF (DE)

(21) Appl. No.: 17/124,299

(22) Filed: Dec. 16, 2020

Related U.S. Application Data
(60) Provisional application No. 62/949,395, filed on Dec. 17, 2019.
(60) Provisional application No. 63/019,070, filed on May 1, 2020.

(51) Int. Cl. G06F 21/10; G06F 16/27; G06Q 20/02

(52) U.S. Cl. CPC G06F 21/105; G06F 2221/0766; G06Q 20/02; G06F 16/27

(57) ABSTRACT

The present invention is a self-executing FRAND licensing method and system incorporating partially software-supported and automated contract design and administration, resulting in lower transaction costs, more individual and flexible licensing models, and improved contract management by use of smart contracts. Smart contracts use algorithms for automatic execution via a processing unit when a required event occurs. Licensing terms and information is continuously updated, categorized and stored in a database that is connected to the processing unit. The processing unit recognizes and evaluates changes and in turn executes the contractual result for the respective case. The data required for the execution of the license agreements could be documented by using blockchain technology in a peer to peer arrangement. Automated licenses are transferred to individual patent registers into a uniform digital file format merged into a worldwide register. Automated contract design is combined with secure blockchain data storage, and a continuous, value-based top-down approach. Comparative licenses can be used in addition to checking the license fees calculated by valuation algorithms in individual cases.

### PRIORITY CLAIMS

This application claims the benefit of U.S. Provisional Application Ser. No. 62/949,395, filed on Dec. 17, 2019, and U.S. Provisional Application Ser. No. 63/019,070, filed on May 1, 2020, the contents of which are incorporated herein.

### BACKGROUND OF THE INVENTION

Every exchange of assets entails transaction costs. The transaction costs burden the exchange ratio and in unregulated markets—in addition to the targeted profit—are added to the production price of the exchanged asset, i.e. “priced in”. Transaction costs are also incurred for license agreements for industrial property rights and are charged to the license fee demanded by the owner of the industrial property right. Due to the principle of contractual autonomy, the importance of transaction costs in unregulated license agreements is limited. The property right owner creates an offer that is either economically attractive for the license seeker—or not.

Anyone applying for a license to a patent will, for example, include in his assessment the costs of alternative technical solutions outside the scope of protection of the patent offered for the license and consider whether it is more favourable to take a license, to develop and establish a technical solution of one's own on the market or to switch to a technical solution in the public domain.

The situation is fundamentally different where the potential licensee cannot rely on alternative or public service technical solutions, since, due to a lack of demand, he cannot effectively market a competitive product on the market with these solutions. If the license seeker wants to create a marketable offer, he must conclude a license agreement.

Such an initial situation exists, for example, in standardised technology areas with a view to those patents in whose scope of protection it is mandatory to intervene if the standardised teaching on technical action is to be implemented, so-called standard essential patents (in short: essential patents or SEP). In order to ensure that interested third parties can also gain access to the standardized result of standardization, the holders of essential patents are obliged under antitrust law to grant licenses to their essential patents on fair, reasonable and non-discriminatory terms, in short: FRAND¹ terms. ¹ Fair, Reasonable And Non-Discriminatory, short: FRAND, especially in English-speaking countries also referred to as “RAND”.

If a property right has to be licensed on a massive scale, it would be a good idea to draw up a standard license agreement and use it consistently. The antitrust dimension of the licensing of essential patents, however, requires—at least according to recent case law²—that the licensor deals transparently with the circumstances of the individual case,³ thus addressing in particular its economic background. Alternatively, the licensor may compensate for an “unreasonable level of royalties by other mechanisms” in individual cases,⁴ e.g. if he unilaterally bears the risk of economic under compensation. The⁵ licensor is faced with the decision either to use a standard license agreement and to realise low license fees throughout the country or to offer individualised, flexible license agreements in individual cases. However, the additional economic effort required to monitor and execute individualised and flexible license agreements then charges the license fee charged by the licensee as transaction costs. ² LG Düsseldorf, Ert. v. 13 Jul. 2017, 4a O 27/16=GRUR-RS 2017, 130336; LG Mannheim, Urt. v. 10 Nov. 2017, 7 O 28/16=GRUR-RR 2018, 273, 278—Radio station; see also Kühnen, Chap. E, Rz. 335.³ On contractual adjustment mechanisms in order to take account of changed actual circumstances, at least from their “perceptibility”, see OLG Düsseldorf, Hinweisbeschl. v. 17 Nov. 2016, I-15 U 66/15 Rz. 32, 37 und 43=GRUR-RS 2016, 21067, Holtorf/Traumann, GRUR-Prax 2017, 42.⁴ LG Düsseldorf, jurisdiction from 9 Nov. 2018, 4a O 17/17, no. 592=Beck-RS 2018, 35570.⁵ LG Düsseldorf, jurisdiction from 9 Nov. 2018, 4a O 17/17, no. 597=Beck-RS 2018, 35570.

The object of this work is to examine how the transaction costs for the conclusion and administration of license agreements for essential patents or entire portfolios of essential patents can be reduced, so that even under the changed requirements of case law essential patents can be licensed out so economically that the standardized technology areas remain attractive for investments in research and development (R&D investments). A⁶ decisive criterion for this is the unconditional focus on patent quality—rightly referred to by Ann as the “megatopic of the patent system”⁷—as a central aspect of patent evaluation. In practice, only high-quality, legally valid patents are respected and the willingness to license patent portfolios decreases dramatically with decreasing patent quality. The⁸ transaction costs incurred for the (continuous) determination of patent quality must be at least balanced against the savings resulting from the elimination of worthless patents in order for a license offer to be economically attractive at all. No commercial licensee will be prepared in the licensing reality to pay higher royalties than for a flat-rate license only to obtain a license tailored to his individual commercial needs. ⁶ The Commission points out in its Communication v. v. 29 Nov. 2017 (COM (2017) 712, p. 2) points out that the patent holders are to be remunerated [by license revenues] so that they continue to invest in R&D and standardization activities.⁷ Ann, VPP Spring Symposium 2019, p. 11; also Ann, GRUR Int. 2018, 1114.⁸ Ann, VPP Spring Symposium 2019, p. 6, refers to portfolio discounts of up to 80% due to latent patent invalidity; Ann, GRUR Int. 2018, 1114 [1116].

The starting point of this work is initially the legal framework for licensing standard essential patents under FRAND conditions. Since patents are granted by state sovereign acts, they are intrinsically linked to the territory of this state (territoriality).⁹ How and against which acts of use the patentee is granted protection is still left to the respective state sovereign, despite the advanced international harmonisation of¹⁰ the minimum levels of protection and term of protection.” Technical standards, on the other hand, affect a large number of nation states. They are implemented wherever there is a corresponding product market—in the electronics and mobile communications sectors, for example, worldwide.¹² The licensing of essential patents is therefore intrinsically a subject that affects several jurisdictions. For the parties to a license agreement on essential patents, the various legal systems concerned result in a partly codified international legal framework of conditions to be taken into account, which is partly further developed by judiciary law. Some approaches seemed to contradict each other at first, but there is¹³ a convergence of national jurisprudence.¹⁴ ⁹ Benkard/Henke, EPC, Art. 64, para. 5; Benkard/Scharen, PatG, Sec. 9, para. 8; Mes, Sec. 9, para. 9, Busse/Keukenschrijver, Sec. 1, para. 96 and in particular Sec. 9, para. 118 et seq.Haedicke/Timmann/Chakraborty, § 11, Rz. 802; Kühnen, Kap. A, Rz. 239 ff.; see also RG, Urt. v. 4 Apr. 1914, Rep. I. 3/14=RGZ 84, 370, 375 f.; BGH, Urt. v. 29 Feb. 1968, Ia ZR 49/65 (Plant Variety Protection)=GRUR 1968, 195—Forward; OLG Düsseldorf, Urt. v. 10 Dec. 2009, I-2 U 51/08=Mitt. 2010, 237; for foreign earnings see supplementary also in particular BGH, judgement v. v. 16 May 2017, X ZR 120/15, Rz. 33 f.=GRUR 2017, 785—Sealing system.¹⁰ Examples are the Paris Convention for the Protection of Industrial Property of 20 Mar. 1883 (Paris Convention; see BGBl. 1970 II p. 391; amended on 2 Oct. 1979, BGBl. 1984 II p. 799; perm. amended on 2 Oct. 1979, BGBl. 1984 II p. 799). 799), the Agreement on Trade-Related Aspects of Intellectual Property Rights (TRIPS); ratified in the Federal Republic of Germany by Article 1 of the Law on the Agreement of 15 Apr. 1994 Establishing the World Trade Organization and Amending Other Laws, BGBl. 1994 II, p. 1428; the text of the TRIPS Agreement is published in BGBl. 1994 II, p. 1565 ff. [English] or 1730 ff. (German)) and Directive 2004/48/EC of the European Parliament and of the Council of 29 Apr. 2004 on the enforcement of intellectual property rights (unofficial: Enforcement Directive; implemented in the Federal Republic of Germany by the Gesetz zur Verbesserung der Durchsetzung von Rechte des geistigen Eigentums of 7 Jul. 2008, BGBl. 2008 I p. 1191).¹¹ Art. 4bis PVO; BVerfG, Resolution of 10 May 2000, 1 BvR 1864/95=GRUR 2001, 43, 44—Clinical trials.¹² See LG Düsseldorf, judgment of 9 Nov. 2018, 4a O 15/17, no. 398=BeckRS 2018, 33825, GRUR-Prax 2019, 91 with note Kurtz.¹³ A concrete example is the development of case law in the United Kingdom. In the proceedings Unwired Planet v Huawei (EWHC, Entsch. v. 5 Apr. 2017, Az. [2017] EWHC 711 (Pat), Rz. 169) Justice Birss took the view that in each individual case only one concrete contractual arrangement was FRAND. This opinion contradicts the case law of the continental European courts, according to which FRAND is a corridor (see e.g. OLG Düsseldorf, Hinweisbeschl. v. 17 Nov. 2016, I-15 U 66/15 Rz. 18=GRUR-RS 2016, 21067, Holtorf/Traumann, GRUR-Prax 2017, 42.OLG Karlsruhe, Beschl. v. 8 Sep. 2016, 6 U 58/16=GRUR-RS 2016, 17467—Dekodiervorrichtung mit Anm. Holtorf/Traumann, GRUR-Prax 2016, 560; Rechtbank Den Haag, Entsch. v. 8 Feb. 2017, ECLI:NL:RBDHA:2017:1025, Pkt. 4.3.), cf. in detail § 10 Abschnitt II.¹⁴ In the meantime, the England and Wales Court of Appeal has resolved this contradiction and stated: “the reality is that a number of sets of terms may all be fair and reasonable in a given set of circumstances”. (EWCA, Resolution v. 23 Oct. 2018, Az. [2018] EWCA Civ 2344, Rz. 121). In paragraph 206 of the decision, the court expressly confirms its desire for international harmonization efforts; cf. in detail § 10 Section II.

Then, on the basis of market data, it assesses how the mobile terminal market has developed over the past two decades in relation to the SEP mobile licensing market and how case law has taken up and assessed these market changes.

Against this background, the significance of transaction costs and the current implementation of licensing at FRAND conditions will be presented in a next step. In order not to burden the license fee with more transaction costs than at least necessary, cross-industry practices in licensing standard essential patent portfolios have developed during the last two decades in order to quickly and efficiently master the complex subject of regulation. The increased requirements of case law regarding the transparency of the calculation and the non-discrimination of a FRAND license offer as well as the flexibility of the license agreement as a whole run counter to this blanket practice and threaten to make the licensing of essential patents more complex and resource-intensive. The resulting transaction costs in turn increase the license fees.

It is therefore necessary to examine how the transaction costs resulting from the amended requirements of case law can be reduced again. The latest achievements in the fields of information technology and data processing are used for this purpose, in particular self-executing license agreements (so-called smart contracts) and forgery-proof technologies for storing data (e.g. block-chain technology).

Finally, the basic mechanisms of an automated evaluation system are presented and taken up in a consistent implementation example. For a self-executing pricing algorithm to be able to charge the license seeker a fair and reasonable royalty, which is non-discriminatory in the context of existing licenses, certain basic decisions have to be taken and the factors for pricing have to be determined.

The aim of the study is to identify positions and fields in the field of FRAND licensing on which there is consensus at international level. In order to develop a functional evaluation approach that is consistent in itself, however, highly controversial questions of patent evaluation must also be decided in practice. It must always be considered how the right balance can be found between material justice and the transaction costs necessary to achieve (and maintain) it. Kühnen notes that it is difficult to achieve material justice with simultaneous rapid justiciability for an object of regulation that is “extraordinarily complex” because of the immense quantitative burden of patents on the standard.¹⁵ Judge Selna also states in TCL v Ericsson: “The search for precision and absolute certainty is a doomed undertaking”.¹⁶ ¹⁵ Kühnen, Kap. E, Rz. 421 f.; Putnam, Fordham International Law Journal, 2018 (Vol. 41), 953 [986]; s.a. Baron, S. 18: “The correct determination of the value of an SEP portfolio is highly challenging”.¹⁶ United States District Court Central District of California, Entsch. v. 8 Nov. 2018, SACV14-00341 JVS (DFMx), S. 14.

The evaluation methodology ultimately proposed is therefore certainly not perfect in every respect and is certainly vulnerable in several respects, both legally and economically. However, it has the decisive advantage that it can actually be put into practice with the means available today for the benefit of all those involved in standardisation. On this basis, corrections and improvements could of course be made in day-to-day operations in order to improve the evaluation concept and (even) adapt it more closely to market conditions. Because here, too:

“The distance is unimportant. Only the first step is important”¹⁷ ¹⁷ An aphorism attributed to Marie de Vichy-Chamrond, better known as Marquise du Deffand (1697-1780).

The content of the study will be subject to a number of limitations in order not to deviate from the above objective of developing a workable evaluation approach based on the existing legal framework, which is consistent in itself. To this end, the central problems can be identified and approaches to solutions can be developed as guidelines for practice. However, not every detail found can be comprehensively integrated into the evaluation system from the outset, so that occasionally only the problem awareness for future regulatory and implementation questions should be sharpened.

The present work therefore refers to the current case law in some fundamental questions and orients itself in central points on the legal reality created by the case law—such as what “FRAND” is in terms of content and that the calculation methodology behind a FRAND offer is to be explained transparently to the license seeker so that the license seeker can check whether an exploitative offer is submitted to him and/or whether he is discriminated against by the offer.

Rather, the focus of the study is on economic implications of licensing agreements and the related aspects of antitrust and patent law. For this reason, the adjoining questions of general terms and conditions control (§§ 305 ff. BGB)¹⁸ and the antitrust conformity of pricing algorithms are¹⁹ expressly not to be examined. ¹⁸ See Heckelmann, NJW 2018, 504 [507].¹⁹ See also Artist, GRUR 2019, 36; Paal, GRUR 2019, 43; Braegelmann/Kaulartz/Riehm, chapter 9.

### SUMMARY OF THE INVENTION

The legal framework for FRAND licenses is based on the consideration that dominant undertakings whose absolute market power is based on proprietary technology license these patents to other market participants on fair, reasonable and non-discriminatory terms. In this way, access to the product market is or remains open and competition on the product market is made possible.

A certain patented doctrine on technical action can also become a de facto industry standard through market enforcement, i.e.²⁰ a competitive offer on the product market requires the use of the patent. In practice, however, dominant market positions are in the vast majority of cases mediated by patents which are essential for an²¹ industry standard agreed by market participants, i.e. set by agreement. ²⁰ So-called de facto standard, for more details see § 3 Section II.²¹ Sog. de iure Standard, more details in § 3 Section II.

The dogmatic background of FRAND licensing therefore lies in standardization and its impact on competitive conditions. This background and the dogmatic mechanisms behind standardization will be explained in more detail. The considerations are based decisively on the legal framework outlined and the underlying interests.

According to the broadest understanding, standardization is the standardization of structures and behaviors. It breaks down barriers and obstacles by harmonising and developing appropriate approaches to solving a particular problem into a basic consensus. Standardisation is therefore by its very nature competition neutral, ensuring only interoperability based on collective innovation.

In this sense, standardization is the basis of human interaction and a central component of transnational and transcultural exchange.²² Basic examples of this are human language and writing, which have enabled communication and documentation for several thousand years.²³ ²² Wenzlhuemer, Rz. 1 m.w.N.²³ Forrester, p. 2; cf. also Zeltwanger, controleng.com.

The first significant example of technical standardization is time recording, first by calendars²⁴, later by clocks,²⁵ and finally by the introduction of Coordinated World Time in 1972. In²⁶ principle, however, harmonization efforts were initially limited to regional environments and did not prevail over borders and greater distances to any significant extent. It was not until the French Revolution at the end of the eighteenth century that the metric system spread far beyond France²⁷ and has been²⁸ administered and monitored by the International Bureau of Weights and Measures (BIPM) since 1875. At the end of the nineteenth century, the International Telegraph Union (ITU) also established the first international communication standard²⁹ by laying down basic rules for international telegraphic exchanges between Member States. ²⁴ Higgins/Miner/Smith/Sullivan, Abschnitt: Ancient Calendars, https://www.nist.gov/pml/time-and-frequency-division/popular-links/walk-through-time/walk-through-time-version-history (abgerufen am 27 Nov. 2019).²⁵ Higgins/Miner/Smith/Sullivan, Abschnitt: Early Clocks, https://www.nist.gov/pml/time-and-frequency-division/popular-links/walk-through-time/walk-through-time-early-clocks (abgerufen am 27 Nov. 2019).²⁶ Coordinated Universal Time, see https://de.wikipedia.org/wiki/Koordinierte_Weltzeit (accessed 27 Nov. 2019).²⁷ See Wenzlhuemer, marginals 5 to 15.²⁸ Bureau International des Poids et Mesures; https://www.bipm.org/en/worldwide-metrology/metre-convention/(abgerufen am 27 Nov. 2019).²⁹ Today: International Telecommunication Union; https://www.itu.int/en/history/Pages/ITUsHistory.aspx (accessed 27 Nov. 2019).

In the twentieth century, international standardization increased explosively³⁰. Influential institutes for the development of technical standards and norms were created. In addition to the ITU, the International Electrotechnical Commission (IEC, 1906)³¹ and the International Organization for Standardization (ISO, 1947³²) are of particular importance at the international level, while CEN (1961)³³, CENELEC (1973)³⁴ and ETSI (1988)³⁵ are to be mentioned at the European level. In the USA, ASTM (1898)³⁶, NIST (1901)³⁷, ANSI (1918)³⁸ and IEEE (1963) are³⁹ leading standardization institutes. The institutes are supported by expert committees, in the field of video data compression for example by the Moving Picture Experts Group (MPEG).⁴⁰ ³⁰ Europäische Kommission, Study into the impact of standardization, S. 158 (Annex 3).³¹ https://www.iec.ch/about/profile/ (accessed 27 Nov. 2019).³² https://www.iso.org/about-us.html (accessed 27 Nov. 2019).³³ Comité Européen de Normalisation, https://www.cen.eu/ (accessed 27 Nov. 2019).³⁴ Comité Européen de Normalisation Électrotechnique; https://www.cenelec.eu/aboutcenelec/whoweare/index.html (accessed 27 Nov. 2019).³⁵ European Telecommunications Standards Institute; https://www.etsi.org/about (abgerufen am 27 Nov. 2019).³⁶ American Society for Testing and Materials; https://www.astm.org/ABOUT/history_book.html (abgerufen am 27 Nov. 2019).³⁷ National Institute of Standards and Technology; https://www.nist.gov/nist-history (accessed 27 Nov. 2019).³⁸ American National Standards Institute; https://www.ansi.org/about_ansi/introduction/history?menuid=1 (abgerufen am 27 Nov. 2019).³⁹ Institute of Electrical and Electronics Engineers; https://www.ieee.org/about/ieee-history.html (abgerufen am 27 Nov. 2019).⁴⁰ https://mpeg.chiariglione.org/ (accessed 27 Nov. 2019).

Digitalization creates new technical networking possibilities and enables the increasing modularity of products and processes.⁴¹ It requires reliable interfaces between products, machines and processes, uniform data formats and standardized transmission solutions.⁴² The increasing demand for interoperability is⁴³ forcing standardization and at the same time represents its greatest social advantage. Through the technical harmonization of the basic characteristics, the users—i.e. the implementers—of a standard can concentrate on demand-relevant characteristics of the product or service. The⁴⁴ end customer is offered versatile and globally applicable products, possibly with interfaces to other devices or networks. If the engine behind standardisation is the end-user's interest in interoperable terminal equipment at a⁴⁵ reasonable price,⁴⁶ standardisation is in principle in the public interest.⁴⁷ ⁴¹ Yamada, p. 108.⁴² Osterrieth, GRUR 2018, 985, Picht, GRUR 2019, 11 [12] f.; European Commission, Standard Essential Patents and the Internet of Things.⁴³ Putnam, Fordham International Law Journal, 2018 (Vol. 41), 953 [961].⁴⁴ Instructive: De Vries, p. 131 ff; Hilty/Slowinski, GRUR Int 2015, 781 [782].⁴⁵ European Commission, Horizontal Guidelines, paragraph 257; European Commission, Patents and Standards, p. 10.⁴⁶ See European Commission, Horizontal Guidelines, paragraph 308.⁴⁷ European Commission, Horizontal Guidelines, paragraph 263; cf. Haedicke/Timmann/Bukow, § 9, marginal 258 m.V.a. LG Düsseldorf, Urt. v. 30 Nov. 2006, 4b O 508/05=InstGE 7, 70—Video signal coding I; Haedicke/Timmann, § 1, Rz. 115 ff.

The mobile standards created and managed by ETSI have, in line with the Commission's objectives in the Green Paper initiative⁴⁸, created a breeding ground for market conditions which have allowed consumers to benefit from a greater variety of telecommunications services of better quality and at lower cost. The mobile radio standards guarantee the compatibility and interoperability of a large number of products and services in this market⁴⁹. By clearly defining the technical implementation, the standards increase competition in the end consumer market⁵⁰ and result in ever lower selling costs with ever better quality. ⁴⁸ European Commission, Green Paper on the Development of European Standardisation, COM (90) 456 (final).⁴⁹ European Commission, Horizontal Guidelines, paragraph 257.⁵⁰ Cf. the following § 2 Section III.

Yamada⁵¹ rightly points out that technical standardization—in contrast to cultural standardization⁵²—already has a competition-strategic aspect in itself. This is because the market leader in a certain technology sector must always be vigilant in order not to lose its lead over its competitors. This is at the same time his central incentive for R&D expenditure and the further development of the product or service. Competitors, on the other hand, must be more willing to take risks in order to catch up with the market leaders. Practice shows that competitors are prepared to test disruptive technologies earlier and that market leaders often do not recognize and help shape a technological change in time.⁵³ They are overtaken by competitors. Market leaders can reduce this risk through standardisation,⁵⁴ because if a product deviates from the standard, the supplier is exposed to cumulative competitive pressure from all compliant products. The⁵⁵ industry participants therefore first orient themselves to this standard before examining fundamentally different technical approaches. As all standardization participants harmonize and focus their R&D efforts, the individual R&D effort is reduced.⁵⁶ Added to this are the continuously incoming license revenues.⁵⁷ ⁵¹ Yamada, p. 110 ff.; see also Blind, p. 155 ff.⁵² See also § 2 Section I.⁵³ Examples are the mobile phone divisions of Siemens, Alcatel-Lucent, Sony-Ericsson or Motorola; see https://www.manager-magazin.de/digitales/it/a-278487.html (accessed on 27 Nov. 2019); https://www.computerwoche.de/a/siemens-wirft-die-handys-raus,556275,2 (accessed on 27 Nov. 2019); https://www.wiwo.de/technologie/gadgets/klassiker-im-abseits-die-verlierer-des-smartphone-booms/6548174.html (accessed on 27 Nov. 2019).⁵⁴ Yamada (p. 114) points out that the mainly Japanese companies from the DVD6C and DVD3C pools licensed the technology to Chinese companies in 2002 in order to secure their market position and profits despite increasing price pressure.⁵⁵ This may also be the strategic background for the fact that powerful companies offer free licenses for their technology, cf. for example the press releases of Tesla: https://www.tesla.com/de_DE/blog/all-our-patent-are-belong-you (accessed on 27 Nov. 2019) and Toyota: https://www.toyota.de/news/patente.json (accessed on 27 Nov. 2019). The rival drive concepts of the companies should thus find users and help the technology as a whole to achieve a breakthrough on the automotive market; see Backler/Heikkils/Kennedy, p. 5.⁵⁶ Yamada, p. 114.⁵⁷ Yamada, p. 113.

The competitive strategic position of individual companies is consolidated when the standardised approach is protected by essential patents, i.e. patents that must be used to implement the standard.⁵⁸ These patents, which should in principle protect the patent holder against imitators—and thus also against competitors—are of fundamental importance for the entire industry by including the protected technology in the standard. Since these patents can give rise to injunctive relief⁵⁹, they have the potential to exclude market participants from the relevant (product) market. Essential standard patents are therefore of considerable strategic importance for the market. ⁵⁸ Cf. already above § 1 section I.⁵⁹ In Germany standardised in Sec. 139 (1) PatG.

Where an economic obligation to use the product prevails in order to place a competitive offer on the product market, antitrust law therefore provides for a claim to licensing under FRAND conditions. Through this corrective intervention of antitrust law, the product market remains open and is accessible to the test of competition, which is beneficial for an economy⁶⁰. Competition has shifted from the basic technical nature of a device or process to the level of standardisation and implementation. ⁶⁰ On the systematics of antitrust law, see § 3 below.

First, competition may arise between different standards⁶¹ and/or proprietary solutions. If two standardisation organisations, enterprises or groupings of enterprises at the same time claim sovereignty to interpret a particular area of technology, end users in that market will ultimately typically prefer a technical solution or standard. A practical example is the competition between the video standards Blu-ray⁶² and HD DVD⁶³ during the last decade. Ultimately, Blu-ray has prevailed among end customers.⁶⁴ Further examples are the competition between VHS, Video 2000 and Betamax in the 1980s⁶⁵ or the fate of the MiniDisc, which in the 1990s was ultimately unable to hold its own alongside portable CD or compact cassette players and, in addition to the iPod as the driving force behind MP3 technology, finally suffered a massive slump in demand from the end of 2001.⁶⁶ ⁶¹ Haft, FS 80 Years of Patent Jurisdiction in Düsseldorf, p. 162.⁶² Created by the Blu-ray Disc Association (short: BDA, among others Pioneer, Philips, Thomson, LG Electronics, Hitachi, Sharp, Samsung and Sony; http://blu-raydisc.com/en/WhatisBlu-rayDisc/SupportingCompanies.aspx (accessed on 27 Nov. 2019)).⁶³ High Definition Digital Versatile Disc (formerly Advanced Optical Disc, AOD for short), created by the Advanced Optical Disc Consortium (AOD for short, including NEC, Microsoft, Toshiba, Intel, IBM and Hewlett-Packard).⁶⁴ http://www.spiegel.de/netzwelt/tech/blu-ray-schlaegt-hd-dvd-kunden-beenden-fonnatkrieg-per-brieftasche-a-530684.html (accessed 27 Nov. 2019).⁶⁵ https://de.wikipedia.org/wiki/Fonnatkrieg_(video recorder) (accessed 27 Nov. 2019).⁶⁶ https://www.theguardian.com/music/musicblog/2012/sep/24/sony-minidisc-20-years (accessed 27 Nov. 2019).

Before a certain standard or product is established on the market, the companies involved in the development do not know whether their solution will establish itself, i.e. whether they will ever be able to successfully sell and license standard-compliant products and processes. The development expenditure for the standard is therefore a daring investment in a future business. As with pioneer patents, the extensive basic work pays off, since patents of one's own can occupy key technologies and thus potentially multiply their value compared to a proprietary competitor solution. Later contributions to a mature standard are often detail improvements of the basic standardized technology.

In addition, the companies involved in standardization are competing for the best solutions for the technical specifications of the standard. The technical expert committees of the standardization organizations decide which individual solution proposal is preferable and which fits best into the overall technical architecture of the standard.⁶⁷ At this stage, the company's own proposed solution, which is usually already patent pending, must prevail qualitatively against the solutions proposed by competitors. This requires not only technical bribery but also the presentation of the solution to the panel in such a way that the panel can quickly grasp and assess the core of the technical solution of the proposal (which is not always based on an inventive step by the contributor).⁶⁸ ⁶⁷ Critical: Bertenyi, bell-labs.com.⁶⁸ In practice, the so-called claim charts, i.e. tables in which the characteristics of the claims of a patent (typically even of a patent family) are juxtaposed with the relevant passages of the standard as technical specifications, are usually already prepared for this purpose. Compatibility tests or certain measurements may also be required.

Even at this level of standard inherent competition, the contributor does not know whether his investment in standardisation efforts will be amortised. He therefore has the incentive to develop the best possible solution in order to improve the chances of his proposed solution being included in the standard.⁶⁹ ⁶⁹ In COM (2017) 712, p. 2, the European Commission points out that patent holders are to be remunerated [by license revenues] so that they can continue to invest in R&D and standardization activities.

Finally, there is competition in the implementation of functionalities (features) that are not standard relevant and therefore do not participate in the market position mediated by standardization, but nevertheless influence the purchase decision of the end user. Vary, Li and Yiu use the term “assets for product differentiation purposes” for patents concerning such functionality (so-called implementation patents)⁷⁰, which can be translated as “object for the purpose of product differentiation”. ⁷⁰ Vary/Li/Yiu, twobirds.com.

These so-called implementation patents are not essential to standards, but can concern technical (ancillary) functionalities that are perceived as essential for the product market. A prominent example of a demand-relevant implementation patent was Apple's EP 1 964 022, which protected the iPhone's “Slide to Unlock” function.⁷¹ ⁷¹ BGH, Urt. v. 25 Aug. 2015, X ZR 110/13—Unlock image; https://www.heise.de/newsticker/meldung/Slide-to-unlock-BGH-kippt-Apples-Entsperr-Patent-2790886.html (retrieved on 27 Nov. 2019).

The level of implementation patents is particularly interesting for SMEs. Since they do not have to take the lion's share of the development themselves, but can access the inventions of the standardization participants for the basic product functionalities, a larger R&D volume is available to them for attractive design and attractive implementation functionalities. Proprietary solutions that do not convey a dominant market position can win customers here. But standardisation is what makes it possible for these companies to enter the market in the first place. Examples of standard implementers without their own (significant) SEP portfolios include Asus, Acer, HTC, Wiko, OnePlus, TCL and Blu—companies that are perceived as attractive, strong and successful in the end consumer market without any standardization effort.

However, the standardized areas on the technology market are subject to monopolies when transferred to antitrust law dimensions. The standard essential patents impart absolute market power on the technology market to their holders and enable every holder of such a technology monopoly to bring competition on the downstream product market to a standstill if he enforces his injunctive relief under patent law in court.

In terms of patent law, the owners of the SEP therefore face each other in a stalemate. A single patent that is actually essential (and thus—because there is no technical alternative—used) and legally valid is sufficient to exclude the opponent from the doctrine of the entire standard. The mandatory requirements of the standard multiply the exclusion potential conveyed by a singular patent. Even a single patent holder could block the application of the technology as a whole. The complex technical standardisation process would have been carried out in vain. Political scientists call this dilemma the “Tragedy of the Anticommons”.⁷² ⁷² Yamada, p. 108 f.; Levêque/Ménière, p. 17 f.

Compared to third parties, e.g. implementers without their own standard essential patents, SEP holders also benefit from the high market penetration of the standard, i.e. from the mass of implementation of the patent-protected technology. The right of exclusion against third parties resulting from the ownership of the patents designated as standard essential conveys power to the owner on the product market, which is designated as market power under antitrust law. Market power gives a company room for manoeuvre vis-à-vis competitors, customers or suppliers, which can have a negative impact on the market result.⁷³ If only one holder of an essential patent enforces his injunctive relief in court, he can prevent third parties from using the standard as a whole. There⁷⁴ is therefore a potential risk that competitors of the patent proprietor or competitors of its licensees will either be completely denied access to the result of standardisation or only be granted on prohibitive or discriminatory terms. The⁷⁵ refusal to license and/or the demand for excessive royalties is commonly referred to as “hold up”.⁷⁶ ⁷³ Bundeskartellamt, Guidelines on market dominance in merger control, paragraph 5.⁷⁴ European Commission, Horizontal Guidelines, paragraph 263; cf. also Block, Mitt. 2017, 97; Fuchs, NZKart 2015, 429 [430].⁷⁵ European Commission, Horizontal Guidelines, paragraph 268; Haedicke/Timmann, § 1, paragraph 115; Gauss/Barthelmess, WuW 2010, 626.⁷⁶ European Commission, Horizontal Guidelines, paragraph 269; the term goes back to Lemley/Shapiro; Angwenyi/Barani, GRUR Int 2018, 204 [205] ff. m.w.N.; Putnam, Fordham International Law Journal, 2018 (Vol. 41), 953 [963] and [971]; Langus/Lipatov/Neven.

As a rule, standard essential patents have acquired their significance through institutional standardisation, i.e. by market participants who are actually competitors on one or more product or service markets agreeing on certain proprietary technical solutions for a defined area of application.⁷⁷ While the purely factual (defacto) standard only gradually gains market power through its de facto market penetration, the institutional or private-law⁷⁸ (de iure) standard already develops antitrust significance from the start of the standardization agreement.⁷⁹ Understanding the participants in standardization has the potential to exclude third parties—in particular companies not involved in standardization—from a product market⁸⁰. In European antitrust law, Art. 101 (1) TFEU prohibits the following ⁷⁷ If a certain technology achieves such a high de facto market penetration that it is economically indispensable to sell a certain product, one speaks of a purely de facto, i.e. non-institutional or private-law, industrial standard—a so-called de facto standard. The SEP holder therefore does not make a FRAND declaration of commitment for de facto essential patents.⁷⁸ The standardisation agreement may also be non-institutional in nature if commercial enterprises agree on a particular technical solution under private law. For the sake of simplicity, the term “institutional standard” will be used below for all these standards.⁷⁹ Hauck, NJW 2015, 2767 [2768], Haedicke/Timmann/Bukow, § 9, marginal 289.⁸⁰ Haft, FS 80 Years of Patent Jurisdiction in Düsseldorf, p. 158; in addition fundamental: Neumann/Koenig, WuW 2009, 382 m.w.N.
“any agreement between undertakings [ . . . ] which may affect trade between Member States and which has as its object or effect the prevention, restriction or distortion of competition within the internal market, and in particular [ . . . ] (b) the restriction or control [ . . . ] of technical development [ . . . ].

The concept of agreement is broad⁸¹ and includes standards relating to intellectual property rights.⁸² When the appreciability threshold⁸³ is exceeded, the institutional standard develops relevance for competition on the product market, since individual alternative technical solutions must compete with the standard—supported by companies with sufficient market power⁸⁴. Even de iure standardisation is therefore capable of affecting trade.⁸⁵ Whether it also has the effect of restricting competition is a matter for the individual case. The⁸⁶ mere ownership of an essential patent—even if the patent conveys a dominant position⁸⁷—does not necessarily lead to the exercise of market power and the restriction of competition, and the requirements for anti-competitive conduct are not too high⁸⁸. The refusal to grant a license on fair, reasonable and non-discriminatory terms in response to a specific, justified request by a license seeker is a regular refusal. ⁸¹ Bechtold/Bosch/Brinker, Art. 101 TFEU, marginal 40 et seq.; Immenga/Mestmäcker/Emmerich, Art. 101 TFEU, marginal 55.⁸² European Commission, Horizontal Guidelines, paragraph 267.⁸³ Sog. de minimis barrier, cf. European Commission, Horizontal Guidelines, paragraph 26 et seq.⁸⁴ LG Mannheim, Resolution of 21 Nov. 2014, 7 O 23/14=GRUR-RS 2015, 10955, paragraph 22.⁸⁵ Mestmäcker/Schweitzer, § 30, Rz. 49.⁸⁶ European Commission, Horizontal Guidelines, paragraph 269.⁸⁷ OLG Düsseldorf, Urt. v. 30 Mar. 2017, I-15 U 66/15=GRUR 2017, 1219 marginal 128—Mobile communication system.⁸⁸ In the opinion of 4b. The first civil chamber of the Düsseldorf Regional Court (judgment of 19 Jan. 2016, 4b O 120/14, margin no. 414=GRUR-RS 2016, 08288—Handover) is to be required to fall under Art. 101 TFEU for the simple reason that it would lead to a procedure of the participants in the standardisation deliberately aligned according to objective and procedure. Effects on competition would arise from the fact that the standardisation participants would forego the development or use of alternative technologies in favour of the standard and a certain factual compulsion would arise to manufacture or work according to the standard.

Pursuant to Art. 101 (2) TFEU, agreements that fall under the definition of an offence under Art. 101 (1) TFEU are generally null and void. This effect therefore also threatens in principle to cover institutional (de iure) standardisation agreements.⁸⁹ ⁸⁹ See § 3 Section II above.

If the market power conferred by the standard exceeds a critical threshold, it becomes absolute market power.⁹⁰ From now on, the standard essential patent will give its owner a market dominating position. If the owner of such a patent abuses his dominant market position—for example by filing an injunction—this may be relevant under Art. 102 TFEU.⁹¹ ⁹⁰ Bundeskartellamt, Guidelines on market dominance in merger control, paragraph 8.⁹¹ EuGH, Urt. v. 16 Jul. 2015 in the version passed on 15 Dec. 2015, C-170/13, paragraph 56=GRUR 2015, 764—Huawei Technologies./. ZTE et al.

The interest of market participants in access to the technology demanded by end-users in order to remain competitive and the commercialisation interest of holders of standard essential patents for such access are in practice in conflict.

The FRAND principle exists to⁹² ensure that standardisation participants with essential patents do not use their market position against license seekers, irrespective of whether they have appreciable or absolute market power^{93 94}. The main focus of the antitrust assessment is on access to the standardized technology itself. This is because competition on the downstream product market is promoted by the fact that third parties not involved in standardization can also access the result of standardization and that as large a number of companies as possible are active on the standardized technology market. ⁹² European Commission, Horizontal Guidelines, paragraph 263.⁹³ See section 3(II) above; the difference lies in the severity of the effect on competition, Art. 101 TFEU merely presupposes that the effect is an impairment of competition, whereas Art. 102 TFEU requires the abuse of absolute market power.⁹⁴ Haedicke/Timmann, § 1, Rz. 116.

The holder of patents essential to the standardised technology therefore makes a FRAND commitment to the standardisation organisation. The FRAND Declaration of Commitment is the irrevocable and unconditional commitment of the SEP holder to grant a license to the SEP to interested third parties on FRAND terms.⁹⁵ ⁹⁵ European Commission, Horizontal Guidelines, paragraph 285.
“In particular, the FRAND commitments may discourage the holders of these rights from making it more difficult to apply a standard by refusing to grant a license or by charging unfair or unreasonable (i.e. excessive) fees after the industry has joined the standard and/or by imposing discriminatory royalty payments.⁹⁶ ⁹⁶ European Commission, Horizontal Guidelines, paragraph 287.

The SEP holder thus avoids the accusation that he is violating Art. 101 TFEU by declaring his commitment to FRAND. The potential⁹⁷ restriction of competition is removed⁹⁸ and the market power conferred by the standard essential patent is (again) relativised, Art. 101 (3) TFEU.⁹⁹ ⁹⁷ Art. 101 TFEU is an abstract dangerous offence, and Mohr, p. 764 and p. 464 ff, instructs on this.⁹⁸ European Commission, Horizontal Guidelines, Rz. 280, 283; see also LG Düsseldorf, Urt. v. 19 Jan. 2016, 4b O 120/14, ref. no. 415=GRUR-RS 2016, 08288—Handover; Haft, FS 80 years patent jurisdiction in Düsseldorf, p. 169; Voss/Fehre, FS 80 years patent jurisdiction in Düsseldorf, p. 565; McGuire, GRUR 2018, 128 [134]; Eckel, NZKart 2017, 469 [470].⁹⁹ LG Mannheim, Resolution of 21 Nov. 2014, 7 O 23/14=GRUR-RS 2015, 10955, paragraph 22; last: TQ Delta v Zyxel, EWCA, Resolution of 18 Jul. 2019, Az. [2019] EWCA Civ 1277, paragraph 14.

For this reason, the IPR policies of the standardization organizations and institutes provide¹⁰⁰—as an antitrust pacemaker, so to speak, for the purpose of their own survival—that the holders of essential patents make a FRAND declaration of commitment¹⁰¹ if they introduce a patent into an institutional standard and declare it to be essential. In Europe, the FRAND access thus has its antitrust origin directly in Art. 101 TFEU.¹⁰² ¹⁰⁰ Dazu Fröhlich, GRUR 2008, 205; Straus, GRUR Int 2011, 469; Haedicke/Timmann/Bukow, § 9, marginal 278.¹⁰¹ E.g. Art. 14 of the Charter of the DVD Forum, Point 6.1 of the ETSI Intellectual Property Rights Policy, Point 6.2 of the IEEE-SA Standards Board Bylaws.¹⁰² LG Mannheim, Resolution of 21 Nov. 2014, 7 O 23/14=GRUR-RS 2015, 10955, para. 22; Kurtz, ZGE 491 [494].

The threat of antitrust sanctions in the event that a patent is not (or not timely) reported as essential leads in practice to a phenomenon known as “over-declaration”. Justice Birss already pointed out in Unwired Planet v Huawei that only a small proportion of the patents reported as essential are actually essential:
“The over declaration problem is the following. Very many more patents are declared to be essential than in fact are essential.”¹⁰³ ¹⁰³ EWHC, Resolution of 5 Apr. 2017, Ref. [2017] EWHC 711 (Pat), recital 201.

In TCL v Ericsson, Judge Selna also points to the over-declaration and locates the cause of the phenomenon in the IPR policy of the standardization organizations, such as the ETSI IPR Policy.¹⁰⁴ Although ETSI calls on its members to declare all patents and patent applications to be essential, it does not check whether the intellectual property rights and applications filed are and remain essential. Section 4. 1 of the ETSI IPR Policy¹⁰⁵ reads (highlighting added): ¹⁰⁴ United States District Court Central District of California, Entsch. v. 8 Nov. 2018, SACV14-00341 JVS (DFMx), S. 11, Fn. 10.¹⁰⁵ ETSI RULES OF PROCEDURE (as amended on 18 Apr. 2018), ANNEX 6—ETSI Intellectual Property Rights Policy (as amended on 8 Oct. 2018), available at: https://www.etsi.org/images/files/IPR/etsi-ipr-policy.pdf (accessed on 27 Nov. 2019); see Fröhlich, GRUR 2008, 205 [208]; see also DIN, Guideline for Standard Essential Patents of 26 Jun. 2019, available at: https://www.din.de/de/din-und-seine-partner/presse/mitteilungen/leitfaden-fuer-standardessentielle-patente-334174 (accessed 27 Nov. 2019).
“Subject to Clause 4.2 below, each MEMBER shall use its reasonable endeavours, in particular during the development of a STANDARD or TECHNICAL SPECIFICATION where it participates, to inform ETSI of ESSENTIAL IPRs in a timely fashion. In particular, a MEMBER submitting a technical proposal for a STANDARD or TECHNICAL SPECIFICATION shall, on a bona fide basis, draw the attention of ETSI to any of that EMBER's IPR which might be ESSENTIAL if that proposal is adopted.”

The Essentiality Notifications and FRAND Commitments are essential for standardisation from an antitrust point of view so that the agreement of competitors on technical standardisation does not violate Article 101(1) TFEU. According to the understanding of the European Commission, European antitrust law sanctions so-called “patent ambushes” accordingly harshly.

Patent ambush” refers to situations in which a standardization participant does not disclose a standard essential patent during standardization and only subsequently asserts it as standard essential.¹⁰⁶ There, the holder of the SEP in question may have to grant a license to the¹⁰⁷ SEP in question.¹⁰⁸ ¹⁰⁶ Kühnen, Chap. E, Rz. 494; LG Düsseldorf, Urt. v. 13 Jul. 2017, 4a O 154/15, no. 491=GRUR-RS 2017, 132078—Mobile station; LG Düsseldorf, Urt. v. 31 Mar. 2016, 4a O 73/14, ref. no. 421=BeckRS 2016, 131580—Pitch analysis device; LG Düsseldorf, judgment of 3 Nov. 2015, 4a O 144/14, ref. no. 228 ff.=NZKart 2015, 545—Communication device; LG Düsseldorf, judgment of 131580, ref. no. 421 24 Apr. 2012, 4b O 274/10, ref. no. 312 f.=BeckRS 2012, 9376; LG Mannheim, Urt. v. 27 Nov. 2015, 2 O 106/14, no. 198=BeckRS 2015, 20077—Stochastic noise, with note Hauck, GRUR-Prax 2016, 84.¹⁰⁷ Kühnen, Chapter E, Rz. 494 m.V.a. LG Düsseldorf, Urt. v. 31 Mar. 2016, 4a O 73/14, no. 424=BeckRS 2016, 131580—Pitch analysis device; LG Düsseldorf, Urt. v. 13 Jul. 2017, 4a O 154/15, no. 494=GRUR-RS 2017, 132078—mobile station.¹⁰⁸ See notice pursuant to Article 27(4) of Council Regulation (EC) No 1/2003 in Case COMP/C-3/38636, OJ No C 133/16 of 12 Jun. 2009—Rambus; Fischmann, GRUR Int. 2010, 185 [194]; Schellingerhout/Cavicchi, Competition Policy Newsletter 2010, 32 et seq.

In order to avoid being accused of patent ambiguity, the standardization participants declare a patent application or a patent as essential as a precaution in case of doubt. In¹⁰⁹ addition, there are alleged essentiality reports from companies hoping for more validity in license negotiations due to a large (declared) SEP portfolio. If a larger portfolio is perceived as particularly valuable in the market due to its size, the portfolio owner can demand higher license fees (outbound licensing) or refer to its portfolio size for back-licenses (grant-back value) in order to have to pay lower license fees to other companies (inbound licensing).¹¹⁰ ¹⁰⁹ Stitzing/Sääskilahti/Royer/Van Audenrode, p. 11.¹¹⁰ Stitzing/Sääskilahti/Royer/Van Audenrode, p. 12.

As a result, the over-declared surplus¹¹¹ thus consists of patents which are ¹¹¹ Happy, GRUR 2008, 205 [211].
(1) have been deliberately falsely declared essential,
(2) have been declared as possibly essential unintentionally inaccurate as essential, and
(3) were first accurately declared to be essential, but their essentiality subsequently ceased to exist.

Mohsler and Tapia cite reasons for when a patent initially registered as essential or a patent application ultimately is or remains non-essential (Group 3)¹¹². It could happen, for example. ¹¹² Mohsler/Tapia, IntellectualProperty, 2019, 13 ff.
(1) the patent application remains unsuccessful,
(2) a patent with modified contents is granted and therefore no longer reads the standard, (3) a patent is subsequently revoked or declared invalid, and
(4) the standard ultimately favours a different proposed solution and is therefore adopted with different technical requirements.¹¹³ ¹¹³ Mohsler/Tapia, IntellectualProperty, 2019, 13 [15]; cf. also Stitzing/Sääskilahti/Royer/Van Audenrode, p. 12.

¹¹⁴ If the superstructure of supposedly essential patents and patent applications—which is superfluous from the point of view of the standardization result—is not followed up, identified and removed from the standardization process at a later point in time, the number of over-declared intellectual property rights and applications for intellectual property rights increases. Millien and Schnitzer point out that Judge Selna in TCL v Ericsson found that for 2G, 3G and 4G a total of only 2,799 patent families were actually essential, while the ETSI database cited 11,469 as essential patent families for these standards.¹¹⁵ Siino, Licensing President of the Via licensing pool, also publicly estimated that of the more than 160,000 SEPs declared essential for ETSI standards, only slightly more than 2,000 would actually be essential.¹¹⁶ Stitzing, Sääskilahti, Royer and Van Audenrode have an average essentiality rate for the LTE standard of 35.2% of patents and patent applications declared essential.¹¹⁷ Other studies also assume¹¹⁸ an actual essentiality rate of between 20 and 35%.¹¹⁹ ¹¹⁴ Picht, GRUR 2019, 1097 [1101]; Picht, GRUR 2019, 11 [16] m.w.N.¹¹⁵ Millions of carvers, iam.com.¹¹⁶ Siino, iam Magazine, 2017, Vol. 84, p. 60.¹¹⁷ Stitzing/Sääskilahti/Royer/Van Audenrode, p. 4.¹¹⁸ Brachtendorf/Gaessler/Harhoff, p. 18.¹¹⁹ Stitzing/Sääskilahti/Royer/Van Audenrode, p. 13 m.V.a. Fairfield Resources International; see also Pohlmann/Blind, p. 48 ff. m.w.N.

Commercial licensing pools are therefore already dealing with the phenomenon of overdeclaration. Via, for example, uses the so-called SEP funnel to license only the “truly essential” patents of its members:¹²⁰ ¹²⁰ See Siino, iam Magazine, 2017, Vol. 84, p. 61.

### BRIEF DESCRIPTION OF THE DRAWINGS

FIG. 1: Via licensing: “truly essential LTE handset patents”¹²¹ ¹²¹ Source: Siino, iam Magazine, 2017, Vol. 84, p. 61.

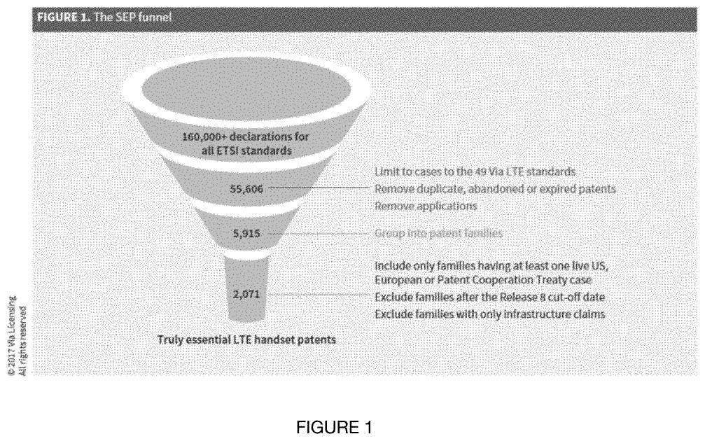

FIG. 2: Market shares by mobile phones sold worldwide in 2002¹²² ¹²² Data source: https://www.umtsworld.com/industiy/user_equipment.htm (accessed 27 Nov. 2019).

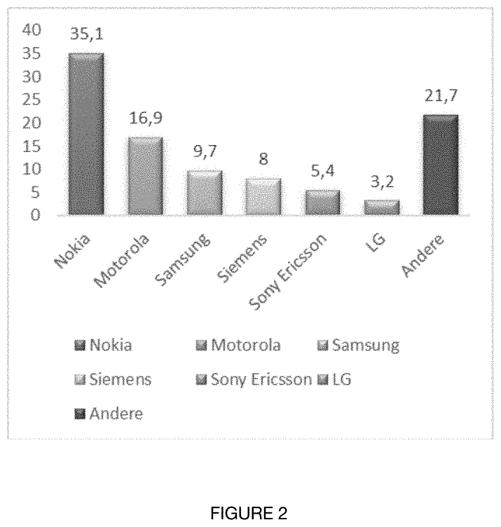

FIG. 3: Market shares by mobile phones sold worldwide in 2009¹²³ ¹²³ Data source: https://techcrunch.com/2010/02/23/smartphone-iphone-sales-2009-gartner/ (accessed 27 Nov. 2019).

FIG. 4: Market shares by mobile phones sold worldwide in 2014¹²⁴ ¹²⁴ Datenquelle: https://www.gartner.com/en/newsroom/press-releases/2015-03-03-gartner-says-smartphone-sales-surpassed-one-billion-units-in-2014 (abgerufen am 27 Nov. 2019).

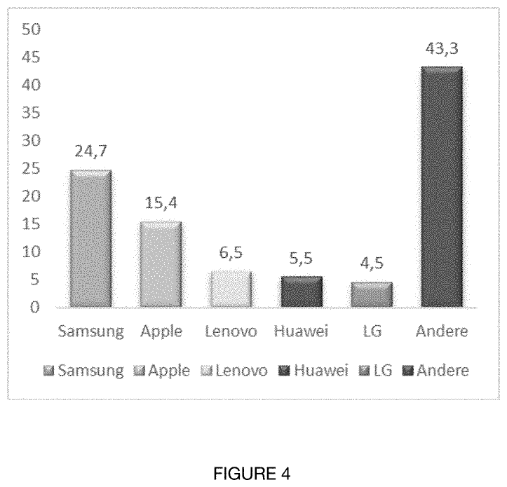

FIG. 5: Market shares by mobile phones sold worldwide in 2018¹²⁵ ¹²⁵ Data source: https://www.canalys.com/newsroom/apple-ships-717m-smartphones-in-q4-2018-as-global-market-falls-6 (accessed 27 Nov. 2019).

FIG. 6: Market shares by mobile phones sold worldwide in Q3 2019¹²⁶ ¹²⁶ Data source: https://www.canalys.com/newsroom/globalQ3smartphonemarket (accessed 27 Nov. 2019).

FIG. 7: Standardization contributions between 1999 and 2017¹²⁷ ¹²⁷ Source: https://www.ericsson.com/494e17/assets/local/patents/estimating-the-future-5g-patent-landscape.pdf (accessed 27 Nov. 2019).

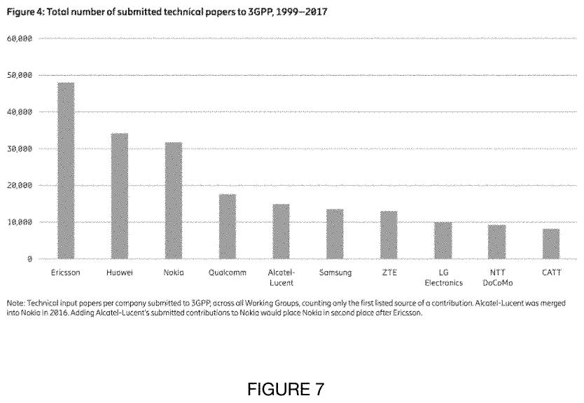

FIG. 8: Share of Huaweis in the total number of SEPs according to the mobile communications standard

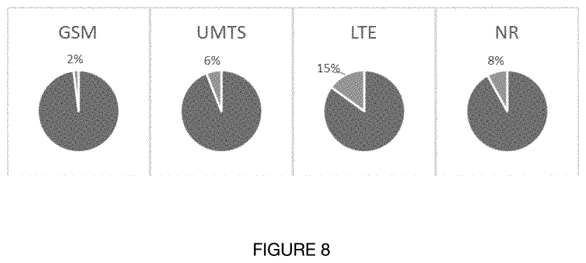

FIG. 9: Standardization contributions to LTE (4G)¹²⁸ ¹²⁸ Data source: https://www.iam-media.com/who-will-be-technology-leader-5g-part-one (accessed 27 Nov. 2019).

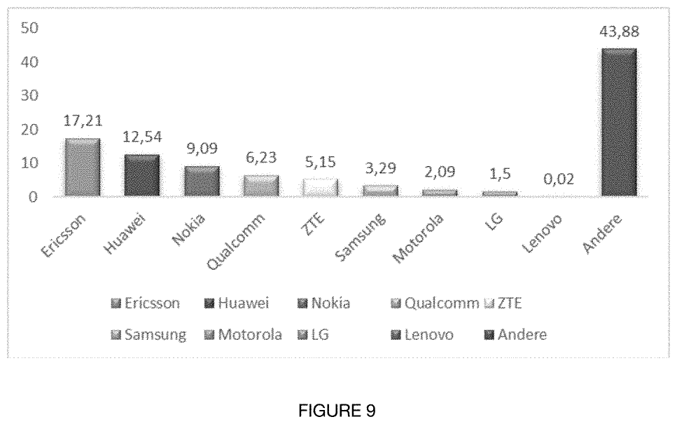

FIG. 10: Standardization contributions to NR (5G)¹²⁹ ¹²⁹ Data source: https://www.iam-media.com/who-will-be-technology-leader-5g-part-one (accessed 27 Nov. 2019).

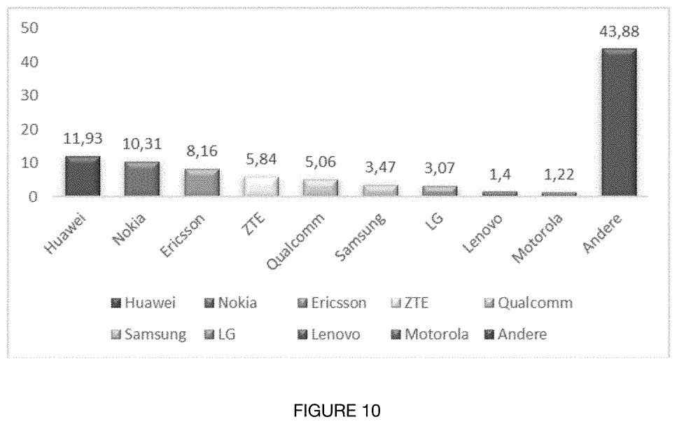

FIG. 11: Average smartphone price between 2010 and 2019 in USD¹³⁰ ¹³⁰ Data source: https://www.statista.com/statistics/484583/global-average-selling-price-smartphones/ (accessed 27 Nov. 2019).

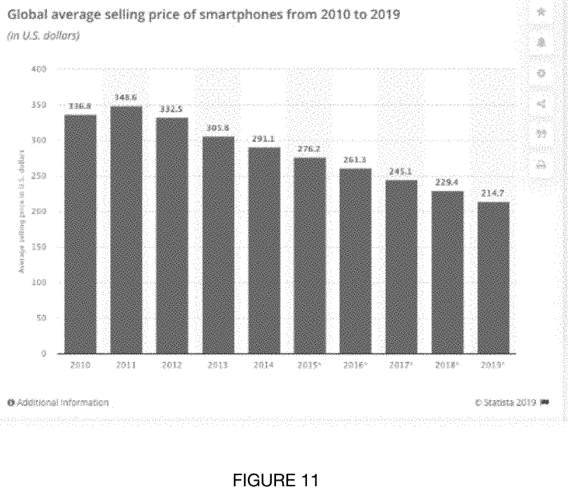

FIG. 12: Average smartphone prices by region in 2017¹³¹ ¹³¹ Data source: https://www.gfk.com/de/insights/press-release/durchschnittlicher-weltweiter-verkaufspreis-fuer-smartphones-verzeichnet-rekordwachstum-im-4-quartal-2017/ (accessed 27 Nov. 2019).

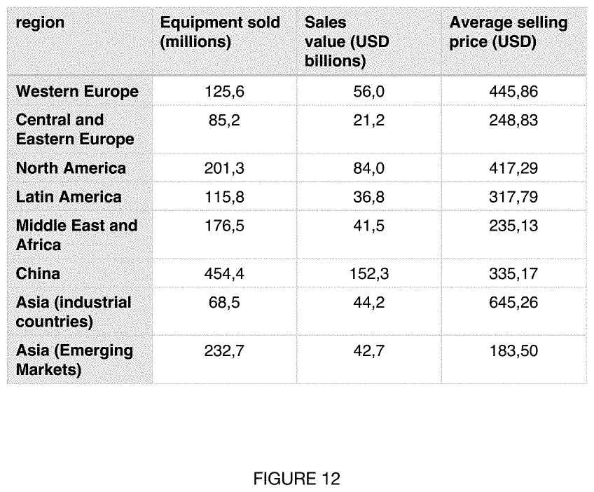

FIG. 13: Average worldwide smartphone prices (high-end and low-end devices)¹³² ¹³² Datenquelle: https://blog.gfk.com/2014/09/smart-value-in-the-smartphone-market-the-highs-and-lows/(abgerufen am 27 Nov. 2019).

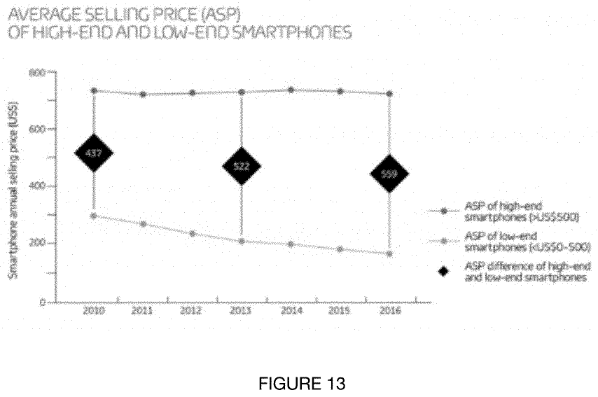

FIG. 14: Proportion of smartphone sales below USD 100 in certain regions in 2013¹³³ ¹³³ Datenquelle: https://blog.gfk.com/2014/09/smart-value-in-the-smartphone-market-the-highs-and-lows/(abgerufen am 27 Nov. 2019).

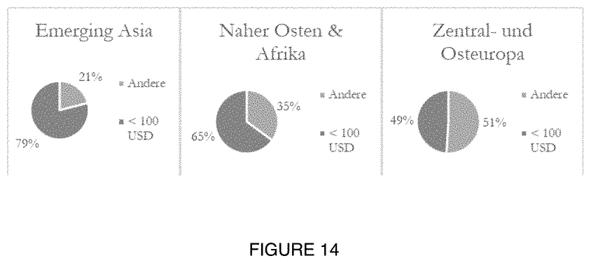

FIG. 15: Composition of the selling price of a product¹³⁴ ¹³⁴ Source: Picot, BB, axe. 13/1986 to issue 27/1986, p. 3.

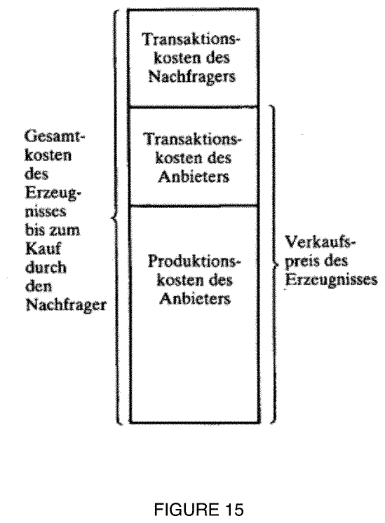

FIG. 16: One-Blue LLC: BD Recorder Software—Distribution of “Licensed Patents” to the Continents

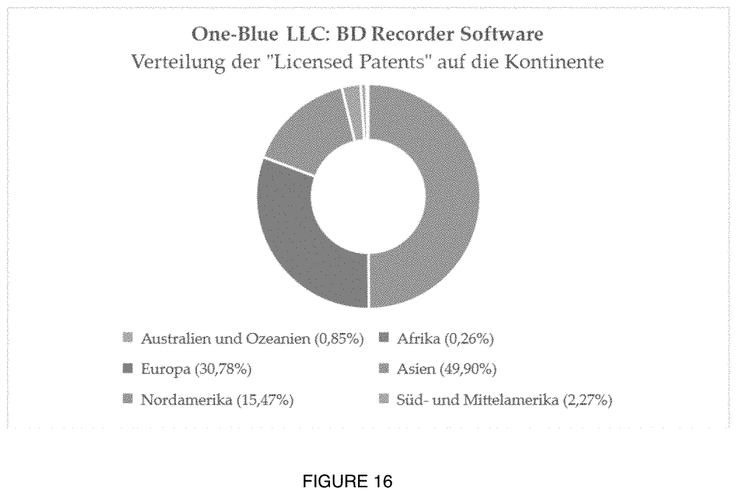

FIG. 17: One-Blue LLC: BD Recorder Software—Breakdown by validation states

FIG. 18: Number of transactions

FIG. 19: Discrimination in case of “reset” of licensing practice

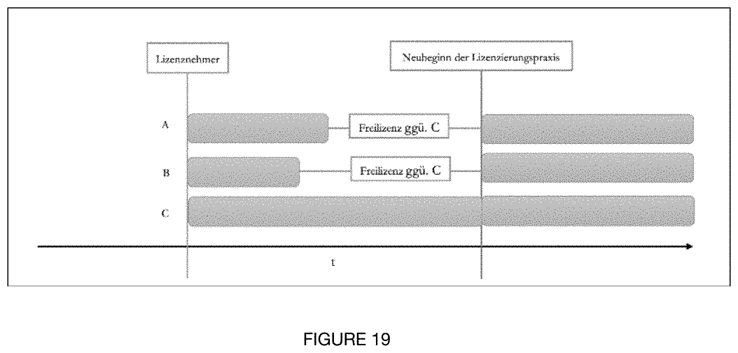

FIG. 20: Avoidance of discrimination in case of “reset” of licensing practice

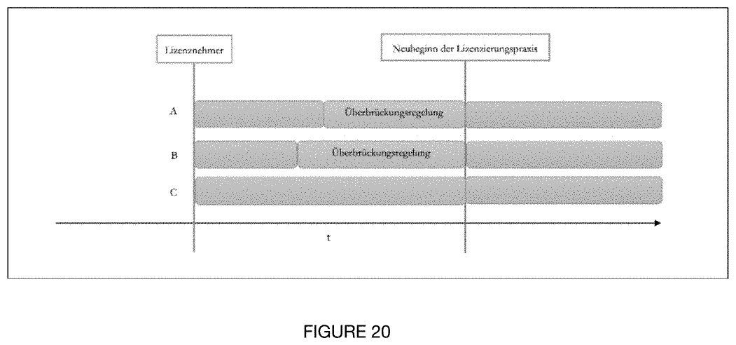

FIG. 21: Ratio of newly granted patents to expiring patents¹³⁵ ¹³⁵ Source: quoted from Mallinson, p. 19 m.V.a. Thomson Innovation.

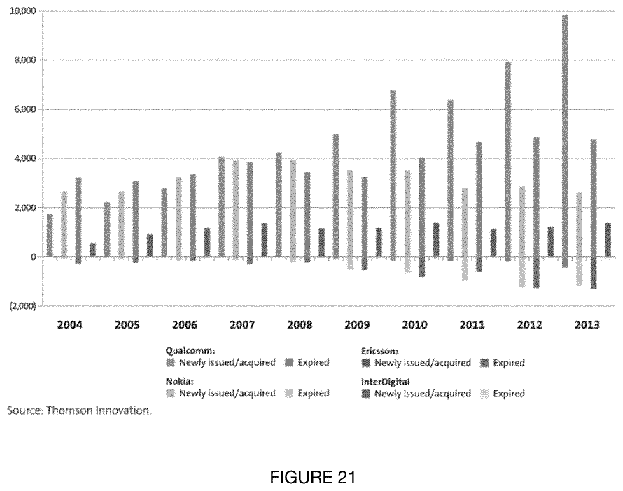

FIG. 22: Overview of flat rates for settlement types

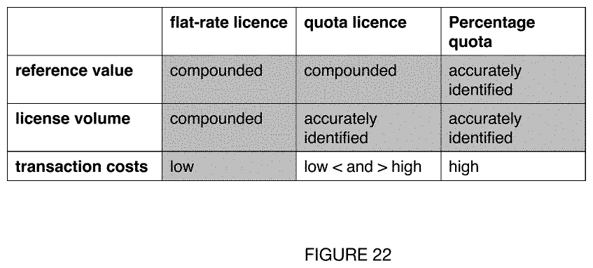

FIG. 23: The “Smartphone Royalty Stack”¹³⁶ ¹³⁶ Source: Armstrong/Mueller/Syrett, p. 68.

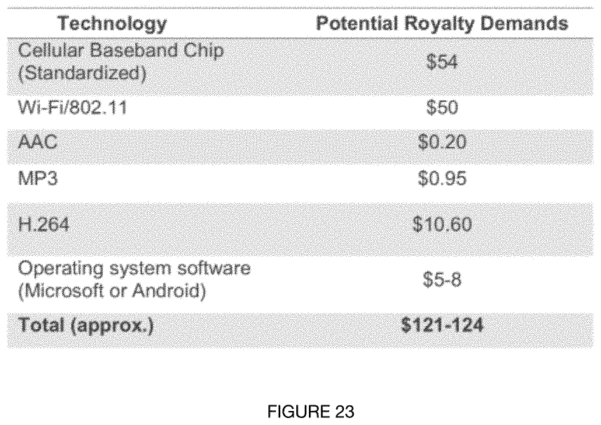

FIG. 24: Plytics—Top 5G SEP Owners¹³⁷ ¹³⁷ Source: IPlytics, https://www.iam-media.com/who-leading-5g-patent-race (accessed 27 Nov. 2019).

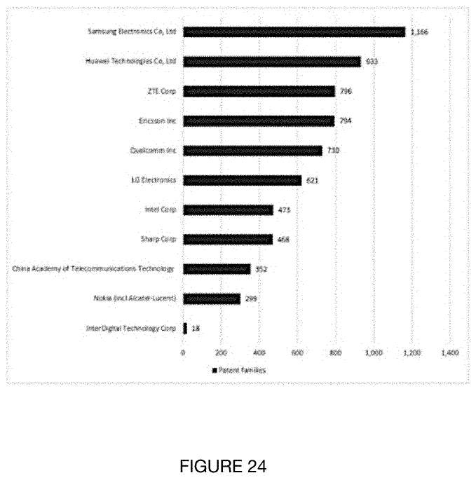

FIG. 25: IPlytics—Top 5G Contributors¹³⁸ ¹³⁸ Source: IPlytics, https://www.iam-media.com/who-leading-5g-patent-race (accessed 27 Nov. 2019).

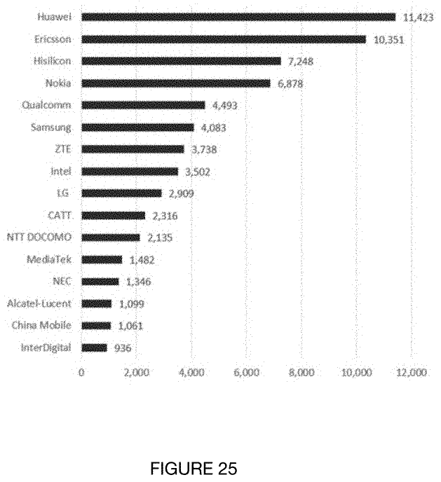

### DETAILED DESCRIPTION OF THE PREFERRED EMBODIMENT

The costs of such an essentiality assessment currently amount to approximately USD 10,000 per patent examined.¹³⁹ ¹³⁹ United States District Court Central District of California, Entsch. v. 8 Nov. 2018, SACV14-00341 JVS (DFMx), S. 30.

Millien and Schnitzer, on the other hand, suggest that the European Patent Office should in future take over essentiality testing as an independent organisation.¹⁴⁰ Picht¹⁴¹, Hoffnann¹⁴² and Schaefer/Czychowski¹⁴³ encourage the establishment of a specialised agency or collecting society.¹⁴⁴ ¹⁴⁰ Millions of carvers, iam.com.¹⁴¹ Picht, GRUR 2019, 1097 [1103].¹⁴² Hoffmann, Academy Heidelberg—FRAND 2019.¹⁴³ Schaefer/Czychowski, GRUR 2018, 582.¹⁴⁴ Similar to Contreras, FRAND Rate Setting, p. 27 et seq., which, however, is leading to a global judicial tribunal.

In practice, the negotiating parties usually do not strive for absolute certainty as to the validity and essentiality of the law, but need a reliable assessment of the probability of validity and essentiality in order to create the necessary legal certainty for license negotiations.¹⁴⁵ A comprehensive, fundamental review of all patents declared essential would help the negotiating parties to turn to the evaluation of the quality of¹⁴⁶ the portfolio patents offered for licensing and limit the quantitative scope of the evaluation. If worthless patents can be sorted out during the evaluation and therefore do not participate in the value creation of the license fee, it is not worth extending their term of protection. The phenomenon of over-declaration and the burden on standards of declared SEPs should then decline in the long term. ¹⁴⁵ Kühnen also proposes a summary review of the legal status and use of portfolio patents, see Kühnen, Chapter E, paragraph 437 et seq.¹⁴⁶ Ann, VPP Spring Symposium 2019, p. 6.

It was worked out that standardisation is advantageous for society and competition as long as access to the standardisation process and the result of standardisation is and remains open for all interested parties. At least in the case of the large institutional standardization organizations, this prerequisite is fulfilled from a legal point of view.

However, as has also been shown that the phenomenon of over-declaration and the increasing notification activity of standardisation participants are de facto threats to effective market access under FRAND conditions. Because of the sheer mass of patents declared to be essential, even technically experienced companies find it¹⁴⁷ difficult to divide the density of patent protection into “chaff and wheat”. The standardisation organisations secure their social mission and their antitrust raison d'être by means of essentiality reports including FRAND declarations of commitment. However, since the question of actual essentiality is not further examined and followed up, the standardisation organisations—and also the companies involved in standardisation—increasingly lose control over which patents are actually essential for the adopted standards. ¹⁴⁷ Wild, iam.com.

It will be shown what changes the terminal equipment markets in the mobile communications sector have undergone over the past two decades and how the new competitive conditions have affected the licensing market.

In the first years of this millennium, the terminal equipment markets in the electronics and mobile communications sectors were primarily served by research-based companies that played an active role in the development of fundamental technological progress. In other words, the companies that fueled technological progress were typically also the market leaders in the terminal equipment markets.

The market situation has changed considerably over the past fifteen years. Since then, the end devices offered have had approximately the same basic functionalities and the underlying standardized technology is regarded as available as a matter of course. End users' purchasing decisions are increasingly based on non-standard implementation elements and features—such as device design, charging cycles, applications and the maturity and safety of operating systems.

This change has created new companies with new sales strategies that focus on the implementation functionalities demanded by customers. The so-called standard implementers often only have a basic understanding of the standardized technology, since, for example, the components necessary for the connectivity of the end devices are supplied by chip manufacturers.

In the following, this development will be traced in particular on the basis of market data. In 2002, Nokia sold the largest number of handsets in the world, known as handsets, and served 35.1% of the world market (151.4 million units). Nokia had a significant lead of almost twenty percentage points over the second strongest company, Motorola (16.9%, 72.8 million units). Samsung was also present on the worldwide market (9.7%, 41.7 million units), followed by Siemens (8%, 34.6 million units), Sony Ericsson (5.4%, 23.1 million units) and LG (3.2%, 13.8 million units). A total of around 431.6 million mobile phones were sold worldwide in 2002.

Market conditions in 2009 were similar. Nokia led the world market in terms of sales and had a market share of 36.4% out of 440.9 million units sold. Samsung had already replaced Motorola as the company with the second highest sales volume and served 19.5% of the world market (235.8 million units) with its mobile phones, followed by LG (10.1%, 122.1 million units). Motorola and Sony Ericsson only had market shares of 4.8% (58.5 million units) and 4.5% (54.9 million units) respectively at that time. The overall market also grew significantly between 2002 and 2009 and already amounted to around 1.2 billion mobile phones in 2009.

Between 2009 and 2014, after the introduction of the iPhone in July 2007, the smartphone moved into the focus of demand by end customers. Although smartphones have the same basic mobile functionality as traditional mobile phones, these phones have been equipped with more computing power and larger displays. This allowed users to access a variety of functionalities and applications previously executed by PCs, such as access to the Internet (via second and third generation mobile standards). This change in demand had a significant impact on market conditions. By 2014, Samsung had taken the lead in the market and had a market share of 24.7% with 307.6 million smartphones sold. Apple, boosted by the success of the iPhone, was catapulted to second place in the global sales charts (15.4% out of 191.4 million units sold), followed by its new competitors Lenovo (6.5% out of 81.4 million units) and Huawei (5.5% out of 68.1 million units). LG also achieved a market share of 4.5% (57.7 million units) for smartphones. A total of 1.25 billion smartphones were sold in 2014.

Siemens, Motorola, Nokia and Ericsson had in the meantime divested their mobile phone businesses,¹⁴⁸ with the two Scandinavian companies Nokia and Ericsson concentrating on the mobile network business. ¹⁴⁸ See https://www.manager-magazin.de/digitales/it/a-278487.html (accessed 27 Nov. 2019); https://www.computerwoche.de/a/siemens-wirft-die-handys-raus,556275,2 (accessed 27 Nov. 2019); https://www.wiwo.de/technologie/gadgets/klassiker-im-abseits-die-verlierer-des-smartphone-booms/6548174.html (accessed 27 Nov. 2019).

By the end of 2018, Huawei has caught up with Apple. Samsung continues to lead the global smartphone market with a market share of 21.2% and 293.7 million units sold. Apple sold 212.1 million iPhones (15.3%) and Huawei already sold 206 million smartphones (14.8%). Xiaomi (8.7% at 120.3 million units) and Oppo (8.6% at 119.6 million units) are now new strong sellers and have pushed Lenovo and LG out of the top 5 smartphone sales worldwide. In 2018, 1.39 billion smartphones were sold worldwide.

In the third quarter of 2019, Huawei (19%) replaced Apple (12.3%) as the second-largest smartphone manufacturer in terms of sales, while Xiaomi (9.2%) and Oppo (9.1%) continued to catch up with the market leaders. If one looks at the parallel activities of these companies in standardization, i.e. the research and further development of basic mobile communications technology, a completely different picture emerges. With Ericsson and Nokia, two companies rank in the top 3 of the ranking according to the cumulative standardization contributions between 1999 and 2017, which since the beginning of the commercial use of mobile radio have produced innovations and decisively influenced standardization.

Huawei and ZTE, on the other hand, have only dealt with standardization in the past decade. According to Huawei, it holds 865 patents essential for LTE (15% of the total), 778 patents essential for UMTS (6% of the total) and 145 patents essential for GSM (2% of the total¹⁴⁹). For the 5th generation NR mobile standard, Huaweis's share is estimated at around 8%.¹⁵⁰ ¹⁴⁹ https://www.huawei.com/us/industry/standards-contributions/index.htm (accessed 27 Nov. 2019).¹⁵⁰ https://www.iam-media.com/who-will-be-technology-leader-5g-part-two (accessed 27 Nov. 2019).

The effort Huawei is putting into standardization is considerable when you consider that the company has only been actively involved in standardization since 2010.¹⁵¹ Huawei already made more technical suggestions for the LTE standard than Nokia, for example. For the 5th generation mobile standard, Huawei leads the list of the most active standardization subscribers even ahead of Nokia and Ericsson. ¹⁵¹ https://www.huawei.com/us/industry/standards-contributions/hw-u_167829.htm (accessed 27 Nov. 2019).

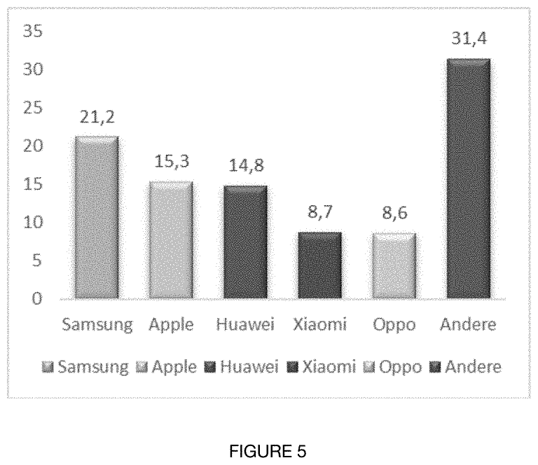

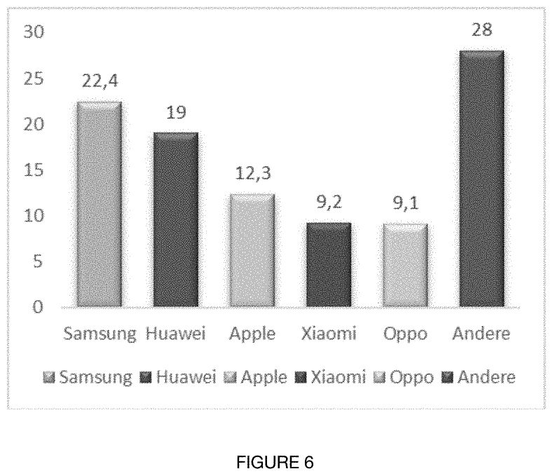

Huawei is thus now the only company among the best-selling companies on the smartphone market (Samsung, Huawei, Apple, Xiaomi, Oppo, cf. FIG. 5 and FIG. 6) that is noticeably committed to the further development of the underlying mobile communications technology.¹⁵² While Samsung still operates in the lower range of active standardization participants, companies such as Apple, Xiaomi, Oppo, TCL and HTC participate in standardization only to a negligible extent, if at all. ¹⁵² This is also largely due to the fact that Huawei serves not only the handset market but also the network equipment market.

Despite the continuous development of mobile communications technology, the average device prices demanded worldwide for smartphones have been falling steadily since 2010. In 2010, a smartphone cost an average of around USD 337 worldwide. In the meantime, the average price realized worldwide has fallen to only around USD 215 by 2019. This corresponds to an average price decline of 36.2% over the past nine years.

The saturation of the markets and the average prices achieved for smartphones, however, vary considerably from region to region. The market research institute GfK calculated the following regional data for 2017:

The different average prices are not only due to the different regional purchasing power, but are also due to the fact that regionally active smartphone manufacturers provide different functionalities in demand and the network expansion rates vary from region to region. While emerging markets are primarily selling low-cost smartphones with 3G functionality, for example (so-called low-end smartphones), customers in industrialized countries are demanding advanced smartphones with 4G and NFC functionality and special display technologies (e.g. OLED), for example (so-called high-end smartphones). The average worldwide selling price does not express the different sales categories. There are significant price differences between the lower and upper market segments:

The market research institute GfK points out, for example, that in 2013 the market share of low-priced smartphones with a selling price of less than USD 100 reached a considerable level in the markets in Asia (Emerging Asia), the Middle East and Africa as well as Central and Eastern Europe. By contrast, 61% of global high-end smartphone sales with realized prices above USD 500 in 2013 were accounted for by the highly developed industrial nations in Asia, North America and Western Europe.¹⁵³ ¹⁵³ Datenquelle: https://blog.gfk.com/2014/09/smart-value-in-the-smartphone-market-the-highs-and-lows/(abgerufen am 27 Nov. 2019).

The data collected provides evidence for two interesting aspects: On the one hand, the balance of power on the global sales market for mobile phones and smartphones has shifted considerably over the past fifteen years. While the leading companies in mobile communications standardization, i.e. the research- and development-intensive sector, with the exception of Huawei and possibly Samsung, have either sold or discontinued their handset business as a whole, companies without significant standardization activities of their own are now leading the global market in terms of sales figures and revenues.

At the same time, the average worldwide selling price for smartphones has been falling constantly for ten years and the regional markets are now highly segmented. In a comparatively small part of the world, manufacturers of high-end smartphones are achieving extremely high selling prices averaging over USD 700, while in the rest of the world market saturation is being driven primarily by low-cost and low-end smartphones at selling prices below USD 100.

This discrepancy in the regional sales prices is understandable in itself and is due to the global economic development. However, the balance between social benefits and fair reimbursement of SEP holders as an incentive for R&D activities in the field of mobile communications technology, on which standardisation is based, could be problematically affected by the fact that the standard implementers—as high-sales companies—determine the selling prices. The fact that the companies active in standardization do not (any longer) influence the selling price means that the value of the smartphone is increasingly decoupled from the value of standardized technology and the price decline on the technology market is accepted in favour of aggressive growth strategies on the sales market.¹⁵⁴ ¹⁵⁴ https://blog.gfk.com/2014/09/smart-value-in-the-smartphone-market-the-highs-and-lows/ (abgerufen am 27 Nov. 2019).

In practice, this leads to a situation where SEP holders active in standardisation set a fair and reasonable price for access to the outcome of standardisation in order to reward them fairly and appropriately for their R&D activities and entrepreneurial risk. The standard implementers would in principle have to price this license fee into the standard-compliant products offered. Due to the high price pressure, especially in the low-price market segments, the standard implementers, i.e. the companies with the largest product sales, are increasingly refusing to pay the license fees demanded by SEP holders. They require royalties to be reduced, for example by proposing a smaller reference value than the terminal (e.g. the smallest salable patent-practicing unit, SSPPU for short¹⁵⁵) or by requiring territorially limited licenses.¹⁵⁶ ¹⁵⁵ Vgl. HTC in United States District Court Eastern District of Texas, Entsch. v. 23 May 2019, 6:18-CV-00243-JRG, S. 8. Dazu näher in § 21 Abschnitt III.1.b); Putnam, Fordham International Law Journal, 2018 (Vol. 41), 953 [967]; Nilsson, GRUR Int 2017, 1017 [1018]; s.a. Apple, A Statement on FRAND Licensing of SEPs.¹⁵⁶ Cf. Haier in OLG Düsseldorf, judgement v. v. 30 Mar. 2017, I-15 U 66/15, ref. no. 19=GRUR 2017, 1219.

Patent holders refer to the strategy of not paying license fees for as long as possible in order to be able to sell cheaper mobile phones on the market as a “hold-out”¹⁵⁷ strategy or “free riding” or “patent dodging”.¹⁵⁸ ¹⁵⁷ Basic: Chien, pp. 20 to 25.¹⁵⁸ See Suh, iam.com.

The views of standard implementers and SEP holders on the determination and calculation of a FRAND license fee are currently increasingly at odds before infringement courts and antitrust authorities worldwide. Over the past decade, they have also had an impact on how the courts and antitrust authorities view the antitrust objections to compulsory licensing and the licensing practices of SEP holders. The reception of the market changes on the technology market and the sales markets described by case law, in particular by the infringement courts.

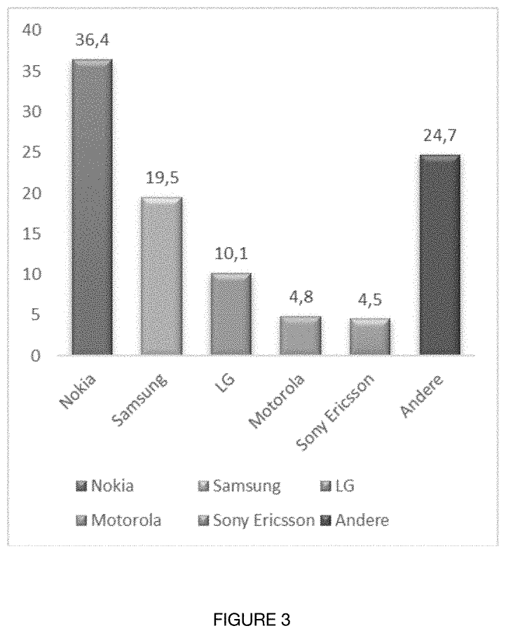

This will examine how case law has taken up and assessed the changed market situation described. As evidence, a practical example from the field of mobile radio terminals (handsets) will be examined. The Orange Book ruling of the Federal Court of Justice in 2009 was¹⁵⁹ a milestone in the international case law on compulsory licenses under antitrust law. The decision was issued on a defacto standard (i.e. there was no FRAND declaration of commitment for the patent¹⁶⁰) and dates from a time when the companies involved in standardisation in the mobile communications sector were themselves still selling handsets on a large scale on the global handset market (2009, see FIG. 3¹⁶¹) ¹⁵⁹ BGH, judgment of 6 May 2009, KZR 39/06=GRUR 2009, 694—Orange Book Standard; see Haedicke/Timmann/Bukow, § 9, marginal 226 et seq.; Kellenter, FS 80 Years Patent Jurisdiction in Düsseldorf, p. 255; Cordes/Gelhausen, Mitt. 2015, 426 [429]; Fuchs, NZKart 2015, 429 [430]; Gartner/Vormann, Mitt. 2009, 440; Jestaedt, GRUR 2009, 801; Maume/Tapia, GRUR Int 2010, 923; Kellenter, FS Mes, pp. 208 ff; Reimann/Hahn, FS Meibom, pp. 373; Voss/Fehre, FS 80 years of patent jurisdiction in Düsseldorf, p. 562 f.; Kling/Thomas, GWB, § 20, margin 159 ff; Osterrieth, margin 972 ff; Körber, NZKart 2013, 87.¹⁶⁰ See Section II of Section 3 above and, in particular, footnote 74.¹⁶¹ Market leader Nokia (36.4%), followed by Samsung (19.5%), LG (10.1%), Motorola (4.8%) and Sony Ericsson (4.5%).

The Orange Book judgement tends to be patent owner-friendly. The Federal Supreme Court assigned the obligation of the first license offer to the infringer, who had to submit at least one national license for at least the plaintiff s patent at the latest with the statement of defence and who subsequently had to comply with the contract through regular billing and provision of security.¹⁶² However, the license seeker could extend the license to other territories and portfolio patents on his own initiative and in order to create the legal certainty necessary for his business activities.¹⁶³ ¹⁶² Kühnen, Kap. E, Rz. 286.¹⁶³ Kühnen, Kap. E, Rz. 286.

With the increasing segmentation of the terminal markets and the increasing popularity of institutional standardization, the enforcement practices of SEP holders became the focus of competition authorities such as the European Commission in the years following the Orange Book ruling—especially when they had given a FRAND commitment for their standard essential intellectual property rights due to de iure standardization.

On Jan. 31, 2012, the Commission announced that it had initiated a formal investigation against Samsung regarding the possible abuse of a dominant market position by the judicial enforcement of SEP.¹⁶⁴ Background was among other things a complaint from Apple.¹⁶⁵ On 3 Apr. 2012 it was announced that—in response to complaints from Apple and Microsoft—two formal investigation proceedings had also been initiated against Motorola. At¹⁶⁶ that time Google had already taken over Motorola.¹⁶⁷ ¹⁶⁴ Press release IP/12/89 of 31 Jan. 2012, available at: https://europa.eu/rapid/press-release_IP-12-89_de.htm (accessed 27 Nov. 2019).¹⁶⁵ Press release IP/12/1448 of 21 Dec. 2012, available at: https://europa.eu/rapid/press-release_IP-12-1448_de.htm (accessed 27 Nov. 2019).¹⁶⁶ Press release IP/12/345 of 3 Apr. 2012, available at: https://europa.eu/rapid/press-release_IP-12-345_de.htm (accessed 27 Nov. 2019); Meyer, F S 80 Jahre Patentgerichtsbarkeit in Düsseldorf, p. 383, among others.¹⁶⁷ Press release IP/12/129 of 13 Feb. 2012, available at: https://europa.eu/rapid/press-release_IP-12-129_de.htm (accessed 27 Nov. 2019).

In view of the emerging changes in the practice of the European Commission, the 4b. On 21 Mar. 2013, the Second Civil Chamber of the District Court of Düsseldorf (Landgericht Düsseldorf) ruled on patent infringement proceedings between the Chinese corporations Huawei and ZTE and referred the questions to the European Court of Justice, which¹⁶⁸ ultimately led to the landmark decision of 16 Jul. 2015.¹⁶⁹ ¹⁶⁸ LG Düsseldorf, decision of 21 Mar. 2013-4b O 104/12=GRUR 2013, 614; in addition Verhauwen, GRUR 2013, 558; Hoppe-Janisch, Mitt. 2013, 384; Körber, NZKart 2013, 239; Osterrieth, Rz. 975.¹⁶⁹ EuGH, Urt. v. 16 Jul. 2015 in the version passed on 15 Dec. 2015, C-170/13=GRUR 2015, 764—Huawei/ZTE.

In its judgement of 15 Jul. 2015, the European Court of Justice reversed the procedure of¹⁷⁰ mutual obligations developed in Orange Book¹⁷¹. Pointing out that the standard implementer was not necessarily aware that he was using an essential and legally valid patent due to the high patent density around the standardization result, the European Court of Justice ordered the SEP holder to point out his essential patent to the user. The SEP holder must designate the SEP in question and indicate how it was allegedly infringed.¹⁷² ¹⁷⁰ EuGH, Urt. v. 16 Jul. 2015 in the version passed on 15 Dec. 2015, C-170/13=GRUR 2015, 764—Huawei/ZTE. In paragraph 30, the ECJ expressly refers to the Orange Book case law.¹⁷¹ Harmsen/Block, IPRB 2015, 260; Block, GRUR 2017, 121; Müller/Henke, Mitt. 2016, 62; Fuchs, NZKart 2015, 429; Cordes/Gelhausen, Mitt. 2015, 426; Hauck, NJW 2015, 2767 [2770]; Körber, W R P 2015, 1167; Kühnen, FS 80 Years Patent Jurisdiction in Düsseldorf, p. 312 ff; Voss/Fehre, FS 80 Years Patent Jurisdiction in Düsseldorf, p. 560 f; Kellenter/Verhauwen, GRUR 2018, 761.¹⁷² EuGH, Urt. v. 16 Jul. 2015 in the version passed on 15 Dec. 2015, C-170/13, margin 61 f.=GRUR 2015, 764—Huawei/ZTE.

In the case of a licensing request by the infringer, the European Court of Justice also assigned the obligation of the first FRAND offer to the SEP holder (and not—as in the case of the Orange Book standard—to the license seeker). The main reason for this—reversed—obligation regime was the consideration that the FRAND commitment of the SEP holder in legal and business transactions creates a legitimate trust in its observance, which honestly encourages the SEP holder to fulfil his licensing promise without any ifs or buts. In¹⁷³ support of this, the Court continued to refer to the fact that, where neither a standard license agreement nor license agreements already concluded with other competitors have been published, the SEP holder is in a better position than the alleged infringer to examine whether his offer meets the condition of equal treatment.¹⁷⁴ ¹⁷³ EuGH, Urt. v. 16 Jul. 2015 as amended by Decision of 15 Dec. 2015, C-170/13, margin no. 64=GRUR 2015, 764—Hua-wei/ZTE m.V.a. Opinion of Advocate General Wathelet of 20 Nov. 2014, C-170/13, margin no. 86=becklink 1035821: “As the Advocate General stated in No. 86 of his Opinion, the holder of an SEP may be expected to make such an offer if he has committed himself to the standardisation organisation to grant licenses under FRAND conditions’; see Kühnen, Chapter E, paragraph 267; Kühnen, FS 80 Jahre Patentgerichtsbarkeit in Düsseldorf, p. 311; Fuchs, NZKart 2015, 429 [433].¹⁷⁴ EuGH, Urt. v. 16 Jul. 2015 in the version passed on 15 Dec. 2015, C-170/13, no. 64=GRUR 2015, 764—Huawei/ZTE; see Kellenter, FS 80 Years Patent Jurisdiction in Düsseldorf, p. 263; Cordes/Gelhausen, Mitt. 2015, 426 [432].

While the EWCA¹⁷⁵ regards the procedure of the European Court of Justice merely as a “safe harbour”, the German courts examine the mutual obligations consecutively.¹⁷⁶ Thus, the enforceability in court of the claims for injunctive relief, recall and destruction^{177 178} now depends on the SEP holder fulfilling his initial obligations to notify the infringement and the first FRAND offer.179 ¹⁷⁵ EWCA, Resolution v. 23 Oct. 2018, Az. [2018] EWCA Civ 2344, Rz. 268 ff.¹⁷⁶ OLG Düsseldorf, decision of 13 Jan. 2016, I-15 U 66/15, margin no. 36=NZKart 2016, 139; OLG Karlsruhe, decision of 31 May 2016, 6 U 55/16, margin no. 31=NZKart 2016, 334; tendentially a.A. LG Mannheim, margin no. v. 4 Sep. 2019, 7 O 115/16, p. 7 (unpublished)).¹⁷⁷ On the destruction claim, which is not expressly mentioned in the judgment of the European Court of Justice, see OLG Düsseldorf, Urt. v. 30 Mar. 2017, I-15 U 66/15=GRUR 2017, 1219—Mobile Communication System; OLG Karlsruhe, Urt. v. 30 Oct. 2019, 6 U 183/16, ref. 134=BeckRS 2019, 28234.¹⁷⁸ Basically, the case-law of the European Court of Justice applies ex tunc and merely clarifies the autonomous interpretation in conformity with Union law (see BVerfG, decision of 6 Jul. 2010, 2 BvR 2661/06=NJW 2010, 3422, margin no. 81 et seq.; decision of 10 Dec. 2014, 2 BvR 1549/07=AP GG Art. 101 No. 66). The courts have granted the parties greater latitude in so-called “transitional cases” (cf. in this respect OLG Düsseldorf, OLG Düsseldorf, Urt. v. 30 Mar. 2017, I-15 U 66/15, margin no. 202 ff.=GRUR 2017, 1219—Mobile communication system; OLG Karlsruhe decision no. 31 May 2016, 6 U 55/16, margin no. 24=NZKart 2016, 334).¹⁷⁹ To the license request of the license seeker (see ECJ, judgment of the Court of First Instance of the European Communities, Case C-249/03) 16 Jul. 2015 in the version of the Resolution of 15 Dec. 2015, C-170/13, margin no. 63=GRUR 2015, 764—Huawei/ZTE), the case-law places extremely low requirements, so that this obligation is of hardly any significance in practice (see, for example, OLG Düsseldorf, OLG Düsseldorf, Urt. v. 30 Mar. 2017, I-15 U 66/15, ref. no. 223=GRUR 2017, 1219—Mobile communication system).

Despite international harmonization efforts,¹⁸⁰ more than four years after Huawei v ZTE, there are still disputes over what is FRAND in the individual case in many points.¹⁸¹ The courts are following a development that has lasted a quarter of a century in the licensing industry and is still in flux.¹⁸² Quite fundamental questions await scientific examination. For example, there is no consensus on whether the FRAND commitment, considered in isolation, is mandatory, i.e. whether the SEP in question is entitled to a license, irrespective of whether or not it conveys a dominant position to its holder on the downstream product market. It¹⁸³ is also unclear whether the given promise to license fair and reasonable merely prohibits exploitative licensing conditions or whether, beyond that, licensing is required which takes equal account of the interests of both sides. For the¹⁸⁴ purposes of the present treatment, there is no need to pursue all this further, as it is linked to the legal reality of the current case law.¹⁸⁵ However, two fundamental theses which emerge from the discussion and which are important for further considerations will be discussed in more detail below: ¹⁸⁰ “We recognise that, in the development of this important area, it is desirable that an internationally accepted approach should ultimately emerge.”, EWCA, Entsch. v. 23 Oct. 2018, Az. [2018] EWCA Civ 2344, Rz. 206.¹⁸¹ Block/Ratz, GRUR 2019, 797; Heinemann, GRUR 2015, 855.¹⁸² Block/Ratz, GRUR 2019, 797 [798].¹⁸³ See Kühnen, Chapter E, Rz. 267; Meyer, F S 80 Years of Patent Jurisdiction in Düsseldorf, p. 377 et seq.; LG Düsseldorf, Urt. v. 24 Apr. 2012, 4b O 273/10=BeckRS 2012, 9682—Access threshold.¹⁸⁴ On the state of opinion s. Cordes/Gelhausen, Mitt. 2015, 426 [432] f.; Kurtz/Straub, GRUR 2018, 136 [140]m.V.a. BGH, decision of 14 Jul. 2015, KVR 77/13=NJW 2015, 3643—Water prices Calw II; see again last District Court Mannheim, judgment of 4 Sep. 2019, 7 O 115/16, p. 52 ff. (unpublished).¹⁸⁵ See the thematic delimitation of the present work in § 1 Section II.

(A) What FRAND is a question of the individual case.

(B) FRAND is a corridor.

The examination of these assumptions and their consequences for the practical orientation of a licensing program is indispensable to understand how a licensing program must be balanced in order to be found to be FRAND by infringement courts and competition authorities such as the European Commission.

The courts grant the SEP holder discretion in individual cases, since FRAND does not mean a legal obligation to treat all trading partners equally on a schematic basis, but may in principle react to different market conditions in a differentiated manner¹⁸⁶. The Commission notes that FRAND is ‘not one-size-fits-all’, i.e. the solutions may vary from sector to sector and depend on the business models in question.¹⁸⁷ ¹⁸⁶ OLG Düsseldorf, Urt. v. 30 Mar. 2017, I-15 U 66/15, ref. no. 254 m.w.N.=GRUR 2017, 1219—Mobile communication system.¹⁸⁷ European Commission, COM (2017) 712 final of 29 Nov. 2017, p. 7; see also Weber/Brandt, MittdPA 2018, 153.

Judge Gilstrap stellte in HTC v Ericsson fest: “[ . . . ] whether a license meets the requirements of FRAND will depend on the particular facts of the case, as there is no prescribed methodology for calculating a FRAND license.”¹⁸⁸ ¹⁸⁸ United States District Court Eastern District of Texas, Entsch. v. 23 May 2019, 6:18-CV-00243-JRG, S. 7.

In Huawei/ZTE, too, the European Court of Justice emphasises—albeit with regard to the action pursuant to Art. 102 TFEU—that “due account must be taken of the particular legal and factual circumstances of the specific case” when examining a possible cartel infringement due to the enforcement of a standard essential patent which conveys a dominant position to its owner.¹⁸⁹ This aspect was highlighted by the High Court of Justice of England and Wales¹⁹⁰, the England and Wales Court of Appeal¹⁹¹ and the Gerechtshof Den Haag in¹⁹² their decisions on the enforcement of standard essential patents. The Düsseldorf Higher Regional Court also points out in Sisvel v Haier that not every difference in the terms and conditions can be regarded as an expression of an abuse of a dominant position.¹⁹³ ¹⁸⁹ EuGH, Urt. v. 16 Jul. 2015 as amended by the resolution of 15 Dec. 2015, C-170/13, paragraph 56=GRUR 2015, 764—Huawei Technologies./. ZTE et al. m.V.a. EuGH, judgment of the European Court of Justice 27 Mar. 2012, C-209/10=GRUR Int. 2012, 922—Post Danmark; cf. on the appreciability of the infringement on the relevant market supplementary: EuGH, Urt. v. Urt. v. 19 Apr. 2018, C-525/16, marginal 25-26=GRUR Int. 2018, 850 with Hemler note—MEO.¹⁹⁰ EWHC, Resolution v. 5 Apr. 2017, Az. [2017] EWHC 711 (Pat), Rz. 739 ff.¹⁹¹ EWCA, Resolution of 23 Oct. 2018, Az. [2018] EWCA Civ 2344, Rz. 240.¹⁹² Gerechtshof Den Haag, Resolution of 7 May 2019, Ref. 200.221.250/01, recital 4.171.¹⁹³ OLG Düsseldorf, Urt. v. 30 Mar. 2017, I-15 U 66/15, ref. no. 256=GRUR 2017, 1219—Mobile communication system.

The circumstances of the individual case must therefore be taken into account at different levels. On the basis of this international consensus, the extent to which the SEP holder must take into account the circumstances of the individual case and the identity of the licensee when preparing and submitting a FRAND offer is of particular importance for this work.¹⁹⁴ ¹⁹⁴ On the current considerations of the German courts, see § 11.

The second key finding is that FRAND is not just a one-off license fee¹⁹⁵, but that the FRAND terms form a corridor¹⁹⁶ within which the SEP holder is left with ‘considerable discretion’, since the FRAND commitment does not oblige the SEP holder to ‘most-favoured-nation’, but must grant the license seeker access to the standardisation result in such a way that he can place a competitive offer on the product market.¹⁹⁷ The SEP holder can license flexibly within the corridor. ¹⁹⁵ EWHC, Resolution v. 5 Apr. 2017, Az. [2017] EWHC 711 (Pat), Rz. 169.¹⁹⁶ See also Haedicke, GRUR Int. 2017, 661 [664].¹⁹⁷ For this above in § 3 section III.

The European Commission decided in 2013 to review the licensing practice in the field of standard essential patents¹⁹⁸ and comes to the conclusion in its final report in 2015: ¹⁹⁸ Europäische Kommission, Fair, Reasonable and Non-Discriminatory (FRAND) Licensing Terms, S. 1.
“There is little doubt that in any given case, a range of different licensing terms and royalty rates could be considered as FRAND without substantially undermining the incentives for the parties to invest in standard development or implementation.”¹⁹⁹ ¹⁹⁹ Europäische Kommission, Fair, Reasonable and Non-Discriminatory (FRAND) Licensing Terms, S. 17 f.

Subsequent publications also point out that non-discriminatory treatment does not necessarily require identical royalties.²⁰⁰ Since FRAND conditions are not the same in every situation, the solutions may vary from industry to industry and depend on the respective business models of the license seekers.²⁰¹ ²⁰⁰ European Commission, Licensing Terms of Standard Essential Patents, p. 135.²⁰¹ European Commission, COM (2017) 712, p. 9.

In the opinion of the Düsseldorf Higher Regional Court in Sisvel v Haier²⁰² and Unwired Planet v Huawei²⁰³ and the Karlsruhe Higher Regional Court in Pioneer v Acer,²⁰⁴ the SEP holder must be granted generous room for manoeuvre in determining the FRAND conditions, since ‘there may be a large number of contractual arrangements which are to be regarded as fair, reasonable and non-discriminatory under the conditions prevailing in the relevant license market’.²⁰⁵ Where a license agreement provides for conditions outside the FRAND corridor, this derogation must be objectively justified on a case-by-case basis, for²⁰⁶ example where the conditions have been determined by a court.²⁰⁷ ²⁰² OLG Düsseldorf, Decree of 17 Nov. 2016, I-15 U 66/15 Rz. 18=GRUR-RS 2016, 21067, Holtorf/Traumann, GRUR-Prax 2017, 42.²⁰³ OLG Düsseldorf, Urt. v. 22 Mar. 2019, I-2 U 31/16, margin no. 413=GRUR 2019, 725—Improving Handovers: “the possible FRAND fee framework”, for details see § 10 section II.²⁰⁴ OLG Karlsruhe, Resolution of 31 May 2016, 6 U 55/16, margin 31 f.=NZKart 2016, 334.²⁰⁵ OLG Karlsruhe, Beschl. v. 8 Sep. 2016, 6 U 58/16, Rz. 52=BeckRS 2016, 17467—Decoding device with note Holtorf/Traumann, GRUR-Prax 2016, 560.²⁰⁶ OLG Düsseldorf, Urt. v. 30 Mar. 2017, I-15 U 66/15, ref. no. 254=GRUR 2017, 1219.²⁰⁷ OLG Düsseldorf, Urt. v. 22 Mar. 2019, I-2 U 31/16, Rz. 415=GRUR 2019, 725—Improving Handovers.

While it was quickly agreed in Germany that several contractual terms could be FRAND, Justice Birss, in the first British decision after the Huawei v ZTE decision of the European Court of Justice, initially took the view in infringement proceedings between Unwired Planet and Huawei that in each individual case only one concrete contractual arrangement was FRAND.²⁰⁸ He had in mind the alleged stalemate from the Vringo v ZTE²⁰⁹ proceedings, if the court finds both exchanged offers for FRAND. The²¹⁰ England and Wales Court of Appeal, under Lord Kitchin's chairmanship of the Appellate Court, clarified that various conditions may be FRAND: ²⁰⁸ EWHC, Resolution of 5 Apr. 2017, Az. [2017] EWHC 711 (Pat), marginal 169.²⁰⁹ EWHC, Entsch. v. 28 Nov. 2014, Az. [2013] EWHC 1591 (Pat) and [2015] EWHC 214 (Pat).²¹⁰ So-called “Vringo Problem”, EWHC, Resolution of 5 Apr. 2017, Az. [2017] EWHC 711 (Pat), marginal 149.
“the reality is that a number of sets of terms may all be fair and reasonable in a given set of circumstances.”²¹¹ ²¹¹ EWCA, resolution of 23 Oct. 2018, Az. [2018] EWCA Civ 2344, marginal 121.

The problem identified by Justice Birss was to be resolved in favour of the SEP holder, since the license seeker was not entitled to another (FRAND) alternative.²¹² The recent appeal decision in TQ Delta v Zyxel does not receive any further evidence in this respect since Zyxel had effectively waived a hearing on FRAND-related issues in the course of the proceedings and the Court therefore did not (any longer) deal with the examination of the exchanged offers.²¹³ ²¹² EWCA, resolution of 23 Oct. 2018, Az. [2018] EWCA Civ 2344, recital 125.²¹³ EWCA, Resolution v. 18 Jul. 2019, Az. [2019] EWCA Civ 1277, Rz. 7 and Rz. 38 ff.

In the Netherlands, at least three proceedings involving the infringement of a standard essential patent have already been decided by the supreme court. In the first case after the decision of the European Court of Justice in Huawei v ZTE, an infringement dispute between Philips and Archos, the Rechtbank Den Haag noted that a FRAND offer can and should be specifically negotiated or adapted as long as it falls within the FRAND corridor (“bandbreedte”).²¹⁴ In Philips v Wiko, the Court of First Instance, in its examination of non-discrimination, confirmed that the principle of non-discrimination did not mean that the exact same license structure and the same conditions should always be applied. Facts and circumstances specific to a particular licensee could lead to the conclusion of other (also) FRAND terms without unduly affecting other licensees in competition.²¹⁵ ²¹⁴ Rechtbank Den Haag, Resolution of 8 Feb. 2017, ECL:NL:RBDHA:2017:1025, Section 4.3.²¹⁵ Rechtbank Den Haag, Resolution of 2 Jul. 2019, ECL:NL:GHDHA:2019:1066, Section 4.34.

In the USA, Judge Gilstrap found in HTC v Ericsson that both Ericsson's offers to HTC were FRAND compliant, although they provided for different price structures. The first offer was a unit license of USD 2.50, the second a percentage license (1%) with one floor (USD 1.00) and one cap (USD 4.00)—each for one LTE-enabled terminal. The²¹⁶ Texan court thus confirmed the conclusion drawn by Judge Selna in TCL v Ericsson that there is no uniform license rate which is necessarily FRAND.²¹ Judge Selna also noted, as regards the non-discriminatory nature of the offer, that different rates offered to different licensees could be FRAND under the economic conditions of the respective license.²¹⁸ ²¹⁶ United States District Court Eastern District of Texas, Entsch. v. 23 May 2019, 6:18-CV-00243-JRG, S. 14, [CL 25].²¹⁷ United States District Court Central District of California, Entsch. v. 8 Nov. 2018, SACV14-00341 JVS (DFMx), S. 109, vgl. schon United States District Court Eastern District of Texas, Zwischenentsch. v. 7 Jan. 2019, 6:18-CV-00243-JRG, S. 12.²¹⁸ United States District Court Central District of California, Entsch. v. 8 Nov. 2018, SACV14-00341 JVS (DFMx), S. 109.

In Huawei v Samsung,²¹⁹ the Shenzhen Middle People's Court determined a global reference value for a FRAND license and noted that offers outside this reference value could also be FRAND.²²⁰ ²¹⁹ Middle People's Court Shenzhen, judgment of 4 Nov. 2018, Huawei v. Samsung (2016), Guangdong 03 Minchu No. 816 and 840.²²⁰ See Vary/Li/Yiu, twobirds.com.

The conclusion reached by international courts as a result of the decisions referred to in extracts²²¹ shows that, in principle, several contractual arrangements for FRAND license agreements with a specific licensee—and/or with comparable licensees—are possible without resulting in discrimination which actually results in a considerable competitive disadvantage. The view that there is a corridor of FRAND conditions is thus fundamentally predominant internationally, but it has not yet been dogmatically worked out. The possibility of providing for a large number of options is applied both to the license seeker himself and to the issue of discrimination against the license seeker in relation to comparable licensees. Only the Düsseldorf Higher Regional Court made it clear in Unwired Planet v Huawei that two different standards can apply in this respect: ²²¹ For further international decisions please refer to Block/Ratz, GRUR 2019, 797 and Contreras, The New Extraterritoriality, e.g. Japan: Obergericht fr Geistiges Eigentum, GRUR Int. 2015, 142—Apple v. Samsung I, India: Deli High Court, December v. 12 Jul. 2018, CS (COMM) 24/2016 and CS (COMM) 436/2017, Spain: Sanjuan/Camapuzano; Beijing High Court, December v. 28 Mar. 2018, (2017) Jing Min Zhong Zi No. 454=GRUR Int 2019, 254 [260]—Sony Mobile.

The 2nd Civil Senate points out that the SEP holder is not yet bound by the principle of non-discrimination if he concludes the first license for a specific matter for his portfolio.²²² Since this first license must only be measured against the requirements of “fair and reasonable”, the corridor has only one upper limit at this point in time, the abuse of exploitation. The SEP holder can start within this range between a free license and a license that is not yet exploitative. ²²² Cf. OLG Düsseldorf, judgment v. 22 Mar. 2019, I-2 U 31/16, Rz. 413=GRUR 2019, 725—Improving Handovers.

For all further licensing “the prohibition of discrimination is moving to the centre of consideration”²²³ The large number of possible contractual arrangements is then limited to non-discriminatory deviations from the initial license for comparable situations. This does not mean, however, that the SEP holder is bound in all respects by the initial license—he may, for example, change the license category—²²⁴ but he must ensure that any deviations are non-discriminatory to the extent that they do not give rise to appreciable restrictions of competition. The SEP holder must be able to objectively justify deviations relevant to discrimination. The Düsseldorf Higher Regional Court points out that this could lead to the situation that, in the second licensing procedure, a non-exploitative license offer is nevertheless not FRAND, even though it would still have been within the permissible limits in a hypothetical first allocation. The SEP holder then “did not make full use of the FRAND fee framework which was possible in itself—or even clearly—during the initial licensing process”.²²⁵ ²²³ Cf. OLG Düsseldorf, judgment v. 22 Mar. 2019, I-2 U 31/16, Rz. 413=GRUR 2019, 725—Improving Handovers.²²⁴ Vgl. United States District Court Eastern District of Texas, Entsch. v. 23 May 2019, 6:18-CV-00243-JRG, S. 14, [CL 25].²²⁵ OLG Düsseldorf, Urt. v. 22 Mar. 2019, I-2 U 31/16, Rz. 413=GRUR 2019, 725—Improving Handovers.

The FRAND corridors, according to the dogmatic understanding of the SEP holder, open up discretionary leeway for the SEP holder²²⁶ and thus for the parties to negotiate. Initial licensing is of central importance, as this negotiation is a decisive quality test for the SEP holder's portfolio under real market conditions. According to the understanding of the Düsseldorf Higher Regional Court, the SEP holder sets the benchmark for comparable facts through this agreement.²²⁷ The “purely subjective failure of the SEP holder to negotiate or deliberate yielding of the SEP holder during the initial licensing” could not later be recognised as a factual reason for discriminatory deviations in favour of the SEP holder²²⁸. Only if there are compelling economic reasons (which, according to German legal understanding, would mark a loss of the business basis in relation to all relevant license agreements) could all license agreements be adapted—and thus the license fee increased.²²⁹ Serious changes in the portfolio value are likely to constitute such a compelling economic reason, so that a correction remains possible—however, according to the understanding of the Düsseldorf Higher Regional Court, only in rare exceptional cases. ²²⁶ So already Haedicke/Timmann/Bukow, § 9, marginal 239 m.V.a. BGH, judgment v. 13 Jul. 2004, KZR 40/02=GRUR 2004, 966 [969]—Standard bung barrel.²²⁷ See above, § 10 Section II.2.²²⁸ OLG Düsseldorf, Urt. v. 22 Mar. 2019, I-2 U 31/16, Rz. 413=GRUR 2019, 725—Improving Handovers.²²⁹ OLG Düsseldorf, Urt. v. 22 Mar. 2019, I-2 U 31/16, margin no. 414=GRUR 2019, 725—Improving Handovers; the factual conditions for § 313 BGB are to be set extremely high in practice.

A far more important option for the SEP holder in practice to regain freedom of action in the licensing conditions is the possibility of agreeing uniform fixed contract terms, which means that all contracts relating to a certain IPR portfolio end on a fixed date²³⁰. Although such a “reset” of licensing practice has the effect that competitors who apply for a license late only benefit from a short contract term (end date minus date of conclusion), legal concerns do not arise in this respect because the only decisive factor for non-discriminatory licensing is that all licensees (=competitors) have to cope with the same license fee and thus cost burden (depending on their licensing circumstances) at each individual point in their business activity on the product market. ²³⁰ OLG Düsseldorf, Urt. v. 22 Mar. 2019, I-2 U 31/16, ref. no. 414=GRUR 2019, 725—Improving Handovers; see § 21 section 1.2 below for details.

The differentiated use of the obligations for exploitation-free²³¹ and non-discriminatory licensing shows the applicable yardstick within which the free forces of the market can unfold. A SEP portfolio will only be able to reach the upper end of the relevant corridor if it is actually perceived as valuable by the market and if license seekers are willing, for instance, to pay a higher license fee for access to the portfolio patents. If the SEP holder deliberately enters the market defensively with his offer, usually in order to achieve a high licensing rate quickly through less resistance in the negotiations, he may forfeit his chance to achieve more advantageous licensing conditions at a later point in time.

The corridor approach thus rewards SEP holders who place their license on the market in a value-oriented manner and achieve a result corresponding to the value in contract negotiations. As is shown in § 9 of this paper, the European Court of Justice in Huawei v ZTE clarified that the holder of a dominant standard essential patent has the obligation to submit an offer on FRAND terms to a license seeker who has declared his willingness to license before filing an action for injunction or recall²³². He must also inform the license seeker of the license fee requested and explain the method of calculating the offer. The European Court of Justice argues that the SEP holder is fundamentally in²³³ a better position to check whether his offer meets the condition of equal treatment than the alleged infringer. ²³¹ Haedicke/Timmann/Bukow, § 9, marginal 259; see also Loth/Hauck, GebrMG, § 20, marginal 21; Picht, GRUR Int 2017, 569 [575]; Treacy/Hunt, GRUR Int 2018, 91 [96].²³² EuGH, Urt. v. 16 Jul. 2015 in the version passed on 15 Dec. 2015, C-170/13, Ls. 1, paragraph 63=GRUR 2015, 764—Huawei Technologies/ZTE Corp. et al.²³³ If neither a standard license agreement nor license agreements already concluded with other competitors have been published.

On the basis of these considerations, the German courts post Huawei v ZTE demand that the SEP holder explain to the license seeker why the offer submitted to him falls within the FRAND corridor in the individual case and how the SEP holder ensures on an ongoing basis that the initially agreed license fee remains FRAND.

According to the understanding of the German courts, the SEP holder must not only explain to the license seeker the method of calculating his FRAND offer, but also make the calculation methodology of the offer transparent, in²³⁴ particular with a view to ensuring that the offer is non-discriminatory. ²³⁴ LG Düsseldorf, Ert. v. 13 Jul. 2017, 4a O 27/16=GRUR-RS 2017, 130336; LG Mannheim, Urt. v. 10 Nov. 2017, 7 O 28/16=GRUR-RR 2018, 273, 278—Radio station; Higher Regional Court Karlsruhe, Germany, v. v. 30 Oct. 2019, 6 U 183/16, no. 134=BeckRS 2019, 28234; see also Kühnen, chapter E, no. 335.

In addition to the license fee, the specific calculation parameters applied (relevant reference value; applicable license rate; graduated scale, if applicable) should²³⁵ also be mentioned and it explained why the SEP holder considered the remuneration parameters proposed by him to be FRAND.²³⁶ An exact mathematical derivation of the required royalties is not necessary,²³⁷ however, since there is usually no single royalty which is FRAND alone.²³⁸ After the Landgericht Mannheim (Regional Court Mannheim) initially provided for conceivably low conditions for the presentation of the method of calculation, the²³⁹ 7th Civil Chamber of the Landgericht Mannheim now also takes the view that the calculation methodology for the offer should be made transparent, for example “by presenting a standard license program lived in contract practice and accepted by third parties or by using other reference values from which the required license fee is derived, e.g. from a pool license fee which in practice is paid by third parties for a patent pool which also includes patents relevant to the standard in question”²⁴⁰. The mere communication of multipliers on which the calculation of the license fee is based is not sufficient if it is not yet possible for the recipient of the offer to assess whether the offer is FRAND on the basis of these parameters.²⁴¹ ²³⁵ See also Rechtbank Den Haag, Entsch. v. 7 May 2019, ECL:NL:GHDHA:2019:1065.²³⁶ OLG Düsseldorf, Urt. v. 30 Mar. 2017, I-15 U 66/15, ref. no. 248=GRUR 2017, 1219; LG Düsseldorf, jurisdiction v. 13 Jul. 2017, 4a O 27/16, ref. 391=GRUR-RS 2017, 130336—mobile stations; see also Kühnen, chapter E, ref. 335²³⁷ Kühnen, Chap. E, Rz. 443; LG Düsseldorf, judgment of 9 Nov. 2018, 4a O 17/17, Rz. 391=Beck-RS 2018, 35570.²³⁸ LG Düsseldorf, Ert. v. 31 Mar. 2016, 4a O 126/14, ref. no. 314=BeckRS 2016, 8040—radio frequency share; even stricter Hauck/Kamlah, GRUR Int. 2016, 420 [425], which require a breakdown of the required fee according to patents and countries.²³⁹ LG Mannheim, Urt. v. 27 Nov. 2015, 2 O 106/14, no. 225=GRUR-RS 2015, 20077—Stochastic noise, with note Hauck, GRUR-Prax 2016, 58; see block, GRUR 2017, 121.²⁴⁰ LG Mannheim, Urt. v. 10 Nov. 2017, 7 O 28/16=GRUR-RR 2018, 273 [278]—Funkstation mit Anm. Weber, GRUR-Prax 2018, 354; otherwise, if a standard license agreement is published, cf. LG Mannheim, Urt. v. 4 Sep. 2019, 7 O 115/16, p. 40 (unpublished).²⁴¹ LG Mannheim, Urt. v. 10 Nov. 2017, 7 O 28/16=GRUR-RR 2018, 273 [278]—Radio station with Weber note, GRUR-Prax 2018, 354.

These requirements of German case-law show that a SEP holder who is interested in the enforceability of his SEP in court²⁴² must not only be aware of the fundamental considerations for his licensing practice, but should also document them in such a way that the calculation methodology can be²⁴³ presented to third parties in an objectively comprehensible manner in individual cases. ²⁴² On the current enforcement difficulties in Germany, see Picht, GRUR 2019, 1097 [1098].²⁴³ On the question of the catchability of an offer in the current process and the application of the procedural delay rules, cf. Kühnen, Chapter E, Rz. 364 ff., Kühnen, FS 80 Jahre Patentgerichtsbarkeit in Düsseldorf, p. 311; at the Mannheim location: LG Mannheim, Urt. v. 10 Nov. 2017, 7 O 28/16=GRUR-RR 2018, 273 [278]—Radio station with Weber note, GRUR-Prax 2018, 354.

In addition, if the SEP holder has previously granted licenses to third parties, he should be obliged to carry forward license agreements with third parties. Depending on the circumstances of the individual case, he must provide more or less substantiated reasons as to why the license fee which he proposes to pay is FRAND in the light of the existing comparative licenses.²⁴⁴ ²⁴⁴ OLG Düsseldorf, Urt. v. 30 Mar. 2017, I-15 U 66/15, ref. no. 248=GRUR 2017, 1219.

At the Düsseldorf location, the SEP holder must submit and present all license agreements with license seekers of comparable licensees.²⁴⁵ In the opinion of 4a. The SEP holder even has to declare himself to be a relevant court decision in the case of the SEP holder in the case of a case before the Civil Chamber of the Düsseldorf Regional Court.²⁴⁶ ²⁴⁵ Kühnen, Chap. E, Rz. 451; OLG Düsseldorf, reference decision of 17 Nov. 2016, I-15 U 66/15, Rz. 31 ff.=GRUR-Prax 2017, 42 with note Holtorf/Traumann.²⁴⁶ LG Düsseldorf, Ert. v. 13 Jul. 2017, 4a O 27/16, ref. no. 389, 395 ff.=GRUR-RS 2017, 130336. This might be outdated in the meantime by the decision of the Higher Regional Court Düsseldorf in Unwired Planet v Huawei, since judicially determined conditions are always objectively justified and therefore cannot justify a discrimination charge, OLG Düsseldorf, Urt. v. 22 Mar. 2019, I-2 U 31/16, Rz. 415=GRUR 2019, 725—Improving Handovers.

The SEP holder also has to present all relevant license agreements already concluded at the Mannheim and Karlsruhe locations—but only if the license seeker has reason to doubt that there are grounds for suspicion.²⁴⁷ ²⁴⁷ Higher Regional Court Karlsruhe, Urt. v. 30 Oct. 2019, 6 U 183/16, no. 134=BeckRS 2019, 28234; LG Mannheim, Urt. v. 10 Nov. 2017, 7 O 28/16=GRUR-RR 2018, 273 [279]—Radio station with Weber note, GRUR-Prax 2018, 354.

The German courts agree on the grounds that otherwise there would always be a risk that only those contracts which supported the required level of royalties would be submitted selectively. Also, non-discrimination could only be verified if information was provided on all license agreements²⁴⁸. For the purpose of the intersubjective comprehensibility of the contractual terms, reliable information on the specific license terms granted elsewhere and the factual grounds for any unequal treatment of the licensee(s) is therefore necessary.²⁴⁹ The Düsseldorf Higher Regional Court restricted the scope of the relevant license agreements to those which were “(already and still) in force at the time the license offer was submitted, whereas license agreements which had already expired at that time because they could have no effect on the current competitive situation of the competitors” would have to be disregarded.²⁵⁰ ²⁴⁸ LG Düsseldorf, Ert. v. 13 Jul. 2017, 4a O 27/16, no. 389, 395 ff.=GRUR-RS 2017, 130336.²⁴⁹ LG Mannheim, Urt. v. 10 Nov. 2017, 7 O 28/16=GRUR-RR 2018, 273 [279]—Radio station with Weber note, GRUR-Prax 2018, 354.²⁵⁰ OLG Düsseldorf, Urt. v. 22 Mar. 2019, I-2 U 31/16, Rz. 213=GRUR 2019, 725—Improving Handovers.

Confidentiality agreements between the SEP holder and its licensees should be largely irrelevant. The²⁵¹ Mannheim Regional Court initially considered with Kurtz/Straub a fundamental nullity of the non-disclosure agreement in accordance with § 134 BGB.^{252 253} The latter argue that standard essential patents are “the children of (permitted) cartels”, which sets very narrow limits on the legitimate secrecy interests of SEP holders. In²⁵⁴ a more recent decision of 4 Sep. 2019, the Mannheim Regional Court clarified, however, that a nullity verdict based on antitrust law would only make contractual confidentiality orders if and when no legally observable confidentiality interests—to be presented by the plaintiff—could be identified.²⁵⁵ ²⁵¹ Kühnen, Chap. E, Rz. 454 f.; for procedural clothing, see OLG Düsseldorf, Beschl. v. 25 Apr. 2018, I-2 W 8/18=GRUR-RS 2018, 7036 and GRUR-Prax 2018, 270 with Weber note; as a result also LG Mnchen I, Beschl. v. 13 Aug. 2019, 7 O 3890/19=BeckRS 2019, 18148.²⁵² i.V.m. Art. 101 or 102 TFEU.²⁵³ LG Mannheim, dated 2 Mar. 2018, 7 O 18/17, p. 25.²⁵⁴ Kurtz/Straub, GRUR 2018, 136 [137].²⁵⁵ LG Mannheim, Urt. v. 4 Sep. 2019, 7 O 115/16, p. 41 (unpublished); substantive and procedural submission claims denied OLG Karlsruhe, Urt. v. 30 Oct. 2019, 6 U 183/16, ref. 157 ff.=BeckRS 2019, 28234.

Exceptionally, this is not the case if the SEP holder always uses a published standard contract²⁵⁶ or if license agreements already concluded with other competitors are published²⁵⁷. The background to this is that in these cases there is no difference in the information provided²⁵⁸ s by the European Court of Justice. In these cases too, however, case law continues to place the obligation of the first offer on the SEP holder because of the confidence-building FRAND commitment.²⁵⁹ ²⁵⁶ For incentives for licensees through standard contracts, see Li/Shuai.²⁵⁷ EuGH, Urt. v. 16 Jul. 2015 in the version passed on 15 Dec. 2015, C-170/13, Ls. 1, no. 64=GRUR 2015, 764—Huawei Technologies/ZTE Corp. et al.; LG Düsseldorf, Urt. v. 9 Nov. 2018, 4a O 17/17, marginals 422, 425=Beck-RS 2018, 35570; LG Mannheim, judgment v. 4 Sep. 2019, 7 O 115/16, p. 40 (unpublished).²⁵⁸ EuGH, Urt. v. 16 Jul. 2015 in the version passed on 15 Dec. 2015, C-170/13, margin 64=GRUR 2015, 764—Huawei Technologies/ZTE Corp. et al.²⁵⁹ LG Düsseldorf, judgment of 9 Nov. 2018, 4a O 17/17, ref. no. 335=BeckRS 2018, 35570, whereby the SEP holder was not obliged to provide further explanations on the calculation of the license fee due to the mass of the license agreements (loc. cit., ref. no. 422). The 4c. In a parallel procedure, the Civil Chamber nevertheless had all 1,400 settlement agreements submitted to it, see LG Düsseldorf, judgment of 8 Jan. 2019, 4c O 12/17, no. 145=BeckRS 2019, 3125. A.A. Kellenter/Verhauwen, GRUR 2018, 761.

In the Netherlands, the obligation to explain the offer has so far been understood quite generously. In Philips v Wiko, the Court of Appeal concludes that neither the ECJ judgment nor the FRAND commitment statement or any other ETSI rule impose an obligation to state reasons, nor can it be assumed that the SEP holder must disclose his mostly confidential license agreements. In²⁶⁰ this way, the Dutch courts have so far avoided an elaborate²⁶¹ disclosure procedure in infringement proceedings. ²⁶⁰ Rechtbank Den Haag, resolution of 2 Jul. 2019, ECLI:NL:GHDHA:2019:1066, point 4.19; still open in Philips v Asustek, resolution of 7 May 2019, ECL:NL:GHDHA:2019:1065.²⁶¹ In Germany, the parties must agree contractual regulations for procedural protection of secrets because of the party publicity of the court file pursuant to § 299 Para. 1 ZPO, see OLG Düsseldorf, Beschl. v. 17 Jan. 2017, I-2 U 31/16=BeckRS 2017, 156523 and resolution of 25 Apr. 2018, I-2 W 8/18=BeckRS 2018, 7036 with note Weber, GRUR-Prax 2018, 270; instructive: Kühnen, chapter E, margin no. 462 ff.; critical: Hinojal/Mohsler, GRUR 2019, 674.

Closely related to the question of the method of calculating the royalty is the question of the adjustment of the required royalty if a relevant calculation factor changes during the term of the license agreement. In such cases, German case law requires certain contractual amendment mechanisms in the license agreements in order to take account of changed factual circumstances—at least as soon as they are “perceptible”. The European Commission also points out that FRAND must be handled flexibly, since the parameters of the FRAND license are difficult to predict ex ante. It is²⁶² therefore inadvisable to fix the licensing concept in such a way that it cannot be changed at the time the contract is concluded²⁶³. In practice, therefore, a FRAND license agreement should either be kept flexible by adjustment clauses or significant changes, such as in pricing, should be absorbed by other appropriate mechanisms.²⁶⁴ ²⁶² Europäische Kommission, Fair, Reasonable and Non-Discriminatory (FRAND) Licensing Terms, S. 7.²⁶³ Europäische Kommission, Fair, Reasonable and Non-Discriminatory (FRAND) Licensing Terms, S. 7.²⁶⁴ LG Düsseldorf, jurisdiction from 9 Nov. 2018, 4a O 17/17, marginals 592, 597=Beck-RS 2018, 35570.

The 15th Civil Senate of the Düsseldorf Higher Regional Court has pointed out that a FRAND license agreement, e.g. by means of an adjustment clause, constitutes a noticeable
must take account of actual exhaustion, provided that the market concerned is one of the factors used to calculate the royalty.²⁶⁵ The 4c. The Civil Chamber of the Landgericht Düsseldorf added that such a clause may not contain any indefinite legal terms²⁶⁶ without connecting facts and that the licensee may not be burdened with the burden of proof for exhaustion.²⁶⁷ ²⁶⁵ OLG Düsseldorf, reference decision of 17 Nov. 2016, I-15 U 66/15, marginal no. 49=GRUR-Prax 2017, 42 with note Holtorf/Traumann.²⁶⁶ In case of dispute: “reasonable reduction of the license fee”.²⁶⁷ LG Düsseldorf, Ert. v. 11 Jul. 2018, 4c O 81/17, margin no. 292 f.=BeckRS 2018, 25105.
must take into account any changes that have occurred in the portfolio of industrial property rights. The price correction should be possible in both directions. The²⁶⁸ decisive factor here is likely to be qualitative aspects rather than the mere number of portfolio patents²⁶⁹ at a given point in time. The 2nd Civil Senate of the Düsseldorf Higher Regional Court also mentions such an opening clause as a possible solution for “economically compelling” reasons which may necessitate an increase in the license fee.²⁷⁰ ²⁶⁸ OLG Düsseldorf, reference decision of 17 Nov. 2016, I-15 U 66/15, marginal no. 43=GRUR-Prax 2017, 42 with note Holtorf/Traumann.²⁶⁹ Cf. in this respect OLG Düsseldorf, Hinweisbeschl. v. 17 Nov. 2016, I-15 U 66/15, Rz. 58=GRUR-Prax 2017, 42 with note Holtorf/Traumann on the expiration of intellectual property rights.²⁷⁰ OLG Düsseldorf, Urt. v. 22 Mar. 2019, I-2 U 31/16, Rz. 414=GRUR 2019, 725—Improving Handovers.

The panels have left open the question as to when an appreciable extent exists or compelling economic reasons can be assumed. This is likely to depend very much on the actual circumstances of the individual case and to be resolved through the competitive relevance of the discrepancy.

The development of case law shows, however, that the SEP holder must not only review his licensing concept at the time the license agreement is concluded, but must also continue to ensure that his licensing concept remains consistent. To this end, SEP holders will have to²⁷¹ increasingly implement control mechanisms and clauses on contractual incident prevention in their license agreements in the future. If the parties to a license agreement agree on a patent license for a worldwide SEP portfolio, extensive information must be continuously collected, evaluated and, if necessary, tracked. ²⁷¹ OLG Düsseldorf, reference decision of 17 Nov. 2016, I-15 U 66/15, marginal no. 43=GRUR-Prax 2017, 42 with note Holtorf/Traumann.

The change in case law between the Orange Book Standard decision of the Federal Court of Justice and the Huawei v ZTE decision of the European Court of Justice, can be illustrated for Germany by a series of lawsuits in the field of mobile communications that began in 2014.

The Sisvel Group is a globally active patent user who, according to its own information, supports more than 25 researching patent holders in monetizing their patents through licensing.²⁷² For this purpose, Sisvel had, among other things, created the “Wireless Patent Program”, through which a patent portfolio in the field of wireless communication was to be licensed. The wireless program included a worldwide license to 47 patent families with more than 480 patents declared essential for various communication standards (GSM, GPRS, UMTS and LTE).²⁷³ ²⁷² https://www.sisvel.com/about-us/who-we-are (accessed 27 Nov. 2019).²⁷³ OLG Düsseldorf, Urt. v. 30 Mar. 2017, I-15 U 66/15, ref. no. 18=GRUR 2017, 1219—Mobile communication system.

In letters dated 20 Dec. 2012, 22 Aug. 2013 and 11 Nov. 2013, Sisvel informed the parent company of the Chinese Haier Group about the “Sisvel Wireless Patent Program”, as Haier—via sales companies—offers or has offered at least three mobile phones and four tablet computers in Germany, which²⁷⁴ support the communication standards GPRS and UMTS, among others.²⁷⁵ ²⁷⁴ OLG Düsseldorf, Urt. v. 30 Mar. 2017, I-15 U 66/15, ref. no. 14=GRUR 2017, 1219—Mobile communication system.²⁷⁵ OLG Düsseldorf, Urt. v. 30 Mar. 2017, I-15 U 66/15, ref. no. 15=GRUR 2017, 1219—Mobile communication system.

On 17 Feb. 2014, talks between the companies took place, which ultimately remained fruitless. Sisvel submitted a license offer on 29 Aug. 2014, which Haier rejected on 1 Sep. 2014 without submitting a counterproposal.²⁷⁶ ²⁷⁶ OLG Düsseldorf, Urt. v. 30 Mar. 2017, I-15 U 66/15, ref. no. 19=GRUR 2017, 1219—Mobile communication system.

In a statement of claim dated Sep. 8, 2014²⁷⁷—i.e. before the decision of the European Court of Justice in the Huawei v ZTE case dated Jul. 16, 2015,²⁷⁸ but after the order for reference of the Düsseldorf Regional Court dated Mar. 21, 2013²⁷⁹—Sisvel filed a complaint against the European and German marketing company²⁸⁰ Haiers at the Düsseldorf Regional Court for the infringement of two patents that were declared essential for the GPRS standard²⁸¹ and the UMTS standard.^{282 283} ²⁷⁷ LG Düsseldorf, judgment of 3 Nov. 2015, 4a O 93/14, paragraph 163 (=GRUR-RS 2016, 04073) and 4a O 144/14, paragraph 187 (=NZKart 2015, 545).²⁷⁸ EuGH, Urt. v. 16 Jul. 2015 in the version passed on 15 Dec. 2015, C-170/13=GRUR 2015, 764—Huawei/ZTE.²⁷⁹ LG Düsseldorf, Resolution of 21 Mar. 2013-4b O 104/12=GRUR 2013, 614.²⁸⁰ OLG Düsseldorf, Urt. v. 30 Mar. 2017, I-15 U 66/15, ref. no. 14=GRUR 2017, 1219—Mobile communication system.²⁸¹ First instance reference number: 4a O 93/14, second instance reference number: 1-15 U 66/15.²⁸² First instance reference number: 4a O 144/14, second instance reference number: 1-15 U 65/15.²⁸³ LG Düsseldorf, judgment of 3 Nov. 2015, 4a O 93/14, paragraph 43 (=GRUR-RS 2016, 04073) and 4a O 144/14, paragraph 42 (=NZKart 2015, 545).

During the ongoing infringement proceedings, the parties exchanged further license offers. It was not until the hearing before the Regional Court on 29 Sep. 2015 that the defendants provided the plaintiff with security for the acts of use and handed over documents with figures on the turnover with the challenged forms of execution.

On Nov. 3, 2015, the Düsseldorf Regional Court sentenced the defendant sales companies, among other things, to refrain from any acts of use as well as to recall and destroy the attacked designs on the territory of the Federal Republic of Germany.²⁸⁴ The 4a. The Civil Chamber justified the judgments, inter alia, by stating that Haier had been obliged from the time of the rejection of the (first) counter-offer to invoice for the use and to provide security for the license fees due. The accounting and provision of security only in the oral hearing on 29 Sep. 2015 were delayed and were an expression of a delay tactic of the defendant which was not compatible with the levying of the compulsory license objection under antitrust law.²⁸⁵ ²⁸⁴ LG Düsseldorf, judgment of 3 Nov. 2015, 4a O 93/14 (=GRUR-RS 2016, 04073) and 4a O 144/14 (=NZKart 2015, 545).²⁸⁵ OLG Düsseldorf, Urt. v. 30 Mar. 2017, I-15 U 66/15, ref. no. 29=GRUR 2017, 1219—Mobile communication system.

By order of 13 Jan. 2016, the Düsseldorf Higher Regional Court discontinued enforcement of the first-instance judgments in respect of claims for injunctive relief, recall and destruction.²⁸⁶ On 17 Nov. 2016, the Higher Regional Court gave the parties detailed instructions in which the Senate listed a number of points which, in its view, must be observed in order for an offer to qualify as a FRAND offer.²⁸⁷ ²⁸⁶ OLG Düsseldorf, Resolution of 13 Jan. 2016, I-15 U 65/15 and I-15 U 66/15=NZKart 2016, 139.²⁸⁷ OLG Düsseldorf, Beschl. v. 17 Nov. 2016, 1-15 U 66/15=GRUR-Prax 2017, 42 with note Holtorf/Traumann; see above already in § 11 Section II.

The parties also exchanged further contract offers during the appeal procedure.²⁸⁸ Sisvel also disclosed six Group and worldwide license agreements for the wireless portfolio.²⁸⁹ ²⁸⁸ OLG Düsseldorf, Urt. v. 30 Mar. 2017, I-15 U 66/15, paragraph 22 f.=GRUR 2017, 1219—Mobile communication system.²⁸⁹ OLG Düsseldorf, Urt. v. 30 Mar. 2017, I-15 U 66/15, ref. no. 24=GRUR 2017, 1219—Mobile communication system.

On 30 Mar. 2017, the Düsseldorf Higher Regional Court finally overturned the first instance judgements with the proviso that the claims for injunctive relief, recall and destruction were dismissed as currently unfounded. The²⁹⁰ reason given by the 15th Civil Senate was that the plaintiff had not submitted a FRAND bid until the end of the last oral factual hearing before the Senate. This is²⁹¹ because the plaintiff s license offer of 20 Dec. 2016 discriminated against the defendants in relation to at least one competitor of comparable standing.²⁹² The admissible appeal against the rulings of the Düsseldorf Higher Regional Court is currently still pending before the Federal Supreme Court.²⁹³ ²⁹⁰ OLG Düsseldorf, Urt. v. 30 Mar. 2017, I-15 U 66/15=GRUR 2017, 1219—Mobile communication system (and I-15 U 65/15).²⁹¹ OLG Düsseldorf, Urt. v. 30 Mar. 2017, I-15 U 66/15, ref. no. 324=GRUR 2017, 1219—Mobile communication system.²⁹² OLG Düsseldorf, Urt. v. 30 Mar. 2017, I-15 U 66/15, ref. no. 316=GRUR 2017, 1219—Mobile communication system.²⁹³ Az. KZR 35/17 and KZR 36/17.

The Düsseldorf Higher Regional Court judged a central course to be different from that which was the case at the time of the Orange Book ruling, in that the Senate pointed out in its decision of 17 Nov. 2016 that there were basically no objections to the offer of a Group²⁹⁴ and worldwide portfolio license. The²⁹⁵ district court had left this question unanswered.²⁹⁶ During the proceedings at first instance, the defendant's offers were limited to the two patents and initially extended to Germany and all European states in which the national parallel protection rights are in force, and subsequently to the defendant's entire group. The²⁹⁷ applicant's offers were aimed at a worldwide portfolio license.²⁹⁸ ²⁹⁴ On the group license: Haedicke/Timmann, § 4, margin no. 111.²⁹⁵ OLG Düsseldorf, reference decision of 17 Nov. 2016, 1-15 U 66/15, ref. 29=GRUR-Prax 2017, 42 with note Holtorf/Traumann.²⁹⁶ LG Düsseldorf, judgment of 3 Nov. 2015, 4a O 93/14, paragraph 172 (=GRUR-RS 2016, 04073) and 4a O 144/14, paragraph 196 (=NZKart 2015, 545).²⁹⁷ OLG Düsseldorf, Urt. v. 30 Mar. 2017, I-15 U 66/15, ref. no. 19=GRUR 2017, 1219—Mobile communication system.²⁹⁸ OLG Düsseldorf, Urt. v. 30 Mar. 2017, 1-15 U 66/15, marginals 22, 64, 264=GRUR 2017, 1219—Mobile communication system.

In order not to have to negotiate all 480 individual patents of the portfolio, the parties simplified the negotiation material. Sisvel submitted 23 claim charts to 15 patent families essential for the standards to be licensed (2G, 3G and 4G), which refer to different countries (including China, the USA and European states). Sisvel argued that it was customary to conduct the technical discussion on the basis of a so-called “proud-list”. Given the size of the wireless portfolio, the submission of 10 to 15 claim charts is appropriate.²⁹⁹ ²⁹⁹ OLG Düsseldorf, Urt. v. 30 Mar. 2017, I-15 U 66/15, ref. no. 65=GRUR 2017, 1219—Mobile communication system.

The defendants complained that Sisvel had not raised the issues of validity and significance of all portfolio patents to be licensed.³⁰⁰ Even the submitted claim charts showed only a weak degree of substantiation.³⁰¹ Sisvel therefore offers a patent portfolio that also includes patents that are not standard essential or legally binding. In³⁰² order to shed more light on this aspect, the defendants submitted their own claim charts as well as a‘Humble List’ with further claim charts (not submitted by the plaintiff) on portfolio patents, most of which were not essential to the standard.³⁰³ ³⁰⁰ OLG Düsseldorf, Urt. v. 30 Mar. 2017, I-15 U 66/15, ref. no. 26=GRUR 2017, 1219—Mobile communication system.³⁰¹ OLG Düsseldorf, Urt. v. 30 Mar. 2017, I-15 U 66/15, ref. no. 38=GRUR 2017, 1219—Mobile communication system.³⁰² OLG Düsseldorf, Urt. v. 30 Mar. 2017, I-15 U 66/15, ref. no. 26=GRUR 2017, 1219—Mobile communication system.³⁰³ OLG Düsseldorf, Urt. v. 30 Mar. 2017, I-15 U 66/15, ref. no. 38=GRUR 2017, 1219—Mobile communication system.

The Senate was finally able to leave this question open in its decision, as the Senate considered the offer to the defendants to be discriminatory.³⁰⁴ In its decision of 17 Nov. 2016, however, the Senate stated that the determination of a “fair and reasonable” license offer required substantiated factual evidence on the use of the portfolio patents. Since the parties had unanimously declared at the hearing on 17 Nov. 2016 that it was customary in the industry to submit a so-called “proud list” for approx. 10-15 selected portfolio patents with associated claim charts for entry into the negotiations, the Senate pointed out that at least the submission of a “proud list” including claim charts was required.³⁰⁵ The use of the portfolio patents not included in the proud list can then be established by a court via Section 287 (2) ZPO if this is predominantly probable.³⁰⁶ Supplementary statements are only necessary for individual patents from a patent family “if they contain different claim wordings and the defendants specifically explain that and why this results in substantially different areas of protection, which lead to the fact that they do not use these patents and this concerns a noticeable extent of the total number of acts of use subject to licensing”³⁰⁷ ³⁰⁴ OLG Düsseldorf, Urt. v. 30 Mar. 2017, I-15 U 66/15, ref. no. 249=GRUR 2017, 1219—Mobile communication system.³⁰⁵ OLG Düsseldorf, decision of 17 Nov. 2016, I-15 U 66/15, ref. 36 ff.=GRUR-Prax 2017, 42 with note Holtorf/Traumann.³⁰⁶ OLG Düsseldorf, decision of 17 Nov. 2016, I-15 U 66/15, ref. 36=GRUR-Prax 2017, 42 with note Holtorf/Traumann.³⁰⁷ OLG Düsseldorf, decision of 17 Nov. 2016, I-15 U 66/15, ref. 39=GRUR-Prax 2017, 42 with note Holtorf/Traumann.

However, the selection of patents to be included in the “proud list” should be explained in a comprehensible way. The Senate demanded of the claim charts that the patent claims should be subdivided into features and compared with the concrete passages in the standard. It should also be stated that those characteristics are either mandatory under the standard or, in the case of a mere option, have been achieved by the implementation forms specifically challenged.³⁰⁸ ³⁰⁸ OLG Düsseldorf, Resolution of 17 Nov. 2016, I-15 U 66/15, paragraphs 36 and 38=GRUR-Prax 2017, 42 with Holtorf/Traumann note.

The change of perspective of the case law from the consideration of the value of a national single patent to the consideration of a worldwide portfolio value caused a dispute between the parties about the obligation to substantiate the price calculation underlying a license agreement offer known as FRAND as well as possible adjustment mechanisms in case of changes of the portfolio value in the future.

According to Haier, Sisvel should have detailed the calculation of the required license fee and disclosed the price calculation. In its decision of 17 Nov. 2019, the Senate had not previously made any stipulations on FRAND pricing, but approached the economic dimension of the matter to be decided primarily via the comparative market approach. In³⁰⁹ its judgment, the Senate was also able to leave open the question of the calculation of a fair and reasonable license, since the Senate ultimately classified the offer to the defendants as discriminatory and granted the objection of compulsory licensing under antitrust law.³¹⁰ ³⁰⁹ OLG Düsseldorf, decision of 17 Nov. 2016, I-15 U 66/15, ref. 20=GRUR-Prax 2017, 42 with note Holtorf/Traumann.³¹⁰ OLG Düsseldorf, Urt. v. 30 Mar. 2017, I-15 U 66/15, ref no. 249=GRUR 2017, 1219—Mobile communication system.

However, the reciprocal party presentation in the concrete infringement proceedings illustrates the points of contention between standardising companies and standard implementers on the basis of the changed market conditions. According to Haier, the defendants could not be referred to the comparative market concept, since there was no functioning comparative market of comparable license agreements that had been concluded without control.³¹¹ ³¹¹ OLG Düsseldorf, Urt. v. 30 Mar. 2017, I-15 U 66/15, ref no. 37=GRUR 2017, 1219—Mobile communication system.

Therefore “the patents in the portfolio would have to be weighted according to relevance and duration and territorial, temporal, economic and legal factors would have to be included in at least a rough calculation”.³¹² Since the applicant refuses to disclose the pricing calculation, it must be presumed that it applied pricing factors which were too high.”³¹³ ³¹² OLG Düsseldorf, Urt. v. 30 Mar. 2017, I-15 U 66/15, ref no. 34=GRUR 2017, 1219—Mobile communication system.³¹³ OLG Düsseldorf, Urt. v. 30 Mar. 2017, I-15 U 66/15, ref no. 37=GRUR 2017, 1219—Mobile communication system.

The requested license amount was manifestly inappropriate as a result. Since the defendants sell their mobile telephones mainly in the low-price segment, the required unit license results in a high percentage license rate compared to the value of the device.³¹⁴ Such a license rate is not feasible in the low-price segment and therefore effectively excludes the defendants from the market.³¹⁵ More than 18,000 patent families were registered as standard essential,³¹⁶ so that such a license rate for 33 patent families without a corresponding adjustment clause would result in an unreasonable overall burden of the terminal device price with license fees for SEP.³¹⁷ ³¹⁴ OLG Düsseldorf, Urt. v. 30 Mar. 2017, I-15 U 66/15, ref no. 37=GRUR 2017, 1219—Mobile communication system.³¹⁵ OLG Düsseldorf, Urt. v. 30 Mar. 2017, I-15 U 66/15, ref no. 37=GRUR 2017, 1219.—Mobile communication system³¹⁶ OLG Düsseldorf, Urt. v. 30 Mar. 2017, I-15 U 66/15, ref no. 37=GRUR 2017, 1219.—Mobile communication system³¹⁷ OLG Düsseldorf, Urt. v. 30 Mar. 2017, I-15 U 66/15, ref. no. 41=GRUR 2017, 1219—Mobile communication system.

Sisvel took the view that the alleged royalty had not been determined on the basis of a precise mathematical calculation, but on the basis of an approximation to the normal and reasonable price on the market. The³¹⁸ appropriateness of the required license fee could therefore—and in the area of SEP licensing per se—be verified via the comparable market concept.³¹⁹ ³¹⁸ OLG Düsseldorf, Urt. v. 30 Mar. 2017, I-15 U 66/15, ref. no. 58=GRUR 2017, 1219—Mobile communication system.³¹⁹ OLG Düsseldorf, Urt. v. 30 Mar. 2017, I-15 U 66/15, ref. no. 62=GRUR 2017, 1219—Mobile communication system.

The license rate applied by Sisvel corresponds to the standard license rate offered to all potential licensees. Sisvel compares this with standard license rates in the mobile communications sector and in relation to a specific license offer for LTE technology. A³²⁰ comparison of the license rates of the wireless license program with other license programs shows that Sisvel's license rates, which cover multiple technologies and a broad protected area, are extremely favorable.³²¹ ³²⁰ OLG Düsseldorf, Urt. v. 30 Mar. 2017, I-15 U 66/15, margin no. 63=GRUR 2017, 1219—Mobile communication system.³²¹ OLG Düsseldorf, Urt. v. 30 Mar. 2017, I-15 U 66/15, ref. 64=GRUR 2017, 1219—Mobile communication system.

With regard to the requested adjustment clause in the form of a maximum burden limit, Sisvel argued that the price for licensing the overall technology needed was one of the fixed cost drivers.³²² Adaptation clauses are unusual³²³. Moreover, since³²⁴ licenses are granted at the lower end of the normal market margin, there is a wide buffer. ³²² OLG Düsseldorf, Urt. v. 30 Mar. 2017, I-15 U 66/15, ref. no. 66=GRUR 2017, 1219—Mobile communication system.³²³ OLG Düsseldorf, Urt. v. 30 Mar. 2017, I-15 U 66/15, ref. no. 66=GRUR 2017, 1219—Mobile communication system.³²⁴ OLG Düsseldorf, Urt. v. 30 Mar. 2017, I-15 U 66/15, margin no. 63=GRUR 2017, 1219—Mobile communication system.

The considerations of the Senate in its reference resolution of 17 Nov. 2016 on adjustment clauses are³²⁵ already described in more detail in § 1111. above. The Senate considered adjustment clauses, in particular in the event of actual exhaustion and changes in the portfolio of intellectual property rights, provided that these actual circumstances have a noticeable effect on the amount of the license fee demanded. ³²⁵ OLG Düsseldorf, decision of 17 Nov. 2016, I-15 U 66/15, ref. 36 ff.=GRUR-Prax 2017, 42 with note Holtorf/Traumann.

In the specific infringement proceedings, the adjustment clause for the application case of exhaustion was ultimately of primary importance. Although the defendants also argued that the absence of any adjustment clauses (price correction in the event of changes in the portfolio of industrial property rights; country spectra) in the³²⁶ contract offer already argued per se that it was not FRAND, they also argued that the contract offer was not FRAND. On the other hand, the plaintiff argued that changes in the portfolio of industrial property rights and the range of countries were already³²⁷ absorbed by the short contract term of only two years.³²⁸ Fluctuations in the portfolio size³²⁹ are priced into the license rate as they are based on an average of the entire portfolio over the term of the contract.³³⁰ ³²⁶ OLG Düsseldorf, Urt. v. 30 Mar. 2017, I-15 U 66/15, ref. no. 41=GRUR 2017, 1219—Mobile communication system.³²⁷ The defendants considered—without further explanation of the background to the facts of the Higher Regional Court's judgment—that such a short duration was also not FRAND in principle, see OLG Düsseldorf, Urt. v. 30 Mar. 2017, I-15 U 66/15, ref. no. 41=GRUR 2017, 1219—Mobile communication system.³²⁸ OLG Düsseldorf, Urt. v. 30 Mar. 2017, I-15 U 66/15, ref. no. 67=GRUR 2017, 1219—Mobile communication system.³²⁹ The Senate probably meant the portfolio value; purely numerical fluctuations do not necessarily mean changes in value, see already Section 11, Section II. of this paper.³³⁰ OLG Düsseldorf, Urt. v. 30 Mar. 2017, I-15 U 66/15, ref. no. 67=GRUR 2017, 1219—Mobile communication system.

The issue of exhaustion was based on the defendant's submission that the plaintiff or its legal predecessor had licensed the chipset of a particular chip manufacturer, which was used in a percentage of the challenged designs, to a particular chip manufacturer. On the basis of that license, the rights conferred by the portfolio patents are exhausted in certain areas of the world.³³¹ Sisvel replied that Haier had not submitted sufficiently substantiated evidence on the alleged exhaustive effect and that it was still necessary to provide such evidence.³³² ³³¹ OLG Düsseldorf, Urt. v. 30 Mar. 2017, I-15 U 66/15, ref. no. 33=GRUR 2017, 1219—Mobile communication system.³³² OLG Düsseldorf, Urt. v. 30 Mar. 2017, I-15 U 66/15, ref. no. 29=GRUR 2017, 1219—Mobile communication system.

The Higher Regional Court ruled in favour of Sisvel in the dispute on the exhaustion effect of the patents. It remained undisputed at first instance that the licensed chipsets had been placed on the market outside Europe for the first time.” Since there is no principle of international exhaustion and since it cannot in fact be established by a court that the legal predecessor was in agreement with a worldwide placing on the market, the objection of exhaustion does not in any event apply to the Federal Republic of Germany.³³⁴ ³³³ OLG Düsseldorf, Urt. v. 30 Mar. 2017, I-15U66/15, margin no. 170=GRUR 2017, 1219—Mobile communication system.³³⁴ OLG Düsseldorf, Urt. v. 30 Mar. 2017, I-15 U 66/15, ref. no. 173=GRUR 2017, 1219—Mobile communication system.

The objection that the requested license fee should be reduced because of exhaustion in a particular license area was not relevant to the decision. In its decision of 17 Nov. 2016, the Senate pointed out, however, that if the market concerned was one of the factors used to calculate the license fee, a noticeable degree of actual exhaustion could be taken into account when examining the FRAND offer.³³⁵ ³³⁵ OLG Düsseldorf, decision of 17 Nov. 2016, I-15 U 66/15, ref. 49=GRUR-Prax 2017, 42 with note Holtorf/Traumann.

Ultimately, however, the Senate denied the FRAND character of the plaintiff s offer on the grounds that it infringed the principle of non-discrimination.

The defendants had argued that the license offers submitted to them were all discriminatory since there was no standard license agreement from³³⁶ the applicant for the wireless portfolio. On the contrary, the applicant has concluded completely different license agreements with different undertakings, to which the offer at issue treats the defendants unequally without objective reason.³³⁷ ³³⁶ The reference to a standard license agreement facilitates the burden of proof according to ECJ, judgement v. v. 16 Jul. 2015 in the version passed on 15 Dec. 2015, C-170/13, margin 64=GRUR 2015, 764—Huawei/ZTE; cf. § 8 and § 12 Section IV.³³⁷ OLG Düsseldorf, Urt. v. 30 Mar. 2017, I-15 U 66/15, ref. no. 35=GRUR 2017, 1219—Mobile communication system.

In the following, the dispute focused on a concrete reference contract of the plaintiff with a licensee designated as “X5” in the anonymous version of the judgment. Sisvel had argued that this license agreement had to be disregarded when examining the offer to the defendants as to its FRAND character, since the licensee had been a ‘reference customer’ to which—as a resource-rich company—considerable importance had been attached in order to establish the license programme for the wireless portfolio on the market.³³⁸ ³³⁸ OLG Düsseldorf, Urt. v. 30 Mar. 2017, I-15 U 66/15, ref. no. 60=GRUR 2017, 1219—Mobile communication system.

Haier replied that the applicant's explanations could not objectively justify the extremely high discounts and overall significantly better conditions compared to X5. In addition, X5 was not the first company to enter into a wireless portfolio licensing agreement.³³⁹ ³³⁹ OLG Düsseldorf, Urt. v. 30 Mar. 2017, I-15 U 66/15, ref. no. 36=GRUR 2017, 1219—Mobile communication system.

Sisvel added that the license agreement with X5 was based on a particular risk distribution. Since X5's sales had declined, Sisvel had preferred a lump sum payment at the time the contract was concluded on the basis of estimated quantities.³⁴⁰ Such a settlement model is possible if Haier discloses the details necessary for the risk assessment, but if sales increase, the same result cannot be expected as with X5.³⁴¹ ³⁴⁰ OLG Düsseldorf, Urt. v. 30 Mar. 2017, I-15 U 66/15, ref. no. 60=GRUR 2017, 1219—Mobile communication system.³⁴¹ OLG Düsseldorf, Urt. v. 30 Mar. 2017, I-15 U 66/15, ref. no. 60=GRUR 2017, 1219—Mobile communication system.

The Düsseldorf Higher Regional Court found that the license fees offered to the defendants were “exorbitantly higher than those agreed in the license agreement with X5”, so that there was “far more than insignificant unequal treatment”.³⁴ The discount on future sales granted to X5 by the lump-sum payment alone was not to be regarded as customary in the industry.³⁴³ Sisvel's submission on contractual risk distribution was not convincing since the calculation of the flat-rate payment was based on a forecast of sales trends.³⁴⁴ Sisvel's reference to the extreme volatility—and thus difficulty in forecasting—of the mobile telephony market does not justify any deviations, as market conditions are ultimately the same for all market participants. In³⁴⁵ addition, reference customers may only be granted ‘to a limited extent more favourable conditions’ than other licensees, with reference to a ‘suction effect’ on the market.³⁴⁶ ³⁴² OLG Düsseldorf, Urt. v. 30 Mar. 2017, I-15 U 66/15, ref no. 263=GRUR 2017, 1219—Mobile communication system.³⁴³ OLG Düsseldorf, Urt. v. 30 Mar. 2017, I-15 U 66/15, margin no. 270 et seq.=GRUR 2017, 1219—Mobile communication system; discounts for user actions in the past, on the other hand, are common, loc. cit.³⁴⁴ OLG Düsseldorf, Urt. v. 30 Mar. 2017, I-15 U 66/15, ref. no. 295=GRUR 2017, 1219—Mobile communication system.³⁴⁵ OLG Düsseldorf, Urt. v. 30 Mar. 2017, I-15 U 66/15, ref. no. 297=GRUR 2017, 1219—Mobile communication system.³⁴⁶ OLG Düsseldorf, Urt. v. 30 Mar. 2017, I-15 U 66/15, ref. no. 282 ff.=GRUR 2017, 1219—Mobile communication system.

The overall view which must be taken, taking into account the objective of the TFEU, which is to ensure freedom of competition, shows that the license offer by Sisvels Haier discriminates against competitor X5.³⁴⁷ ³⁴⁷ OLG Düsseldorf, Urt. v. 30 Mar. 2017, I-15 U 66/15, ref. no. 316=GRUR 2017, 1219—Mobile communication system.

Immediately following the announcement of the appeal judgments, Sisvel Haier submitted a new license offer on 14 Apr. 2017³⁴⁸ and applied for a temporary injunction, after Haier also objected to this offer as not FRAND.³⁴⁹ The Düsseldorf Higher Regional Court rejected the petition for a ruling. If the injunctive relief claim from an SEP was previously dismissed in the main action proceedings as currently unfounded, a request in the summary proceedings usually fails because of the urgency requirement.³⁵⁰ ³⁴⁸ OLG Düsseldorf, Resolution of 29 Jun. 2017, I-15 U 41/17, paragraph 41=GRUR-RS 2017, 120339—Kommunikationsvorrichtung.³⁴⁹ OLG Düsseldorf, Resolution of 29 Jun. 2017, I-15 U 41/17, paragraph 41=GRUR-RS 2017, 120339—Kommunikationsvorrichtung.³⁵⁰ OLG Düsseldorf, Resolution of 29 Jun. 2017, I-15 U 41/17, paragraph 35=GRUR-RS 2017, 120339—Kommunikationsvorrichtung.

Sisvel learned from these infringement proceedings and converted its license program to a standard license agreement in 2018, the “Mobile Communication Program” (MCP).³⁵¹ On Jun. 26, 2018, Sisvel submitted this new license offer to the French-Chinese smartphone manufacturer Wiko, while an ongoing infringement case was suspended by mutual agreement³⁵². Included were explanations of the calculation method underlying the offer, an anonymous overview of the existing license agreements and a proud list of 20 claim charts.³⁵³ Wiko did not accept this standard license offer. ³⁵¹ LG Mannheim, judgment of 4 Sep. 2019, 7 O 115/16, p. 7 (unpublished).³⁵² LG Mannheim, judgment of 4 Sep. 2019, 7 O 115/16, p. 7 (unpublished).³⁵³ LG Mannheim, judgment of 4 Sep. 2019, 7 O 115/16, p. 8 (unpublished).

On Sep. 4, 2019, the Mannheim Regional Court sentenced Wiko to cease and desist as well as to recall and destroy the patent-infringing devices. If a pool license program or a standard license program existed, it would be sufficient to provide sufficient evidence of its acceptance in the market³⁵⁴. Where a sufficient number of license agreements have been concluded, no further information on the appropriateness of the license fee requested is normally required, provided that the composition of a pool³⁵⁵ is demonstrated by the submission of a sufficient number of claim charts for reference patents³⁵⁶ Sisvel had been able to refer to a sufficiently established licensing program in which the standard conditions were accepted in each case.³⁵⁷ Sisvel therefore had only a reduced burden of justification for its FRAND offer, which was satisfied by the submission of the list of licensees for the license programme.³⁵⁸ Wiko, on the other hand, should have explicitly explained why there was an alleged need for further clarification.³⁵⁹ ³⁵⁴ LG Mannheim, judgment of 4 Sep. 2019, 7 O 115/16, p. 40 (unpublished).³⁵⁵ Or portfolios.³⁵⁶ LG Mannheim, judgment of 4 Sep. 2019, 7 O 115/16, p. 40 (unpublished) m.V.a. LG Düsseldorf, judgment of 9 Nov. 2018, 4a O 63/17=BeckRS 2018, 38608.³⁵⁷ LG Mannheim, judgment of 4 Sep. 2019, 7 O 115/16, p. 50 (unpublished).³⁵⁸ LG Mannheim, judgment of 4 Sep. 2019, 7 O 115/16, p. 50 (unpublished).³⁵⁹ LG Mannheim, judgment of 4 Sep. 2019, 7 O 115/16, p. 50 (unpublished).

The practical example illustrates the extent of developments in the licensing of essential patents in the mobile device industry. The decision of the European Court of Justice in Huawei v ZTE represents a decisive turning point—the point in time at which the case law took into account the market reality on the handset market and modified the structure created in Orange Book by the Federal Court of Justice in favour of the standard implementers.

With the obligation of the first FRAND offer and coupled with the transparency approach in explaining it, SEP holders were suddenly confronted with the challenge of explaining their license programs, which had been freely negotiated on the market in recent years, not only in a consistent³⁶⁰ but also in an intersubjectively comprehensible³⁶¹ form. In Sisvel's case, the SEP holder stumbled, among other things, over the fact that he offered comparable license seekers various settlement modalities (lump sum payment and unit licenses) and priced in an excessively generous “early adopter” discount. The tough and factual-intensive infringement proceedings against Haier prompted Sisvel to rethink. The restructuring of the licensing program into a standard license agreement reduced the amount of explanation required, which means that Sisvel's essential patents remain legally enforceable even in the post-Huawei v ZTE era. ³⁶⁰ In view of the FRAND obligation, all SEP holders are likely to have lived a consistent licensing practice even before Huawei v ZTE.³⁶¹ LG Mannheim, Urt. v. 10 Nov. 2017, 7 O 28/16=GRUR-RR 2018, 273 [279]—Radio station with Weber note, GRUR-Prax 2018, 354.

A standard license program saves the licensor the transaction costs of explaining individualized license offers. However, it also refrains from exploiting economic corridors above the uniform license fee in individual cases.

The Janus-faced nature of the ECJ case law in Huawei v ZTE and its implementation by the national courts is shown as follows:

First, the European Court of Justice has provided SEP holders with a strong tool by requiring the standard user to respond to the SEP holder's offer “in accordance with accepted business practices and in good faith”—which has led national courts to give the SEP holder the opportunity to offer the standard holder a worldwide portfolio where this is customary in practice in the industry.³⁶² Contrary to the Orange Book jurisprudence, which required that the standard user be granted a portfolio license only upon request,³⁶³ the SEP holder thus has a lever which brings the dispute over FRAND licenses between two companies to an overall standstill. ³⁶² Block, GRUR 2017, 121, 125 f. already with previous LG Mannheim, judge v. 4 Mar. 2016, 7 O 96/14, margin 97=GRUR-RS 2016, 06527—Information recording medium; LG Düsseldorf, judge v. 31 Mar. 2016, 4a O 126/14, margin no. 274=BeckRS 2016, 08040 m.w.N.; later also expressly OLG Düsseldorf, decision of 17 Nov. 2016, I-15 U 66/15, margin no. 29=GRUR-Prax 2017, 42 with note Holtorf/Traumann; Kellenter, FS 80 Jahre Patentgerichtsbarkeit in Düsseldorf, p. 276 f.³⁶³ S.o., § 7.

But it is precisely this advantage that is the biggest pitfall of the ECJ ruling,³⁶⁴ because the SEP holder has to make the calculation methodology of his license offer comprehensible to the standard user. The requirements of case law regarding the calculation methodology make it indispensable for the SEP holder, ³⁶⁴ Described by Picht as a “cross-jurisdictional portfolio problem”, cf. GRUR 2019, 1097 [1103]; on the long-standing problems in the valuation of global portfolio licenses, Nestler/Ordosch, GRUR-Prax 2012, 372; see also Friedl/Ann, GRUR 2014, 948.
be able to explain how he calculated the required royalty.
The SEP holder must be aware of the strengths and weaknesses of his portfolio. This means that the patentee must be aware of the value of his essential patents (based on the validity and essentiality of the respective patent or at least the patent family), the territorial scope of his portfolio, the remaining terms of the patents in the portfolio and the number of new grants as well as possible exhaustion situations. In addition, the SEP holder needs to know what the relative strength of its portfolio is compared to the strength of the portfolios of other licensors.
be able to explain the economic considerations on which the licensing terms of comparable existing licensees are based.
On the basis of well-founded market data, the SEP holder must be able to explain why he granted which license conditions to which licensee. The SEP holder must be able to justify deviations objectively.

This means that if the SEP holder wants a global portfolio license, he will have to deal with a mass of data that is highly individual. The SEP holder must also continuously update this data in order to detect possible adjustment issues.

Another central problem is the phenomenon of over-declaration described in § 3 Section IV—and the uncertainty about its actual extent on the data analysis side. As in the practical example, the standard users are not satisfied with claim charts of certain proud-list patents, but demand a minimum of substantiation for the portfolio patents offered for licensing. This is a central aspect for resolving valuation disputes in practice.³⁶⁵ ³⁶⁵ Wild, iam.com.

If, however, an attempt is made to track the data subject to constant change in the negotiations on a portfolio license, this will result in considerable additional costs.³⁶⁶ In practical reality, SEP holders and license seekers only negotiate a manageable contractual object in very few cases. In particular, when licensing pools act as licensors, the portfolios offered for licensing quickly reach a size of several thousand patents valid throughout the world. But even individual SEP holders can now offer tens of thousands of patents. ³⁶⁶ Wild, iam.com; cf. § 3 Section IV, according to which the valuation of a patent already has an impact of approximately USD 10,000.

Wildpoints out that these costs ultimately also burden the end user's product, whereby nobody wins until an institution or process is universally accepted and ultimately separates wheat from chaff.³⁶⁷ This is because the escalating scope of valuation burdens the license fee with transaction costs as negotiation expenses (preparation and review of claim charts, technical explanations in personal meetings, supplementary valuation reports, etc.). For SMEs in particular, the additional effort has so far represented a potential barrier to market entry.³⁶⁸ ³⁶⁷ “There is no way of knowing exactly what the true number is because there is no organisation whose role is to sort the truly essential wheat from the non-essential chaff. [ . . . ] until some kind of body or method is universally accepted to do the job [ . . . ]. “, Wild, iam.com.³⁶⁸ Pohlmann/Blind, p. 56.

In order to make this gigantic—and constantly changing—subject of negotiation tangible at all within an economically reasonable period of time, the negotiating parties in practice make use of standard valuation mechanisms which generalise certain aspects of the valuation and thus inevitably result in uncertainty.

How the parties to SEP licensing agreements handle the interaction between portfolio licenses and transaction costs in practice is explained that individualisation and individual monitoring of licensing conditions is difficult to implement in practice and that there are no incentives to do so as the additional work involved leads to higher negotiation and contract administration costs. The pursuit of individualization collides with the reality of the economic proportionality of this gain injustice to the transaction costs triggered by individualization.

In order to use a technology lawfully worldwide, the standard user must obtain a license for each state for whose territory the technology is protected by at least one claim of a patent of the licensor and in whose territory he (the standard user) performs at least one act of use. This presupposes that both parties are aware of
how the value chains of the products distributed by the standard user run territorially,
which value-added or sales step is carried out by which company and where, and
which of the participating companies have licensed which patents of the licensor.

Only when these fact-intensive preliminary questions have been clarified can the contracting parties analyse,
which actions are even eligible for licensing and,
whether there is an exhaustion fact in the jurisdictions concerned, the extent of which is so appreciable that the royalties must be reduced.

The expense of recording, processing, communicating and tracking this information causes transaction costs from an economic point of view.³⁶⁹ Transaction costs are incurred in every contractual exchange relationship. The initiation, agreement and execution of the contract form a single transaction³⁷⁰. The total consumption of resources triggered during the phases of the transaction is referred to as transaction costs, shown as an amount of money.³⁷¹ ³⁶⁹ Transaction cost theory goes back to Coase, Economics, 1937, Vol. 4, p. 386 ff; see also Coase, Journal of Law and Economics, 1960, Vol. 3, p. 1 ff; Williamson, Journal of Law and Economics, 1979, Vol. 22, p. 233 ff.³⁷⁰ Will, p. 9.³⁷¹ Will, p. 10.

The transaction costs, together with the supplier's production and distribution costs and its profit margin, constitute its selling price for a product³⁷². At each stage of the value chain, the respective economic operator prices at least its transaction costs into the sales price demanded: ³⁷² Picot, BB, axe. 13/1986 to issue 27/1986, p. 3.

When transaction costs are added to the value of the assets exchanged, their amount is a critical criterion for assessing the efficiency of economic processes. If an entrepreneur succeeds in reducing his transaction cost share, he can either offer his goods at a lower price or realise a higher profit share.

The license fee for a patent license is also made up of the consideration for the use of the patented technology (license fee in the narrower sense) and the allocated costs of initiating and administering the contract (transaction costs). It should be noted that transactions in the field of intellectual property generally involve higher transaction costs than the transfer of property, since intellectual property has so far been “rather imprecisely defined”, is “difficult to price” and can involve high monitoring, administrative and enforcement costs³⁷³. The marketability of industrial property rights under Lévêque/Ménière is economically at least as important as the possibility of excluding third parties from using the teaching. It is only if the property right can be the subject of a transaction that it can be ensured that the asset can be used by the economic operator who attaches the highest value to it.³⁷⁴ The transaction costs of a license are therefore very important. The value of the invention can only be made accessible and exploited through low transaction costs. In practice, for example, patent pools are used for this purpose. They shall promote administrative efficiency through better pricing and the exploitation of synergies to the benefit of licensors³⁷⁵. The license seeker no longer has to negotiate licenses with each individual patent holder.³⁷⁶ ³⁷³ Heyers, GRUR Int. 2011, 213, [216].³⁷⁴ Lévêque/Ménière, p. 11.³⁷⁵ Heyers, GRUR Int. 2011, 213, [216].³⁷⁶ Lévêque/Ménière, S. 13: “By reducing the number of contracts, these collective mechanisms reduce transaction costs.”

Moreover, high transaction costs can effectively drive small and medium-sized enterprises (SMEs), in particular start-ups, out of certain markets or prevent them from entering them. SMEs usually do not have the internal resources and reserves to complete costly transactions.³⁷⁷ “The smaller the companies are, the more the scarce resources limit the spectrum and scope of the activities that can be carried out”³⁷⁸ ³⁷⁷ European Commission, SMEs and Cooperation, p. 18.³⁷⁸ European Commission, SMEs and Cooperation, p. 18.

It should not be lost sight of the fact that standardisation itself should actually help to reduce transaction costs for sellers and buyers.³⁷⁹ If the transaction costs for SEP licenses can be reduced, this will strengthen the competitiveness of SMEs and thus create more choice in the retail market. ³⁷⁹ European Commission, Horizontal Guidelines, paragraph 308; see also https://www.din.de/de/ueber-normen-und-standards/nutzen-fuer-die-wirtschaft/mittelstand (accessed 27 Nov. 2019).

The European Commission is aware that the balance between individual equity and transaction costs is difficult to balance in practice. License fees saved through individualization may be offset by transaction costs. The³⁸⁰ Commission therefore requests that the transaction costs associated with the negotiation of a license be limited to the minimum necessary and that the efficiencies achieved in practice through cross-licensing be taken into account.³⁸¹ Both should be taken into account in the case-by-case examination of whether a license offer is compatible with FRAND. In³⁸² their decisions on Unwired Planet v Huawei, the British courts point out that portfolio licensing also saves transaction costs compared to licensing individual patents.³⁸³ ³⁸⁰ Lévêque/Ménière, S. 12: “The decisive factor is whether the transaction costs are higher or lower than the gain of the transaction.”³⁸¹ European Commission, COM (2017) 712, p. 9.³⁸² European Commission, COM (2017) 712, p. 9.³⁸³ Express: EWCA, resolution of 23 Oct. 2018, file no. [2018] EWCA Civ 2344, paragraph 34; cf. EWHC, resolution of 5 Apr. 2017, file no. [2017] EWHC 711 (Pat), paragraph 533.

The balance proposed by a license offer between transaction costs and fairness in individual cases is therefore—also because it is directly price relevant for the end customer—an important criterion in assessing whether the license offer is FRAND.

In practice, the licensors and licensing pools are guided by the international framework conditions previously described.³⁸⁴ However, in global areas, such as mobile communications or electronics, an approach has developed in recent decades that aims in particular to keep transaction costs in patent licensing agreements as low as possible. The fee for access to the standardization result via the patented technology is then not burdened with high contract administration costs, so that the actual license fee to be paid by the standard user is lower. ³⁸⁴ European Commission, COM (2017) 712.

The patent license agreements concluded in practice do not link the license fees for the use of the protected technology to the number of acts of use under patent law in the individual states for which at least one portfolio patent is in force, but instead provide for an average worldwide tariff. This average worldwide fee is payable for the manufacture and distribution of the licensed products in each country of the world, irrespective of whether patent protection exists in that country or not.

Consequently, the license fee cannot be allocated pro rata to a specific portfolio patent for each act of use, but is incurred as a mixed calculation for access to the licensed portfolio as a whole. In return, the standard user may also pay royalties for states in which no patent protection exists, or at least no equivalent patent protection. By simplifying the calculation methodology, the contracting parties save a considerable amount of transaction costs.

As a practical example the standard license agreement “LICENSE AGREEMENT FOR BD-SOFTWARE MANUFACTURER” of the patent pool One-Blue LLC for the Blu-ray standards administered³⁸⁵ by the Blu-ray Disc Association will be discussed. ³⁸⁵ See http://www.blu-raydisc.com/en/index.aspx (accessed 27 Nov. 2019).

According to this standard license agreement, the patents of the licensors are to be licensed which are essential (technically or commercially) for the implementation of the standards for BD software, DVD software and, if applicable, the CD³⁸⁶. The license agreement is therefore a patent license agreement for standard essential patents. The core of the license agreement, the “License Grant” in Section 3.1, is as follows (emphasis added): ³⁸⁶ See point 1 (“Definitions”) of the Standard License Agreement.
“Subject to Licensee Parties' full and unconditional compliance with its obligations under this License Agreement, Licensing Company hereby grants to Licensee Parties during the term of this License Agreement a non-exclusive, non-transferable license, under the Licensed Patents, to make, use, Sell, offer for Sale and import Licensed Products. [ . . . ].”

The synallagmatically linked counterpart, the obligation to pay a license fee in Clause 5.1, reads in extracts as follows (emphasis added):
“Licensee shall pay to Licensing Company a royalty at the Standard Rate for each copy of Licensed Product that is provided directly or indirectly by Licensee [ . . . ].”

Although the licensing is linked to the licensed SEP, the payment obligation is not territorially limited. It refers to all “Licensed Products”, i.e. all “BD Software made, used, Sold, offered for Sale or imported by or on behalf of Licensee Parties”. The licensed patents do not cover every country in the world and are not evenly distributed across the continents. The patent list of³⁸⁷ 4,194 individual national patents provided by One-Blue for “BD Recorder Software”, for example, gives the following proportional distribution across the continents: ³⁸⁷ http://www.one-blue.com/license-programs/bd-software/ (Status: February 2019; accessed 27 Nov. 2019).

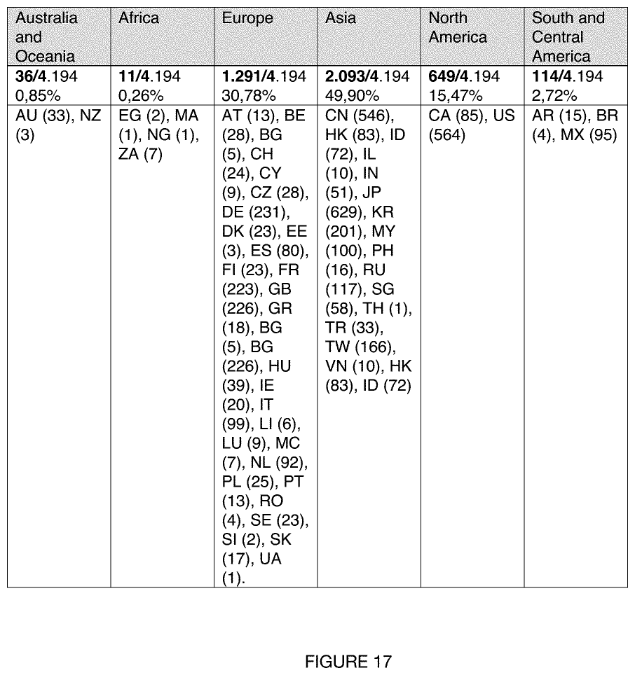

The individual countries in which patents for BD Recorder Software of the One-Blue-Pool are in force are detailed in the following FIG. 17. In this practical example, the standard users thus pay an average worldwide tariff, the amount of which is linked to the number of globally validated portfolio patents, but which in territorial terms is a mixed calculation independent of the state territories of the validation states. In principle, the licensee pays the same royalty regardless of whether he uses the protected technology in Tunisia (patent-free), Brazil (4 portfolio patents) or China (546 portfolio patents).

According to Section 5.2 of the Standard License Agreement, deductions from the license fee calculated for worldwide distribution activities are only provided for in the case of separate bilateral agreements between the licensee and one of the licensors of the pool. There are no provisions for exhaustion situations. Clauses 11.2. and 11.3 expressly state that changes in the portfolio holdings and/or the essential valuation do not affect the amount of the license fees.

How a portfolio, i.e. a bundle of territorially limited intellectual property rights, can give rise to a payment obligation for worldwide actions is an interesting question of contract law which should be dealt with from the perspective of German law.³⁸⁸ ³⁸⁸ For the BD Software LA mentioned in the practical example, Chinese law or the law of the State of New York applies according to Section 14.2.

In a simple patent license agreement, the granting of a positive right of use by the patent holder in favour of the licensee³⁸⁹ and the obligation of the licensee to pay the license fee in contractual exchange are in principle opposed.³⁹⁰ The payment obligation depends decisively on whether the licensee commits an act under Sec. 9 S. 2 or Sec. 10 PatG which would be prohibited without the license. However, the licensor is not liable for success. In particular, the licensee shall not be liable for the commercial success of the licensee resulting from the use of the invention,³⁹¹ but shall only be liable for the procurement and maintenance of licensed intellectual property rights positions in the case of a positive license.³⁹² ³⁸⁹ KraBer/Ann, § 40, paragraph 29; Haedicke/Timmann, § 4, paragraphs 74 and 89; Kühnen, Chapter E, paragraphs 184 et seq.; GroB, paragraph 13.³⁹⁰ So at least the meanwhile h.M., on the state of opinion see Bartenbach, margin no. 73 ff; Gross, margin no. 13 ff.³⁹¹ Bold, GRUR 2019, 665 [669].³⁹² Bartenbach, paragraphs 76 and 1370 ff.

In the case of licenses based on a mixed calculation, the payment obligation is decoupled from the territoriality of the user action. In³⁹³ addition to the patentee's consent to acts of use, there is a second main obligation of the patentee: he grants the licensee worldwide freedom to operate (FTO),³⁹⁴ irrespective of changes in the portfolio and possible changes in the licensee's territorial radius of action. Since both the portfolio and the licensee's business activity are constantly in flux in practice, the scope and value of the portfolio patents at the time the contract is concluded are a yardstick for the mixed calculation of usage activities and entrepreneurial freedom of action. When the royalty is negotiated, the parties must³⁹⁵ exchange information with each other, such as claim charts³⁹⁶ (for portfolio strength evaluation), rough figures on the territorial and quantitative scale of business activity³⁹⁷ (for FTO evaluation) and background information on the upstream value chain of their own activity—if exhaustion facts are to be taken into account. The European Court of Justice wants to protect this negotiation process between a bona fide³⁹⁸ license seeker and the portfolio owner from the influence of negotiating pressure, which arises from the irrelevant criterion of an acutely threatening or in any case concrete risk of omission.³⁹⁹ ³⁹³ Haedicke/Timmann/Bukow, § 9, marginal 261 m.V.a. LG Düsseldorf, judgment of the court of first instance 11 Sep. 2008, 4b O 78/07, marginal 114=BeckRS 2009, 10890—Video signal coding III.³⁹⁴ Cf. LG Munich I, judgment v. 21 Aug. 2014, 7 O 11811/12=BeckRS 2014, 16898, GRUR-Prax 2014, 459 with Note Hauck—FTO-License; dated 8 Jan. 2015, 7 O 28263/13=BeckRS 2015, 04007, GRUR-Prax 2015, 149 with Note Dombrowski—Tread Base Layer.³⁹⁵ In the case of cross licenses even reciprocally.³⁹⁶ Block, GRUR 2017, 121 [124] m.w.N.; the procedure customary in the industry, such as the exchange of claim charts for Proud Lists, is illustrated in the practical example in § 12 of this paper. Sisvel exchanged technical claim charts for a selection of portfolio patents with both Haier and Wiko.³⁹⁷ So well Rechtbank Den Haag, Ent. v. 8 Feb. 2017, ECL:NL:RBDHA:2017:1025, Pkt. 4.3³⁹⁸ EuGH, Urt. v. 16 Jul. 2015 in the version passed on 15 Dec. 2015, C-170/13, margin 65=GRUR 2015, 764—Huawei Technologies./. ZTE Corp. et al.³⁹⁹ “Before the judicial assertion”, EuGH, Urt. v. 16 Jul. 2015 in the version passed on 15 Dec. 2015, C-170/13, paragraph 61=GRUR 2015, 764—Huawei Technologies/ZTE Corp. et al.

The European Court of Justice last confirmed in 2016 in the case of Genentech Inc. v Hoechst GmbH et al. that the granting of entrepreneurial freedom of action can itself be the subject of a main contractual obligation to perform.⁴⁰⁰ The European Court of Justice recognises that the contractual royalty “constitutes the price to be paid for the commercial exploitation of the licensed technology in the certainty that the licensor will not exercise his intellectual property rights”, even if the licensed IPR expires or ceases retroactively.⁴⁰¹ ⁴⁰⁰ EuGH, judgment of 7 Jul. 2016, C-567/14=GRUR 2016, 917—Genentech Inc. ./. Hoechst GmbH et al.⁴⁰¹ On the applicability of ECJ, Genentech v Hoechst to standard essential patents, cf. Weber/Altmeyer, GRUR, 2017, 1182; cf. also § 21 Section II.e).

The above analysis of the dogmatic mixture of currently issued SEP portfolio licenses shows that the parties to the SEP portfolio license apply a compromise solution in order to reduce the transaction costs of the license to a manageable level. In doing so, they guarantee the practical efficiency gains that the European Commission has been calling for so far. However, SEP holders increasingly run the risk of being confronted with the accusation that they do not sufficiently appreciate the circumstances of the individual case and that the licensing concept is too inflexible for changes after conclusion of the contract. The owner of a standard essential patent portfolio is faced with the dilemma of how to create a licensing program that
continuously with fluctuating portfolio size and coverage and fluctuating end device prices
takes individual account of the subject matter and scope of the business activities of its licensees, and
is neither exploitative nor discriminatory,

while at the same time:
should trigger the lowest possible transaction costs, as these burden the license fee and must therefore be priced into the price of the terminal equipment.

If he fails to do so, the antitrust objection of the license seeker under compulsory license law—if he can be proven to be willing to license—threatens to be successful and to block the claims for injunctive relief, recall and destruction. The standard implementers are therefore increasingly deciding to reject the licensing efforts of SEP holders and SEP pools.⁴⁰² Without the⁴⁰³ return on investment (ROI) of R&D costs, standardization becomes economically unattractive. This stalemate thus threatens standardization as a vehicle for global social progress as a whole.⁴⁰⁴ ⁴⁰² Plus Quinn, ipwatchdog.com.⁴⁰³ Haedicke/Timmann, § 1, paragraph 6; Putnam, Fordham International Law Journal, 2018 (Vol. 41), 953 [969]; Nilsson, GRUR Int 2017, 1017.⁴⁰⁴ See Picht, GRUR 2019, 1097 [1100]; Angwenyi, GRUR Int 2017, 105.

The following will therefore show how, in the event of changed market conditions, the resulting jurisdictional requirements could be implemented at the lowest possible transaction costs.

The paradigm shift in case law following the decision of the European Court of Justice in the Huawei v ZTE case as described has led to the fact that the licensing practice as described, which has been practised to date, has increasingly been perceived by German courts over the past two years as too lump-sum.

The required changes in SEP holder licensing practices will result in higher transaction costs. If the derivation of the license fee is to become more transparent for the license seeker, less flat-rate factors must be included in the calculation of the license fee. Without the flat rate, the circumstances of the individual case must be determined and assessed. This expenditure of time and resources is transaction expenditure.

The risk of higher transaction costs, which could erode the savings, can be countered by the self-executing FRAND licensing proposed in this paper. If the contract design and administration is at least partially software-supported and automated, transaction costs are considerably lower. Kurtz and Straub point out that in effective competition an entrepreneur must in any case calculate his cost factors mathematically precisely in order to have them under control and to be able to exploit the potential for savings and profit maximisation.⁴⁰⁵ This is also much easier than in the past due to the methods of modern EDP and general practice.⁴⁰⁶ The legal and technical cornerstones of how this can be done are set out as follows: Automation is particularly worthwhile when certain processes are carried out in large numbers and impersonally, i.e. independently of the persons involved. Typically, license agreements are⁴⁰⁷ not a mass business, but an exception to the principle laid down in Sections 9 and 10 PatG that direct and indirect acts of use are reserved solely for the patentee. ⁴⁰⁵ Kurtz/Straub, GRUR 2018, 136 [141] m.V.a. BGH, Resolution of 14 Jul. 2015, KVR 77/13=NJW 2015, 3643, marginal 22—Water prices Calw II.⁴⁰⁶ Kurtz/Straub, GRUR 2018, 136 [141].⁴⁰⁷ See reference to automated license agreements in Braegelmann/Kaulartz/Hauck, Chapter 13—but without reference to the SEP license agreements' area of application; for software licenses, see Blocher/Hoppen/Hoppen, C R 2017, 337.

In the case of license agreements on standard essential patents, however, the rule-exceptional relationship is reversed. Due to the FRAND access, the SEP holder is obliged to conclude a license under FRAND conditions with each⁴⁰⁸ license seeker. In⁴⁰⁹ the case of the MPEG license pool, the⁴¹⁰ pool members have greatly simplified access to the protected technology by offering each license seeker a standard license agreement on uniform and unalterable terms. The standard license agreement for the MPEG-2 video coding standard, for example, has already been concluded 942 times with the same content,⁴¹¹ almost 1,400 times for the MPEG-4 standard⁴¹² and 262 times for the successor standard HEVC.⁴¹³ ⁴⁰⁸ Bold, GRUR 2019, 665 [666].⁴⁰⁹ For more details see § 3 Section III.⁴¹⁰ Sisvel has also changed its licensing practice in the meantime, cf. LG Mannheim, Urt. v. 4 Sep. 2019, 7 O 115/16, p. 7 (unpublished), described above in § 12 Section IV.⁴¹¹ See: https://www.mpegla.com/programs/mpeg-2/licensees/ (accessed 27 Nov. 2019).⁴¹² LG Düsseldorf, jurisdiction from 9 Nov. 2018, 4a O 17/17, no. 120=BeckRS 2018, 35570.⁴¹³ See: https://www.mpegla.com/programs/hevc/licensees/ (accessed 27 Nov. 2019).

These figures show that SEP licensing is also a mass business and therefore more suitable for automation than licensing contracts for non-standard IP rights. The freedom in the choice of the contracting party⁴¹⁴ is considerably restricted by the antitrust access obligation, so that the conclusion of the contract does not require a relationship of trust between the contracting parties. At the same time, the prohibition of discrimination sets narrow limits on the content of potential deviations and the obligation of transparency in the calculation of licenses can be established by means of visible calculation data. ⁴¹⁴ Haedicke/Timmann, § 4, paragraph 107; Braegelmann/Kaulartz/Möslein, chapter 8, paragraphs 3 and 8.

In the last decade, the automation of contracts has been preferentially⁴¹⁵ discussed under the buzzwords “Legal Tech” and “Smart Contracts”, although not all contracts referred to as “Smart Contracts” in literature and practice have actually been discussed. ⁴¹⁵ For the background and the history of the origin of the term see Braegelmann/Kaulartz, chapter 1, margin no. 10 ff; instructive: Kaulartz/Heckmann, CR 2016, 618; Paulus/Matzke, CR 2017, 769 [771].
(i) are able to make autonomous decisions; and
(ii) contracts in the legal sense.

This dogmatic background has been increasingly dealt with in jurisprudential literature over the last decade. The following section will therefore discuss the legal framework for Smart Contracts in more detail. Important aspects are, in particular, the manner in which the contract is concluded through self-executing contracts as well as the execution of the contract and the associated right to disrupt performance.

In practice, the instruments referred to as “Smart Contracts” differ both in their degree of automation and in their external impact with regard to legal transactions.

In principle, a truly smart⁴¹⁶ contract should only be a contract that operates largely independently within a predefined area and makes autonomous⁴¹⁷ decisions within this area of application, which are covered by the fundamental will of at least one participant in legal transactions, but which—due to the autonomous mode of operation of the contract algorithm—must be legally attributed to this participant. The⁴¹⁸ smart contract algorithm takes an active part in the decision-making process and the contract is written exclusively⁴¹⁹ in machine-readable code.⁴²⁰ ⁴¹⁶ Braegelmann/Kaulartz/Voshgmir, Chap. 2, Rz. 13.⁴¹⁷ Gratzmacher/Heckmann, CR 2019, 553.⁴¹⁸ See section II.1.b. for more information.⁴¹⁹ The free choice of language is covered by the contractual freedom guaranteed under Article 2 (1) of the Basic Law, cf. Braegelmann/Kaulartz/Möslein, Chapter 8, paragraph 21.⁴²⁰ On declarations of intent cast in code and the resulting questions under § 125 BGB and § 126a BGB, see Braegelmann/Kaulartz/Möslein, Chapter 8, paragraphs 15 to 17 m.w.N.

In the less smart alternative, the contract algorithm processes a sequence of predefined conditions (§ 158 BGB) and triggers certain predefined transactions depending on the established facts, i.e. no human intervention or further human verification is required for the transaction.⁴²¹ Such a contract algorithm does not actively participate in the decision-making process that forms the basis of the contract, but essentially carries out a contract that has already been concluded by triggering or blocking real acts as agreed. It is a traditional contract with an additional software layer.⁴²² A processor (=processing unit) processes predefined criteria or conditions and carries out the contractual exchange of services independently if the relevant condition is fulfilled. ⁴²¹ Association of the Bavarian Economy, Blockchain and Smart Contracts, p. 13 m.w.N.⁴²² Hohn-Hein/Barth, GRUR 2018, 1089 [1093].

Due to its technical character, the term “Smart Contract” is not limited to the legal term of the contract, but in principle applies to any “software that controls, monitors and/or documents legally relevant actions (in particular an actual exchange of services) as a function of digitally verifiable events, with the help of which, however, contracts in rem and/or contracts under the law of obligations may also be concluded”.⁴²³ ⁴²³ Braegelmann/Kaulartz/Möslein, Chap. 8, Rz. 1 m.w.N.

The actions (or omissions) that follow a determined event do not necessarily have to bring about a legally significant success. Heckelmann refers to the example of a company that controls its internal processes with a “Smart Contract”, such as closing blinds in sunshine⁴²⁴. In this case example, too, an algorithm evaluates the relevant weather data and, depending on it, initiates a predetermined sequence of real acts. However, the acts are exclusively unilateral and have no intended effect on legal relations, i.e. without any will to be bound by the law. As a result, the corresponding declarations of intent of at least two contractual partners required for an effective conclusion of the contract pursuant to §§ 145 ff. of the German Civil Code are not valid. BGB (German Civil Code).⁴¹⁵ ⁴²⁴ Heckelmann, NJW 2018, 504 [506].⁴²⁵ Heckelmann, NJW 2018, 504 [505].

Since self-executing contracts are not a “fundamental alternative to the contract embedded in a private law system”,⁴²⁶ but can form contractual obligations according to the general rules of civil law, in⁴²⁷ principle all types of contracts can be represented in self-executing contracts under the law of obligations.⁴²⁸ ⁴²⁶ MüKO-BGB/Ernst, Einl. SchuldR, no. 68; detailed discussion in Börding/Jülicher/Röttgen/v. Schönfeld, CR 2017, 136 [137].⁴²⁷ In Germany: §§ 241 ff. BGB.⁴²⁸ Heckelmann, NJW 2018, 504 [508].

In the field of application of licensing contract law, the case of lack of participation in legal transactions—and thus also of lack of willingness to be bound by the law—described in Section 1.2 above does not play a decisive practical role. This is because the contracting parties regularly strive for the conclusion of a legally valid contract.

However, as with other contracts under the law of obligations, the licensing concept proposed in this paper raises the question of the degree of automation and the timing of the use of automated mechanisms.

Möslein differentiates between whether a Smart Contract is only used as an instrument for contract implementation or whether it serves at least as a “functional contract equivalent”. In the⁴²⁹ former case, the underlying contract is concluded in the traditional way, so that specific legal issues do not arise⁴³⁰ The contract is merely self-executing and documents the exchange of services as well as any breaches of duty. In the second case, the legal effectiveness depends on whether the prerequisites for legal effectiveness are fulfilled by the automated action.⁴³¹ ⁴²⁹ Braegelmann/Kaulartz/Möslein, Chap. 8, Rz. 14.⁴³⁰ Braegelmann/Kaulartz/Möslein, Chap. 8, Rz. 14 with reference to the term “offchain”.⁴³¹ Braegelmann/Kaulartz/Möslein, Chap. 8, Rz. 14.

In addition, it should be pointed out that hybrid forms are also conceivable in which, for example, only one of the two declarations of intent is generated automatically, whereas the corresponding declaration is based on a direct human decision-making process. In the following application examples, the two licensing models preferred by case law will be dealt with:
Application example 1 concerns the alternative of licensing via standard contracts, i.e. the constellation that the offerer offers the same conditions to all potential interested parties and therefore only the question remains whether the interested party accepts the offer;
Application example 2 concerns the alternative of licensing via a contract offer tailored as closely as possible to the individual license seeker, which is kept flexible via adjustment clauses.

A suitable practical example for a basically fixed offer is the standard license offer of the MPEG-Pool, which is open to all interested parties.⁴³² ⁴³² See above in the introduction to § 17.

Without an automated license offer, the published standard license agreement would only represent an invitatio ad offerendum with a largely concrete regulatory density and would not be regarded as a fixed contract offer to everyone.⁴³³ For an effective conclusion of the contract it is necessary that the license seeker first requests the conclusion of the standard license agreement from the pool, whereupon the pool accepts the offer. Only then does a legally valid pool license agreement come into effect. ⁴³³ cf. § 147 para. 2 BGB.

If, on the other hand, the license offer of the MPEG pool were to be automated, a transaction could be omitted. As in the case of a so-called vending machine business, the program code explicitly states rules and conditions, whereby it is entitled to the declaration content required for a declaration of intent⁴³⁴. Automated transactions are generally treated as a case of the so-called real offer, i.e. by making an offer of goods available—for example in an automated vending machine—a contractual offer is addressed to an indeterminate group of persons. In⁴³⁵ order that the offeror does not become liable for damages, in particular if the range of goods is exhausted, the offer to everyone in these cases is regarded as (i) limited to the existing stock of goods in accordance with §§ 133, 157 BGB (German Civil Code) as long as (ii) the functionality of the mechanism is guaranteed and (iii) the machine is properly operated⁴³⁶. The first restriction relating to the goods in stock does not apply to simple licenses to industrial property rights because of their intangible nature⁴³⁷ and the resulting unlimited availability in terms of quantity. Anyone who is actually interested can therefore be offered and actually granted a patent license, as long as the patent proprietor is entitled to dispose of the patent and the patent is in force. ⁴³⁴ Heckelmann, NJW 2018, 504 [505]; Braegelmann/Kaulartz/Möslein, Chap. 8, Rz. 20; Spindler/Schuster, BGB, vor § 116, Rz. 1; for imputability see also BGH, Urt. v. 16 Oct. 2012, X ZR 37/12=NJW 2013, 598 (Ls. 1).⁴³⁵ So-called offer ad incertas personas, cf. HK-BGB/Dorner, § 145, no. 6.⁴³⁶ HK-BGB/Dorner, § 145, paragraph 6; MüKO-BGB/Busche, § 145, paragraph 12 m.w.N.; Palandt/Ellenberger, § 145, paragraph 7.⁴³⁷ McGuire, GRUR 2015, 424 [426] uses the term ubiquity in this context.

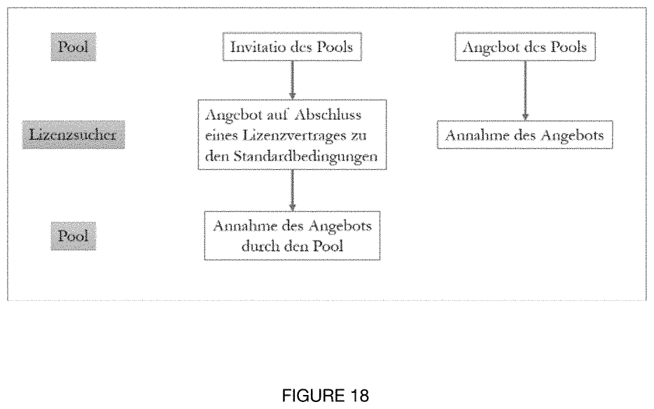

The license seeker only has to accept this permanently available⁴³⁸ contract offer. The receipt of the declaration of acceptance by the natural or legal person behind the offer is irrelevant, as the access requirement is implied in accordance with § 151 S. 1 BGB can be waived.⁴³⁹ The license agreement is concluded more quickly than was previously the case under the non-automated contract conclusion procedure (cf. FIG. 18 below). ⁴³⁸ arg. e contr. § 148 BGB; cf. MüKO-BGB/Busche, vor § 145, para. 73; MüKO-BGB/Busche, § 145, para. 24; BeckOK BGB/Eckert, § 145, para. 28.⁴³⁹ Braegelmann/Kaulartz/Möslein, Chap. 8, Rz. 26.

The mere fact that a transaction required for the conclusion of the contract is omitted reduces the cost burdening the conclusion of the contract—here for the acceptance by the license seeker of the offer aimed at the conclusion of the standard license agreement. For the license seeker, the acceleration is also advantageous, since it is no longer within the sphere of the licensor when he (the license seeker) is specifically licensed and may thus lawfully use the licensed invention. Instead, the license seeker can immediately ensure the necessary legal certainty for access to the patented technology by directly concluding the contract. The digital documentation of the declaration of acceptance also provides conclusive evidence of the conclusion of the contract and its date.⁴⁴⁰ ⁴⁴⁰ For the protection against counterfeiting and evidence function in the documentation in a block chain, see below in § 18.

The situation is somewhat different if the agreement is not to be based on a standard license agreement, but the license terms are variable (flexibility) and/or are to be tailored to the license seeker (individualization). Due to a flexible and individual licensing concept for each license seeker, the content of the automated contract offer is not permanently fixed, but must be updated and newly individualized at regular intervals for all license seekers.

Since the contract algorithm has no legal personality and is not itself legally competent, it cannot be the holder of rights and obligations in its own name.⁴⁴¹ For this reason, it is not possible for the algorithm to act as the licensor's representative. He cannot make his own declaration of intent, § 161 Paragraph 1 S. 1 BGB. For legally incompetent intermediaries of declarations of intent, messenger status may be considered at most. However, this also does not apply, since the contract algorithm does not transmit a third-party declaration, but only creates it according to pre-programmed rules.⁴⁴² ⁴⁴¹ Bridegroom/Klindt, N Y W 2015, 1137 [1138] m.w.N.⁴⁴² Leyens/Böttcher, JuS 2019, 133 [135].

The literature therefore considers whether the existing regulatory gap can be remedied by applying §§ 164 et seq. analogously. BGB can be concluded. However, the approach is rejected as there is a lack of comparable interests. § 165 BGB expressly requires that the representative be at least partially legally competent and that §§ 179 et seq. of the German Civil Code also apply. BGB (German Civil Code) are linked to the representative as a liability object with legal personality.⁴⁴³ ⁴⁴³ Cornelius, MMR 2002, 353 [355]; Specht/Herold, MMIR 2018, 40 [43]; Leyens/Böttcher, JuS 2019, 133 [135], see also Sosnitza, CR 2016, 764.

It is therefore obvious to consider the point in time at which the contracting party(s) behind the conclusion of the contract have been able to move forward in time, e.g. to the moment of commissioning of the system.⁴⁴⁴ The declaratory act produced by the computer system is then—so could be concluded—to be classified as a declaration of intent by the user, whereby the legal obligation is based on the user's legal intention to use the computer as a tool for the production of his declaration of intent and to dispense with a special control.⁴⁴⁵ The user thus defines a corridor of content during commissioning within which there is a general awareness of explanation, which is concretized in individual cases by the computer system.⁴⁴⁶ According to prevailing opinion⁴⁴⁷ and jurisdiction, such a so-called computer declaration is attributed to the user of the computer program.⁴⁴⁸ ⁴⁴⁴ Cornelius, MMR 2002, 353 [355].⁴⁴⁵ Cornelius, MMR 2002, 353 [355]; Bridegroom/Riicker/Service/Falcon, 14th part, paragraph 15.⁴⁴⁶ In detail: Bridegroom/Ricker/Service/Falcon, Part 14, No. 18; Spindler/Schuster, BGB, vor § 116, No. 6 m.w.N.⁴⁴⁷ Spindler/Schuster, BGB, vor § 116, Rz. 6 m.w.N.; Grapentin, NJW 2019, 181 [184] m.w.N.; MüKO-BGB/Sacker, Einl.BGB, Rz. 184.⁴⁴⁸ BGH, judgment of 7 Nov. 2001, VIII ZR 13/01=NJW 2002, 363 [364] f.—ricardo.de; BGH, judgment of 7 Nov. 2001, VIII ZR 13/01=NJW 2002, 363 [364] f.—ricardo.de; BGH, judgment of 7 Nov. 2001, VIII ZR 13/01 26 Jan. 2005, VIII ZR 79/04=NJW 2005, 976 [977]; Higher Regional Court Frankfurt a.M., judgement v. 20 Nov. 2002, 9 AND 94/02=MMR 2003, 405 [406].

Alternatively, it is proposed to treat computer declarations as a blanket declaration⁴⁴⁹, i.e. on the basis of a prima facie case.⁴⁵⁰ However, Leyens and Böttcher rightly point out that the liability risk associated with the use of a reliable computer is fundamentally not comparable with the potentially far-reaching risk of human behaviour that is contrary to the agreement⁴⁵¹. In contrast to the cases of so-called “blind signing” by a human blanket agent, the operator of the computer system has no reason to assume a risk of conduct contrary to the agreement.⁴⁵² ^{449 § 172} BGB analogous, presented in Leyens/Böttcher, JuS 2019, 133 [136]; Sester/Nitschke, CR 2004, 548 [550]; BGH, Urt. v. 29 Feb. 1996, IX ZR 153/95=NJW 1996, 1467 [1469].⁴⁵⁰ Sester/Nitschke, CR 2004, 548 [550] f.; Specht/Herold, MMR 2018, 40 [43].⁴⁵¹ Leyens/Böttcher, JuS 2019, 133 [136].⁴⁵² Leyens/Böttcher, JuS 2019, 133 [136].

Even if this dispute ultimately has no significant influence on the civil-law imputability of the computer declaration, the solution of shifting the declaration of intent forward to the user of the computer system seems dogmatically more convincing for the reasons mentioned. In any case, the only decisive factor for the present work is that the use of the computer intermediary—even if it is only used unilaterally for the preparation of the contract offer and the subsequent execution of the contract—results in considerably lower transaction costs for the contracting parties than the use of human negotiators or administrators. As shown above in FIG. 18, the semi-automated contract conclusion also saves the parties a transaction compared to the conventional model—which represents a further gain in time and efficiency.

Both application examples described in the previous section are characterized in contract management by the fact that the contract algorithm regularly checks and adjusts the evaluation parameters⁴⁵³ and performance obligations on which the contract is based, e.g. the payment of the specific (application example 1) or calculated (application example 2) license fee. ⁴⁵³ See the Sixth Chapter of this paper.

On the basis of parallel digital documentation,⁴⁵⁴ the origin and duration of breaches of duty can also be precisely tracked. Examples include late payment by the licensee or systematic under-reporting of the relevant measurement factors (sales figures, sales prices). Facts that permit an extraordinary termination of the license agreement, for example, can be documented and reported. ⁴⁵⁴ For the protection against counterfeiting and evidence function in the documentation in a block chain, see below in § 18.

Self-executing contracts could make contract management more effective in both application examples. With low transaction costs, more individual and flexible licensing models could be offered, taking into account the increased requirements of case law.

Contracts under the law of obligations are also self-executing contracts of the parties' choice of law in accordance with the principles of private international law. The substantive law applicable to the contract can, in principle, be⁴⁵⁵ freely determined by the parties, for example in accordance with Article 3(1) of the Rome I Regulation.^{456 457} ⁴⁵⁵ In the case of licenses, the disposition transaction is an exception in this respect because of the underlying principle of protection, see OLG Düsseldorf, Urt. v. 24 Sep. 2015, I-2 U 30/15, ref. no. 26=BeckRS 2015, 18754; Higher Regional Court (OLG) Düsseldorf, Germany, ref. no. v. 12 Jun. 2014, I-2 U 86/09, no. 75=BeckRS 2014, 14418; Kühnen, GRUR 2014, 137 [142].⁴⁵⁶ Regulation (EC) No 593/2008 of the European Parliament and of the Council of 17 Jun. 2008 on the law applicable to contractual obligations (Rome I), Official Journal L 177 of 4 Jul. 2008, p. 6, as last amended by Official Journal L 309 of 24 Nov. 2009, p. 87.⁴⁵⁷ The UN Convention on Contracts for the International Sale of Goods (CISG) of 11 Apr. 1980 (BGBl. 1989 11588) may also apply.

For the processing unit to be able to read and execute the contract terms, the contract text (human-readable source text) must be converted into machine-readable code (machine code).⁴⁵⁸ For this purpose, the Smart Contract is formulated on the software level according to the syntax of a certain programming language as a bundle of different instructions that can be processed by the processing unit (so-called program code). The formal sequence and the systematics, according to which the processing unit is to implement the instructions provided in the program code in the concrete application case, is called algorithm. Sandner/Braunberger/Gabriel ⁴⁵⁸ Instructive on the technical background and solution approaches Braegelmann/Kaulartz/Sandner/Braunberger/Gabriel, Chapter 3; Braegelmann/Kaulartz/Koch/Reitwiessner, Chapter 5 and Bmegelmann/Kaulartz/Jentzsch, Chapter 6; Braegelmann/Kaulartz/Matzke, Chapter 14, each with w.m.N.

In the simplest variant of Smart Contracts, the algorithm describes certain transactions that the processing unit automatically executes if it [the processing unit] is proved that a certain condition has occurred (the so-called if-then rule). “This means that fixed activities to carry out the expression of will of the contract are automatically carried out when a required event occurs. At the same time, all contractual partners shall be informed of status changes in real time.”⁴⁵⁹ ⁴⁵⁹ Schiller, blockchainwelt.de

For the processing unit to be able to verify whether one of the predetermined conditions has occurred, it is dependent on evaluable information. This information is categorized and stored in a database that is continuously updated and connected to the processing unit. The processing unit can recognize and evaluate changes in the information situation and execute the contractual reaction for the respective case. In order for the reaction to be automated, too, interfaces must be provided for external reactions, e.g. for the collection or payment of a sum of money, such as license fees from the licensee to the licensor or annual fees to an office. The reactions are preferably used within the system in order to further integrate the system, for example by updating or modifying a data field in the database; e.g. specifying a factor in a calculation complex.

The data required for the execution of the license agreements described in § 17 could be documented in a block chain. Blockchain technology is⁴⁶⁰ based on the principle that transactions are combined and validated in a chain of blocks that build on each other⁴⁶¹. The central advantage of blockchain technology over other data security systems is its extremely low susceptibility to manipulation. The blockchain technology operates decentrally and does not require a central memory or control unit(s),⁴⁶² i.e. from a safety point of view no single point of failure⁴⁶³. In order to manipulate the transactions stored in the blocks,⁴⁶⁴ an attacker would have to control the majority of the network (over 50%). ⁴⁶⁰ See Matzke, CR 2018, R44; Blocher/Hoppen/Hoppen, CR 2017, 337; Kaulartz, CR 2016, 474.⁴⁶¹ Braegelmann/Kaulartz/Voshgmir, Chap. 2, Rz. 7 ff.⁴⁶² So-called “Distributed Ledger” technology.⁴⁶³ Tapscott/Tapscott, p. 135.⁴⁶⁴ Instructive on attack points and cost-effective protection mechanisms based on the blockchain technology Guin/Cui/Skjellum; Braegelmann/Kaulartz/Voshgmir, chapter 2, paragraph 33.

In order to be able to carry out transactions via the blockchain, the participants in a peer-to-peer network are connected to each other with equal rights. Transactions and created blocks are passed on between system participants via the network and thus disseminated.⁴⁶⁵ Each block joins a previous block to form a chain⁴⁶⁶. However, transactions and blocks are not transferred proactively, i.e. unsolicited, to neighbors. Instead, inventory messages are first used to announce that new transactions or blocks exist. The recipient of the inventory message can then decide whether he already knows the data announced in it or whether he is interested in receiving a copy. If required, it sends a message to one of its active communication partners requesting the transmission of the actual data. The storage of transaction data and blocks is therefore highly redundant. New peers can be added to the network at any time and receive redundant copies of data from existing peers. Peers can also leave the network at any time. Only a few computers in the network, the so-called full nodes, store all transactions and the received blocks in order to use them as a basis for checking the validity of future transactions and blocks.⁴⁶⁷ ⁴⁶⁵ In the Bitcoin network, this happens every ten minutes.⁴⁶⁶ Tapscott/Tapscott, p. 40.⁴⁶⁷ Association of the Bavarian Economy, Blockchain and Smart Contracts, p. 2; Hohn-Hein/Barth, GRUR 2018, 1089.

Blockchains can thus be described in simplified terms as distributed databases that are organized by the participants in the network.⁴⁶⁸ “All participants of a blockchain are distributed over a P2P network (distributed ledger technology, short: DLT)⁴⁶⁹ and transactions can be viewed by every participant”⁴⁷⁰. Because transactions in the blockchain are validated decentrally, contracts can⁴⁷¹ be processed automatically as part of the blockchain log. The occurrence of the condition is fixed for the contracting parties and can no longer be subsequently unilaterally changed.⁴⁷² Heckelmann rightly points out in this context that the occurrence of the condition is only irrevocably established when the block with the underlying information has been updated and thus validated at least six times.⁴⁷³ Due to the decentralized structure of the blockchain network, many computing power applying points (miner) update the blockchain in parallel. This can cause the blockchain to branch (fork) for a short time. “Then the declaration of intent is only stored in a part of the servers forming the blockchain”, the remaining blocks are finally invalidated.⁴⁷⁴ ⁴⁶⁸ Fraunhofer Institute, Position Paper Blockchain and Smart Contracts, pp. 10 ff; Tapscott/Tapscott, pp. 39 ff; Braegelmann/Kaulartz/Voshgmir, chapter 2, paragraph 9.⁴⁶⁹ Instruction McLean/Deane-Johns, C R I 2016, 97.⁴⁷⁰ Braegelmann/Kaulartz/Voshgmir, Chap. 2, Rz. 28.⁴⁷¹ Braegelmann/Kaulartz/Voshgmir, Chap. 2, Rz. 11.⁴⁷² Fraunhofer Institute, Position Paper Blockchain and Smart Contracts, p. 33.⁴⁷³ Heckelmann, NJW 2018, 504 [506].⁴⁷⁴ Heckelmann, NJW 2018, 504 [505].

Considering these technological peculiarities of blockchain technology, it can meet the high demands to be made on an evidence preservation mechanism that forms and updates the test basis for self-executing contracts.⁴⁷⁵ The federal government has announced testing measures to determine whether blockchain technology can be admitted as evidence in civil proceedings.⁴⁷⁶ The Chinese Internet Courts have already made their first experiences with blockchain-based tokens as legal evidence. In⁴⁷⁷ the United Kingdom, Vos, Chancellor of the EWHC, presented a “Legal Statement on the Status of Cryptoassets and Smart Contracts” on 18 Nov. 2019. The paper confirms that English law provides an appropriate framework for smart contracts and cryptoassets based on DLT.⁴⁷⁸ ⁴⁷⁵ In addition Lupu, CR 2019, 631; Brding/Julicher/Röttgen/v. Schönfeld, CR 2017, 136 [137] f.⁴⁷⁶ Blockchain Strategy of the Federal Government of 18 Sep. 2019, p. 13, available at: https://www.bmwi.de/Redaktion/DE/Publikationen/Digitale-Welt/blockchain-strategie.pdf?_blob=publicationFile=10 (accessed on 27 Nov. 2019).⁴⁷⁷ vgl. Andrieux, medium.com und https://legal-patent.com/intemational-intellectual-property/blockchain-based-evidence-approved-china/ (abgerufen am 27 Nov. 2019).⁴⁷⁸ Vos, The Launch of the Legal Statement on the Status of Cryptoassets and Smart Contracts, Rz. 12 ff. und 17 ff.

The level of detail and thus the individual fairness made possible by self-executing contracts and artificial intelligence depends to a large extent on the size of the database to which the evaluation algorithm has access.

In order to create a technical environment in which self-executing contracts can work precisely, the relevant information must be machine-readable and, if possible, transferred to a uniform database. The following applies here: the more information is available for the calculations, the greater the networking effect of the information among each other and the more precise the ejected results of the automated information processing.

In an optimal case, all information is available to the system, i.e. it is fully integrated and does not have to price in uncertainties or evaluate and integrate external factors. Of course, no information technology system is so perfect. Nevertheless, all information technology systems strive for this optimal state, since it puts them in a position to operate as autonomously as possible.

A basic task for automated licenses is to transfer the national patent registers into a uniform digital file format and to merge them into a worldwide register that represents the absolute number of intellectual property rights worldwide.⁴⁷⁹ Until now, each national patent office has in principle kept its own patent register. The European Patent Register kept by the European Patent Office pursuant to Art. 127 EPC is an exception in this respect as a supranational register. For a global patent register, the registry offices can either cooperate⁴⁸⁰ or make the data available to a third party organisation⁴⁸¹ which then creates and maintains such a register.⁴⁸² ⁴⁷⁹ “Recording IP rights in a distributed ledger rather than a traditional database could effectively turn them into “smart IP rights”, Clark, WIPO Magazine, January 2018; vgl. auch Hohn-Hein/Barth, GRUR 2018, 1089 [1092].⁴⁸⁰ Some patent offices (CIPO, CNIPA, EPO, JPO, KIPO, USPTO and WIPO) already cooperate via the “Global Dossier Service” and thus offer central access to the contents of patent documents, see https://register.epo.org/help?topic=globaldossierng=en (accessed on 27 Nov. 2019).⁴⁸¹ The patent registers are generally accessible to the public anyway, cf. Art. 127 S. 3 EPC (EPO) and Sec. 30 (1) Patent Law (DPMA)—but with different scope of electronic inspection.⁴⁸² Cf. for example: http://globalpatentregistry.io/ (accessed on 27 Nov. 2019).

In a second step, the global register database must be compared with the databases of the standardization organizations. To date, the standardisation organisations have maintained their own databases⁴⁸³ for essentiality reports and FRAND declarations of commitment. Not all databases are publicly accessible. ⁴⁸³ E.g. the ETSI IPR ONLINE DATABASE: https://ipr.etsi.org/ (accessed 27 Nov. 2019) and for the International Organization for Standardization (ISO): https://www.iso.org/iso-standards-and-patents.html (accessed 27 Nov. 2019).

Ideally, the standardisation organisations should integrate their reporting obligations into the global register database. The legal background could be found in the fact that the Düsseldorf Higher Regional Court regards the FRAND declaration of commitment as a limitation of the rights arising from the patent. Once submitted, the restriction is liable to the SEP.⁴⁸⁴ The FRAND declaration of commitment is thus protected against succession. It does not have to be filed separately with the SEP or re-submitted to the standardization organization after the SEP has been acquired, but is an indispensable burden on the patent itself. It is⁴⁸⁵ then justified to include the essentiality notifications and FRAND declarations of commitment directly in the patent register. License seekers can thus quickly obtain clarity about the situation regarding intellectual property rights. The European Court of Justice has pointed out that in view of the large number of protective rights in the standard, the infringer of an SEP does not necessarily know that he is using the doctrine of a legally valid and standard essential patent. The⁴⁸⁶ European Commission is also of the opinion that the quality and accessibility of the databases of the standardisation organisations should be improved⁴⁸⁷. It proposes to simplify the interfaces for data exchange and requires that old documents be transferred to current data formats. In addition, the Commission proposes to link the data of the standardisation organisations with the databases of the patent offices.⁴⁸⁸ ⁴⁸⁴ OLG Düsseldorf, Urt. v. 22 Mar. 2019, I-2 U 31/16, Rz. 205=GRUR 2019, 725—Improving Handovers.⁴⁸⁵ OLG Düsseldorf, Urt. v. 22 Mar. 2019, I-2 U 31/16, Rz. 205=GRUR 2019, 725—Improving Handovers.⁴⁸⁶ EuGH, Urt. v. 16 Jul. 2015 in the version passed on 15 Dec. 2015, C-170/13, paragraph 62=GRUR 2015, 764—Huawei Technologies/ZTE Corp. et al.⁴⁸⁷ European Commission, COM (2017) 712, p. 3 f.⁴⁸⁸ European Commission, COM (2017) 712, p. 4, Section 1.1.

The resulting central global register thus contains all register data on all patents worldwide. On this basis, simpler transactions such as patent transfers or the payment of annual fees can be automated. In order to automate entire license agreements, especially for essential patent portfolios, further data is required. The data records required for this should also be stored in a block chain if they have been identified as necessary and entered, in order to avoid system breaks. If these data are confidential trade secrets of a company involved in a transaction, a (possibly parallel) non-public blockchain could be⁴⁸⁹ maintained as backup and supplementary storage. ⁴⁸⁹ Hohn-Hein/Barth, GRUR 2018, 1089 [1090].

As a robust system, the blockchain technology is ideally suited “to document the value-added processes carried out and make them available to all parties involved in a transparent and manipulation-free manner⁴⁹⁰”. The continuous updating of the blockchain enables automated contracts to operate independently if certain conditions are met. If the process is continuously documented, entire condition chains can be processed and even extremely complex transactions can be carried out without human intervention. The two technologies presented are transparent and have the potential to massively reduce transaction costs for the exchange of goods.⁴⁹¹ ⁴⁹⁰ Association of the Bavarian Economy, Blockchain and Smart Contracts, p. 8.⁴⁹¹ Association of the Bavarian Economy, Blockchain and Smart Contracts, p. 15.

The following will therefore show how these exponential technologies could be used, for example, in FRAND licensing. For this purpose, evaluation bases and factors have to be worked out and it has to be checked which additional data have to be collected so that an algorithm can repeat them regularly and self-executively. The increased requirements of case law for the transparency of the calculation and non-discrimination of a FRAND license offer as well as the requirements on other aspects of licensing practice make⁴⁹² the licensing of essential patents in practice more complex and resource-intensive. However, the license seekers will not accept a transparent licensing model implemented according to these specifications in the market reality if the license fees calculated in this way are higher than the currently demanded and paid license fees due to the higher transaction costs. After all, even in FRAND cases, the license fee is only one of many economic factors and the sales price has a considerable influence on the sales opportunity of a product. Implementation companies will not be prepared to pay a higher license fee than before in favor of a more legally precise solution. ⁴⁹² These include the use of adjustment clauses for exhaustion situations and changes in portfolio size, the target group of the license within a value chain and the continuation of the previous licensing practice after the transfer of an essential patent; see Chapter 2.

It is proposed to reduce the transaction costs addressed by self-executing license agreements in order to create an attractive licensing model for essential patents. The blockchain technology should be used to ensure that the processed information is not only traceable for the license agreement parties and third parties, but can also be stored in a forgery-proof manner.

In order for a self-executing pricing algorithm to be able to charge the license seeker a fair and reasonable royalty, which is non-discriminatory in the context of existing licenses, certain basic decisions need to be taken and the factors for pricing determined. It will be shown where the central course is set for this and on the basis of which premises a practical licensing system could work.

For more than a decade, FRAND licensing has been the subject of jurisprudence and literature. A large number of opinions on certain aspects of license calculation have emerged, some of which concern the interests of researching companies and some of which reflect the interests of standard implementers. It is not possible to identify a lowest common denominator in this thicket of economic theories and sometimes diametrically opposed legal views. The practical difficulties resulting from this are documented by the extensively substantiated first-instance judgments in the case of Unwired Planet v Huawei⁴⁹³ and TCL v Ercisson.⁴⁹⁴ The judges have set themselves the mammoth task and tried, with energetic expert support, to pave their way through the diversity of opinions. If one reflects the criticism of these decisions and offers supplementary approaches, it seems possible to build on these findings and to develop a consistent evaluation concept. For this purpose, a number of basic points must be observed. ⁴⁹³ EWHC, Resolution v. 5 Apr. 2017, Az. [2017] EWHC 711 (Pat).⁴⁹⁴ United States District Court Central District of California, Entsch. v. 8 Nov. 2018, SACV14-00341 JVS (DFMx).

The first question to be asked is whether and, if so, how the holder of a SEP portfolio can change his licensing programme for the future in order to be able to use the automated licensing mechanism proposed in this paper.

As explained in § 10II.2., the Düsseldorf Higher Regional Court recently had to deal with the question whether the holder of a portfolio of essential patents may change his licensing practice if he has already granted licenses for his portfolio or a part of the portfolio in the past which are still in force (hereinafter referred to as “old contracts”).⁴⁹⁵ ⁴⁹⁵ OLG Düsseldorf, Urt. v. 22 Mar. 2019, I-2 U 31/16=GRUR 2019, 725—Improving Handovers.

The 2nd Civil Senate came to the conclusion that after the first granting of a non-exploitative license, the patent holder can only deviate from the licensing practice adopted under more difficult conditions and that a change in the license fee would only be possible if all license agreements were adjusted in parallel for economically compelling reasons—which in turn required contractual adjustment clauses.⁴⁹⁶ ⁴⁹⁶ OLG Düsseldorf, Urt. v. 22 Mar. 2019, I-2 U 31/16, Rz. 413 f.=GRUR 2019, 725—Improving Handovers.

This means that if the SEP holder
(i) has not yet concluded any licensing agreements for its patent portfolio, or
(ii) has not yet concluded a license agreement for a particular licensed item (e.g. a particular technology standard and/or a new field of application such as mobile telephony in automobiles⁴⁹⁷), he can start a new licensing practice in these areas in an unobjectionable manner under antitrust law. He has the full corridor to the limit of exploitative abuse at his disposal. In particular, the introduction of the fifth generation “New Radio” (NR) mobile telephony standard commonly referred to as “5G” opens up new opportunities for SEP holders to exploit and apply SEPs. ⁴⁹⁷ For more details see § 21 Section IV.

If, however, reference contracts already exist, two scenarios are conceivable for a change in licensing practice:
(i) On the one hand, the patent holder could try to smoothly change the current licensing practice and successively change the license agreements for the essential patent portfolio.
(ii) Alternatively, the patent holder could try to establish a new licensing practice by a complete “reset” of his licensing practice.

The latter two alternatives will be examined in the following sections before the legal reality of the case law of the Düsseldorf Higher Regional Court.

Of primary practical interest might be the possibility of a fluent change in licensing practice, i.e. the patent holder starts a new licensing practice with new license seekers while license agreements established in the past are still being processed in parallel.

The Düsseldorf Higher Regional Court points out two different possibilities for such a change in current licensing practice. The patentee may either:
adjust all existing contracts simultaneously by means of contractual adjustment clauses, if any, (homogeneous adjustment); or
adjust its licensing practice only to the extent that the deviation is still objectively justified vis-à-vis licensees of comparable situation (gradual adjustment).

The self-executing license agreements must also not discriminate against new licensees in a competition-relevant manner vis-à-vis existing licensees with existing agreements. What is decisive is that the adapted licensing practice “does not result in undue discrimination (worse treatment) against later or former licensees”⁴⁹⁸ ⁴⁹⁸ OLG Düsseldorf, Urt. v. 22 Mar. 2019, I-2 U 31/16, Rz. 413=GRUR 2019, 725—Improving Handovers.

In the case of a gradual adaptation of licensing practice, it could therefore be considered whether individual licensing by means of self-executing contracts is objectively justified in individual cases as a new type of licensing. The background for this is that the automated FRAND licenses combine elements of the previously used accounting modalities. The transaction costs for automated licenses are similarly low to those of a lump sum payment, but the nature of automated royalties is that of ongoing royalties, which can be expressed either as unit licenses or as percentage quota licenses⁴⁹⁹. In this way, the automated license fee in demand follows the paradigm shift in case law produces transparently calculated results which, in individual cases, are more in line with the FRAND principle than the practical approach described. ⁴⁹⁹ For more details see § 21 Section III.2.

This is in line with the European Commission's requirements that the transaction costs associated with the negotiation of a license should be kept to the minimum necessary and efficiency gains should be taken into account. The⁵⁰⁰ fact that the SEP holder may offer the license seeker various settlement modalities without being exposed to the accusation of unfounded discrimination is demonstrated, for example, by the HTC v Ericsson decision.⁵⁰¹ There the jury had found a piece license as well as a percentage license for FRAND. ⁵⁰⁰ European Commission, COM (2017) 712, p. 9; see § 14 Section III.⁵⁰¹ United States District Court Eastern District of Texas, Resolution of 23 May 2019, 6:18-CV-00243-JRG, p. 14, [CL 25]; see § 10 Section II.1.

However, the decisive question as to whether the SEP holder may (still) refer to an objective justification because of the efficiency gains is ultimately the economic burden on the licensed object in the individual case. As introduced in the introduction, no economically minded licensee in the licensing reality will be prepared to pay higher royalties than for a flat-rate license—and thus place a less competitive product on the market—only in order to obtain a license tailored to his individual economic needs.⁵⁰² The boundary of the objective justification is then regularly spanned. ⁵⁰² In addition already in § 1 and § 14 section III.

Thus, SEP holders will only be able to gradually change their licensing practices (and, if necessary, to achieve higher license fees—since they are calculated automatically and continuously on an individual basis—within narrow limits if they have not provided for opening or adjustment clauses in their previous license agreements.

If the patent holder is not allowed to change his licensing practice according to any of the above variants “in the current licensing operation”, he could alternatively consider a complete restart of his licensing practice. In the opinion of the Düsseldorf Higher Regional Court, the patent proprietor would first have to terminate all old contracts at the same time—or the old contracts would otherwise have to be terminated by the expiry of a fixed, always the same contractual period on a certain date.⁵⁰³ ⁵⁰³ OLG Düsseldorf, Urt. v. 22 Mar. 2019, I-2 U 31/16, ref. no. 414=GRUR 2019, 725—Improving Handovers, “if and as soon as they are effectively terminated”; outlined above in § 10 Section II.3

If this approach is consistently pursued, the patent proprietor would probably have to wait beyond the time of the effective termination until none of the old contracts is actually in force any longer, since for the purposes of the discrimination test under Art. 102 TFEU it is important whether the discriminatory action of the dominant undertaking leads to a noticeable impairment of competition.⁵⁰⁴ However, an appreciable restriction of competition is only excluded if all license agreements for the (new) portfolio to be licensed have expired and none of the former licensees pays any more royalties. ⁵⁰⁴ See ECJ, Judgment of the Court of Justice. 19 Apr. 2018, C-525/16=GRUR Int. 2018, 850—MEO, Ls.

Such a “reset” of licensing practice puts the patent holder in a dilemma: On the one hand, he has committed himself to the standardization organization to grant everyone a license to his essential patents under FRAND conditions. On the other hand, he has an interest in coordinating the termination of these licenses in order to be able to establish a new licensing practice. For reasons of antitrust law, he cannot avoid this dilemma by not granting any further licenses to his portfolio for a certain period of time. Licensees with previous contracts would continue to pay royalties and include them in their product prices. These licensees would be significantly disadvantaged by the price premium on their product sold on the market. In sharp contrast to this, other license seekers—who are basically willing to license—received a free license on the portfolio for the same period—at least until the patent holder is prepared to negotiate new license agreements in accordance with the changed licensing practice.

Thus, even the patent holder seeking a “reset” of his licensing practice is still required to conclude new contracts with license seekers. However, he will ensure that the license agreements are limited in time—for example by bridging regulations—so that they all expire on a selected date.

In practice, such a request would be quite complex, as license negotiations often take months or years before they are concluded. It is doubtful whether a short-term bridging arrangement can be found. For the patent holder, however, this is only relevant if and as long as he negotiates with the license seekers. As soon as he has started to apply his new licensing practice, the amount of the license fee during the bridging periods in the guise of the license analogy is (only) a question of compensation for the past.⁵⁰⁵ ⁵⁰⁵ . . . a position which the patent holder should not, of course, renounce for the past without objective reason, since the renunciation would otherwise discriminate against licensees with old contracts.

In conclusion, it should be noted that, in the opinion of the Düsseldorf Higher Regional Court, it is in principle still possible for dominant companies to leave the licensing practice once adopted within the limits of the prohibition of exploitation. However, a smooth adaptation of current licensing practice requires a great deal of tact and prudence to ensure at all times that none of the old or new licensees are treated noticeably differently from an economic point of view, without any reason.

Depending on the extent of the differences between the old contracts and the automated license agreements for a specific license object and a specific SEP portfolio in the individual case, the transaction costs saved may possibly be cited as an objective justification—however, a blanket view is also prohibited here.

If it is to be ensured beyond doubt that none of the licensees/license seekers is discriminated against in individual cases, it is advisable to use self-exposing licenses either for an entirely new licensing practice or an entirely new object of application or to simultaneously terminate the old contracts in a controlled manner through a “reset” of the licensing practice or to simultaneously adapt them via contractual adjustment clauses, if any.

When calculating the license fees for a patent portfolio, temporal and territorial pricing components are important factors, because patent portfolios are subject to currents; patents are added and patents are dropped—in Vary's words: “SEP portfolios are living things: they change over time”⁵⁰⁶ ⁵⁰⁶ Vary, twobirds.com.

⁵⁰⁷A worldwide patent database harmonised in accordance with the present invention provides important objective information on the territorial spread, weighting and residual maturity of the SEP assigned to a standard as well as on its holder and the size of the portfolio belonging to the standard. The negotiating parties quickly receive precise background information, which they can incorporate into pricing. If the automated FRAND license offer and the automatically administered FRAND license agreement are to provide added value in terms of content compared to the weighted FTO⁵⁰⁸ currently granted, both the “time” and “license territory” factors need to be addressed in more detail. According to current practice, these aspects are only two of many negotiating factors for the contract offer on the basis of a worldwide mixed calculation during the duration of the contract. ⁵⁰⁷ See § 19.⁵⁰⁸ For more details see § 15 Section II.

By their very nature, patents are closely interwoven with a temporal fate. Time plays a central role in the existence of a patent, starting with the temporal priority rank and the thus defined pre-published prior art, the filing date, the date of publication of the grant of the patent, annual renewal fees and finally up to the expiry of the twenty-year term of protection of the temporally limited monopoly.⁵⁰⁹ Time—in the form of a temporary exclusion right—is what the state can grant the patent holder for the disclosure of his invention. The term of protection of the portfolio patents to be licensed therefore plays a significant role in the valuation of the portfolio. ⁵⁰⁹ Or as Michael Ende put it: “for time is life” [Momo].

Licenses are basically oriented towards the future. In order to take adequate account of the quantitative development and qualitative fluctuation in the portfolio of IP rights for the duration of the contract, the Düsseldorf Higher Regional Court has called for an adjustment clause in the license agreement “which permits a price adjustment (in both directions) if there are noticeable changes in the portfolio of IP rights”.⁵¹⁰ The Karlsruhe Higher Regional Court has also pointed out that the patent proprietor must in any event, in the event of changes in the portfolio of industrial property rights which have “considerable effects on the economic relationship between performance and consideration”, explain why the license fee requested is FRAND for the entire term of the contract.”⁵¹¹ ⁵¹⁰ OLG Düsseldorf, reference decision of 17 Nov. 2016, I-15 U 66/15 Rz. 43=GRUR-RS 2016, 21067, Holtorf/Traumann, GRUR-Prax 2017, 42; see § 11 Section II.⁵¹¹ OLG Karlsruhe, Beschl. v. 8 Sep. 2016, 6 U 58/16, Rz. 54=GRUR-RS 2016, 17467—Decoding device with note Holtorf/Traumann, GRUR-Prax 2016, 560.

If the portfolio patents were already used before the license was granted, a FRAND offer should also contain an additional retrospective element. For this period, the license seeker owes at least damages according to the calculation method of the license analogy.⁵¹² ⁵¹² The Mannheim District Court (judgment of 10 Nov. 2017, 7 O 28/16=GRUR 2018, 864—Funkstation) gives an unlimited title to the preparatory claim for invoicing, while the Düsseldorf courts limit this claim to the details for the calculation according to license analogy for the period in which a FRAND offer was not submitted contrary to duty (cf. judgment of 10 Nov. 2017, 7 O 28/16=GRUR 2018, 864—Funkstation). 22 Mar. 2019, 1-2 U 31/16, Rz. 400 ff.=GRUR 2019, 725—Improving Handovers).

The contractual linchpin of the automated FRAND license agreement offer is the time of the licensing request. From this moment on, the forward-looking license fee and—if necessary—the backward-looking amount of damages can be calculated. For this purpose, all calculation-relevant values, insofar as they are subject to the temporal change, are recorded in a “snapshot” (snapshot, evaluation snapshot) at the time of the licensing request. In information technology, this refers to the snapshot of a global state in a changing system at a particular point in time.⁵¹³ ⁵¹³ https://de.wikipedia.org/wiki/Schnappschuss_(Infornationstechnik) (accessed 27 Nov. 2019).

By combining automated contract design with forgery-proof storage in a blockchain, the aim of this thesis is to save⁵¹⁴ data and computing time by gradually taking snapshots, so-called incremental snapshots. Because every snapshot captured by the system and stored in the blockchain captures the global state of the system. This means that the complete evaluation process does not have to be completed every time, but it is sufficient for the system to update the last stored snapshot and only calculate the changes from the previous state using the algorithm. Of course, the system should carry out regular security cross-checks by parallel and complete recalculations on the basis of a current snapshot. This allows the system to reassure itself that the pricing algorithm is working correctly and precisely and also avoids redundancies. ⁵¹⁴ https://www.itwissen.info/incremental-snapshot-Inkrementelle-Momentaufnahme.html (accessed 27 Nov. 2019).

The time interval for the valuation of the SEP portfolios relevant for a standard can be set at will. The smallest time unit for the evaluation is the day, since the term of protection of a patent is exactly twenty years to the day since the filing date⁵¹⁵. The patent develops its full protective effect on the date of publication of its grant.⁵¹⁶ ⁵¹⁵ § Sec. 16 PatG, Art. 33 TRIPS; for the term of protection as the usual contractual connecting factor, see Haedicke/Timmann, Sec. 4, para. 113 m.w.N.⁵¹⁶ § Sec. 58 (1) Patent Law.

Although a daily assessment is possible, it is extremely resource-intensive, as changes in the worldwide intellectual property rights portfolio must be tracked on a daily basis. For practical reasons, a monthly or quarterly update is recommended.

In order to create legal certainty, a specific time zone should in any case be established as the relevant contractual connecting factor.

The offered license fee is a legal snapshot, as it is based on the time interval of the evaluation. For example, if the global rating is updated monthly, the license fee offered will change from month to month.

After a successful conclusion of the license agreement, the agreed license fee is determined for each time interval and is thus continuously updated within the framework of license management. In principle, it seems possible that the parties to the agreement are free to choose the update interval—provided that this does not result in price discrimination in practice, especially in the case of different agreements with comparable licensees.

This approach makes the costs of the license fee transparent to the licensee at all times and documents them (using a blockchain). However, a possible deficit exists in the predictability of costs if the licensee plans future business activities (e.g. product developments, investments). The evaluation algorithm knows via the global patent register when the term of protection of the licensed patents will definitely⁵¹⁷ end. Therefore, it could be estimated for a certain period in the future how the amount of the royalty will develop in this respect (calculated from the value of the remaining patents). When licensing fluctuating patent portfolios, additional consideration would have to be given to how the overall burden of essential patents on the standard is likely to develop over this period as a result of new grants. This is because the major licensors in the field of mobile communications and wireless data transmission are currently granted considerably more patents than portfolio patents expire: ⁵¹⁷ If the patent has not previously been bindingly revoked, destroyed (see section e below) or abandoned.

If necessary, changes in the reference value and/or the causality component of the standard must also be taken into account. The further the forecast period lies in the future, the more uncertain the forecast is likely to become.

Such a “forecast-tool” could nevertheless help to create clarity for entrepreneurial planning in the short term. For patent holders, this would open up new possibilities in the assessment and management of individual patents, for example in assessing whether it is worth maintaining or dropping individual patents in order to save annual fees.⁵¹⁸ ⁵¹⁸ For example, because the annual fee for a nation state is higher than royalty income in that state. However, future markets that may emerge and/or grow during the twenty-year term of protection should not be lost sight of.

In addition to the offer of the license for the future, the offer could include provisions for the remuneration of past acts of use.⁵¹⁹ The European Court of Justice requires the license seeker to provide the SEP holder with a statement of past use and adequate security for the sums owed.⁵²⁰ It therefore generally recognises the asset position of the SEP holder as worthy of protection. The license seeker would therefore be expected to negotiate and conclude a solution for the past together with the license for the future. ⁵¹⁹ Usually referred to in practice as release payments.⁵²⁰ EuGH, Urt. v. 16 Jul. 2015 as amended by the resolution of 15 Dec. 2015, C-170/13, paragraph 67=GRUR 2015, 764—Huawei Technologies./. ZTE et al.;

The royalty due may be calculated for the past on the basis of data stored in the system of comparable licensees (in the case of a comparative license approach valuation⁵²¹) or global values (in the case of a top-down approach valuation⁵²²) for each billing interval individually. The license seeker knows from his books in which period of time and to what extent he has carried out activities subject to remuneration. If he informs the SEP holder of this data—while maintaining the necessary confidentiality—the exact amount of the compensation payment can be determined. ⁵²¹ See also § 21 Section III.4.b).⁵²² See also § 21 Section III.4.a).

Here, too, supplementary regulations and mechanisms are conceivable, such as an increase in the compensation payment for the SEP holder's loss of flat-rate income opportunities as a result of the subsequent payment—or simply for penalty considerations.⁵²³ If penalty considerations should be priced into the compensation payment, a return flow to licensees who concluded a license agreement early before or immediately after their commencement of use could be provided for. For example, a financial incentive could be created against hold-out⁵²⁴ strategies whereby users of standardised technologies hope to subsequently obtain discounts for past acts of use by concluding contracts as late as possible and also benefit from better liquidity during use because they do not pay license fees. ⁵²³ For punitive damages under European law, see in detail ECJ, judgment of 9 Jun. 2016, C-481/14=GRUR 2016, 1043 with note Trauernicht/Thöne—Hansson/Jungpflanzen and ECJ, judgment of v. 25 Jan. 2017, C-367/15=NJW 2017, 1373 with note Hauck.⁵²⁴ See also § 6.

An interesting temporal aspect is connected with the subsequent omission of licensed patents with effect ex tunc⁵²⁵. According to the case law of the German courts⁵²⁶ and the European Court of Justice, the⁵²⁷ license fee remains unaffected by the subsequent discontinuation of the licensed property right due to the Wagnerian nature of a license agreement. Altmeyer and Weber argue that this principle should not be applied to standard essential portfolio patents as an exception due to the special antitrust situation.⁵²⁸ Be that as it may, this question is a detailed problem that can be solved if the central evaluation factors are defined and coordinated in practical application. ⁵²⁵ Possible options include revocation and declaration of invalidity (in Germany: Sec. 21 (3) Sentence 1, Sec. 22 (2) Patent Law in conjunction with Sec. § 61 PatG or § 81 PatG).⁵²⁶ Lecturer in LG Düsseldorf, Urt. v. 12 Aug. 2008, 4b O 17/08=BeckRS 2009, 08738—Coin deposit lock.⁵²⁷ EuGH, Urt. v. 12 May 1989, C-320/87=GRUR Int 1990, 458—Ottung; ECJ, Judgment of the Court of First Instance 7 Jul. 2016—C-567/14=GRUR 2016, 917 with note McGuire/Ackermann—Genentech Inc./Hoechst GmbH et al.⁵²⁸ Weber/Altmeyer, GRUR, 2017, 1182.

The complexity is demonstrated by the fact that reclaims are generally subject to very substantial transaction costs if the value of the portfolio license is subsequently recalculated for the past and entered in the accounts. Licensees in a SEP should therefore (at least initially) not be treated differently from licensees in patents that are not standard essential.⁵²⁹ ⁵²⁹ See Kühnen, Chapter E; Rz. 351.

In territorial terms, there are also challenges for the calculation of licenses in individual cases.⁵³⁰ Typically, the patent holder does not search for a patent in all countries affected by standardization. For example, the progressive renewal fees for the maintenance of patents create an incentive for the applicant or holder either not to apply for patent protection in economically less interesting states, not to complete the application procedure in full or to drop the patent protection obtained before time (e.g. by not paying the renewal fee⁵³¹) ⁵³⁰ Haedicke/Timmann, § 4, margin no. 112.⁵³¹ In Germany: Sec. 20 (1) No. 2 PatG and Art. 83 (1) Sentence 3 EPC; see BGH, Beschl. v. 11 Mar. 2008, X ZB 5/07=GRUR 2008, 551—Sageblatt; according to Schafers, this fact may be the statistically most frequent reason for extinction, see Benkard/Schafers, PatG, Sec. 20, para. 11.

In practice, standardized technology is therefore often only protected by patents in important sales markets or future markets and can be used free of charge in other parts of the world at the same time. This situation is relevant for the antitrust tug-of-war between the exclusive right conferred by a patent and the FRAND commitment in so far as the standard user in countries without patent protection is not dependent on access in order to be able to operate on the corresponding product market—or the geographical submarkets of the product market in these countries. There is no threat of the patentee hindering market entry or affecting trade by means of an exclusive right.

Thus the standard user basically only needs licenses for the use of the claims of standard essential patents in force in order to be allowed to legally⁵³² manufacture, distribute and use his standard-compliant product worldwide or to legally offer and perform his standard-compliant service worldwide. ⁵³² According to h.M., the license gives the licensee a positive right of use to the patented teaching on technical action, see Bartenbach, ref. no. 73, m.w.N.

In order to enable individualisation in individual cases, both the territorial extension of the licensed portfolio and the territorial dimension of the licensee's acts of use must therefore be set in relation to each other. Different degrees of detail are conceivable: The attempt to record the territorial relation of the license per actual act of use, i.e. for every manufactured and distributed end product, is an immense challenge and causes a very considerable effort. The worldwide distribution channels and value chains would have to be recorded daily and for several hundred million products in parallel. The task seems technically feasible in principle, but⁵³³ the costs of its realisation are currently still far higher than its financial benefit. ⁵³³ See the outlook in § 24.

Alternatively, certain territorial zones could⁵³⁴ be provided to take account of territorial portfolio coverage and, where appropriate, regional price differentials. In TCL v Ericsson, for example, Judge Selna has defined three zones with different license rates: the USA, Europe and the rest of the world (RoW).⁵³⁵ Justice Birss also differentiated Unwired Planet v Huawei regionally into “major markets” and “other markets”.⁵³⁶ ⁵³⁴ See also § 22 Section V.1.d).⁵³⁵ United States District Court Central District of California, Entsch. v. 8 Nov. 2018, SACV14-00341 JVS (DFMx), S. 17, 46 ff. und 114.⁵³⁶ EWHC, Resolution v. 5 Apr. 2017, Az. [2017] EWHC 711 (Pat), Rz. 587 and 593.

In order to create a consistent licensing program, the reference value for the license, the manner in which it is billed, and finally the valuation approach must be fundamentally defined and coordinated.

A decisive factor for a consistent licensing program is the selection of the correct reference value for the FRAND license and the subsequent question of how the reference value is to be reflected in the valuation approach. As a preliminary consideration, the question arises as to the subject-matter of the license and thus in particular as to the relevant reference factor if the licensed technology is used in components of a complex product.⁵³⁷ The technological development of the past three decades—particularly in the field of information technology—has fundamentally changed the markets, the competition for innovation and the filing behaviour with regard to the patenting of technology. In the last century, a patent typically claimed a rather concrete design of a device or process.⁵³⁸ Nowadays, many products are modular and are delivered and distributed globally and therefore⁵³⁹ often use several thousand patents, especially when telecommunication technology is one of the functionalities of the product.⁵⁴⁰ The choice of the subject matter of the license or the reference value is therefore of decisive importance in FRAND licensing. ⁵³⁷ European design law defines a complex product as “a product consisting of several components which can be replaced so that the product can be disassembled and reassembled”, Art. 3 lit. c of Council Regulation (EC) No. 6/2002 of 12 Dec. 2001 on Community Designs (OJ EC No. L 3 of 5 Jan. 2002, p. 1); cf. also BGH, Urt. v. 10 May 2016, X ZR 114/13, para. 44=GRUR 2016, 1031—Warmetauscher: “[ . . . ] Space for a period of use to be exceptionally granted [ . . . ] if the infringing object concerns only a small, but functionally essential component of a technically complex device and cannot be replaced within a reasonable time by a patent free or licensable product”.⁵³⁸ Osterrieth, Mannheim Patent Days 2018, p. 8.⁵³⁹ E.g. in disputes about so-called “connected cars” and IoT functionalities, see for example https://www.juve-patent.com/news-and-stories/cases/warning-trolls-ahead/ (accessed on 27 Nov. 2019), https://www.juve-patent.com/news-and-stories/cases/next-broadcom-battle-over-daimler-and-bmw/ (accessed on 27 Nov. 2019) and https://www.juve-patent.com/news-and-stories/legal-commentary/pool-party/ (accessed on 27 Nov. 2019).⁵⁴⁰ Osterrieth, GRUR 2018, 985; Picht, GRUR 2019, 11; cf. also ECJ, Judgment of the Court of Justice of the European Communities 16 Jul. 2015 as amended by the resolution of 15 Dec. 2015, C-170/13, paragraph 62=GRUR 2015, 764—Huawei Technologies./. ZTE et al.; Opinion of 20 Nov. 2014, C-170/13, paragraph 81.

In practice, the question of the correct reference value, especially for licenses for components that are built into complex products, is often disputed in the infringement process.⁵⁴¹ The question arises as to which level should be licensed—at the level of the (in case of doubt) more favorably priced delivered components or at the level of the complex end product.⁵⁴² The dispute can be illustrated using the example of the networked car: The license for a mobile radio patent can either be linked to the price of a supplied chip (component level) or to the selling price of the vehicle.⁵⁴³ ⁵⁴¹ As far as can be seen, it has not yet been relevant to decisions in German processes.⁵⁴² United States Court of Appeals, Federal Circuit, Entsch. v. 30 Aug. 2012, 694 F.3d 51 (Fed. Cir. 2012)—Laserdynamics, Inc. v Quanta Computer, Inc., S. 52: “Where small elements of multi-component products are accused of infringement, calculating a royalty on the entire product carries a considerable risk that the patentee will be improperly compensated for non-infringing components of that product”.⁵⁴³ Bold, GRUR 2019, 665.

Judge Gilstrap, the question of the choice of the reference value for a FRAND license on a mobile portfolio in HTC v Ericsson was submitted for decision in a jury trial.⁵⁴⁴

HTC argued that the FRAND commitments made to ETSI by Ericsson on behalf of SEP obliged it to grant and charge licenses on the basis of the ‘smallest salable patent-practicing unit’ (SSPPU)—in the case of a mobile telephone, the baseband processor.⁵⁴⁵ Ericsson counterclaimed for a declaration that FRAND licenses do not have to be linked to the SSPPU.⁵⁴⁶ ⁵⁴⁴ United States District Court Eastern District of Texas, Resolution of 23 May 2019, 6:18-CV-00243-JRG, pp. 7 to 11; Interim Resolution of 7 Jan. 2019, 6:18-CV-00243-JRG [Dkt. No. 376].⁵⁴⁵ United States District Court Eastern District of Texas, Entsch. v. 23 May 2019, 6:18-CV-00243-JRG, S. 8.⁵⁴⁶ United States District Court Eastern District of Texas, Zwischenentsch. v. 7 Jan. 2019, 6:18-CV-00243-JRG, S. 2.

The court first approached the question via ETSI's IPR policy and stated: “However, as both parties' experts concede, the ETSI IPR policy says nothing about what it means for a license to be FRAND”.⁵⁴⁷ Ericsson's private evaluator, a member of the ETSI IPR Committee from 1989 until the ETSI IPR Policy came into force in 1994, stated that at the time of the adoption of the IPR Policy it was common practice in the industry to license at the terminal level and not at the component level. They had not wanted to influence this industry practice, which has continued to this day.⁵⁴⁸ HTC pointed out that the ETSI IPR policy was not adopted unanimously but only by a majority decision and therefore did not constitute a common intent of all ETSI members.⁵⁴⁹ ⁵⁴⁷ United States District Court Eastern District of Texas, Zwischenentsch. v. 7 Jan. 2019, 6:18-CV-00243-JRG, S. 9.⁵⁴⁸ United States District Court Eastern District of Texas, Resolution of 23 May 2019, 6:18-CV-00243-JRG, p. 10; Interim Resolution of 7 Jan. 2019, 6:18-CV-00243-JRG, p. 9 to 11.⁵⁴⁹ United States District Court Eastern District of Texas, Entsch. v. 23 May 2019, 6:18-CV-00243-JRG, S. 10.

Ericsson added that HTC underestimated the value of wireless technology. This is not limited to the baseband processor, but requires additional components such as antennas, RF switches, baseband filters, low-noise amplifiers and duplexers⁵⁵⁰. The vast majority of Ericsson's essential patent claims refer to “mobile terminals” or “user equipment”, which necessarily includes other components in addition to a baseband processor.⁵⁵¹ ⁵⁵⁰ United States District Court Eastern District of Texas, Entsch. v. 23 May 2019, 6:18-CV-00243-JRG, S. 9 f.⁵⁵¹ United States District Court Eastern District of Texas, Entsch. v. 23 May 2019, 6:18-CV-00243-JRG, S. 9 f.

The profit margin of a component supplier, if any, does not necessarily reflect the value of the patents contained in the component. End customers particularly value certain functionalities and are willing, for example, to pay more than USD 100 for a mobile tablet than for a WLAN-only tablet.⁵⁵² ⁵⁵² United States District Court Eastern District of Texas, Entsch. v. 23 May 2019, 6:18-CV-00243-JRG, S. 9.

Finally, the Court found that HTC could not provide a practical example of a license at the chip level. Ericsson, on the other hand, has shown that it is customary in the industry to license at the terminal level (e.g. mobile phone, tablet).⁵⁵³ ⁵⁵³ United States District Court Eastern District of Texas, Entsch. v. 23 May 2019, 6:18-CV-00243-JRG, S. 10.

The Court therefore held that the FRAND obligation laid down in the ETSI IPR policy did not require a FRAND license to be determined on the basis of the SSPPU, but it did not exclude it.⁵⁵⁴ ⁵⁵⁴ United States District Court Eastern District of Texas, Interim Resolution of 7 Jan. 2019, 6:18-CV-00243-JRG, p. 12; Resolution of 23 May 2019, 6:18-CV-00243-JRG, p. 11.
Even after bold ones, the profit that can reasonably be expected hangs in the balance “the exploitation possibilities for the invention which the licensee's business promises in view of his specific product and customer orientation and against the background of his personnel and equipment, whereas it is completely irrelevant whether the fields of application eligible for the exploitation of the invention are (sufficiently) served by the licensee and whether the operating resources available to him are fully exhausted or not”⁵⁵⁵ ⁵⁵⁵ Kühnen, GRUR 2019, 665 [669] f.

If the license is based on the profit made at each individual exploitation stage, the inventor's participation in the intrinsic value of the invention, which is realised in the final product and its selling price, could only be obtained at the very last exploitation stage.⁵⁵⁶ However, the SEP holder was by no means certain that he would have access to licensing at this—profitable—point, because the FRAND declaration obliged him to grant a license on FRAND terms to any interested party, including the very first in a exploitation chain. If this had been done (possibly following an active offer complaint by the interested party), the prohibition rights from the SEP would have been exhausted for the entire further distribution channel along the exploitation chain, so that the granting of licenses at a higher exploitation level would no longer be considered. Under the special conditions of an obligation to contract which is otherwise foreign to the licensing business⁵⁵⁷ and the resulting exhaustion of patent rights, the question must be answered as to whether the SEP holder must fairly participate in the economic yield and benefit which is derived from his invention at the last stage of the exploitation chain. Since the question raised as to the fair inventor's remuneration must be answered in the affirmative in the case of a patent in kind which conveys absolute protection, the license fee is determined uniformly on the basis of the sales price at the final exploitation stage, irrespective of the licensee's location in the exploitation chain.⁵⁵⁸ ⁵⁵⁶ Bold, GRUR 2019, 665 [670].⁵⁵⁷ Fuchs also refers to the special “obligation to contract under antitrust law in the area of intellectual property rights”, Fuchs, NZKart 2015, 429 [434]; see ECJ, judgment of 5 Apr. 1995, C-103/94—Magill; judgment of v. Apr. 29, 2004, C-387/01—IMS Health.⁵⁵⁸ Kühnen, GRUR 2019, 665 [671] f.

In return, the entire distribution chain will be made free of intellectual property rights. The^{559 560} license fee to be paid once can be priced into the sales price of the intermediate product and is thus a ‘continuous cost item’ within the exploitation chain.⁵⁶¹ ⁵⁵⁹ Kühnen, GRUR 2019, 665 [671], upstream and downstream of the licensee.⁵⁶⁰ Bold, GRUR 2019, 665 [671].⁵⁶¹ Bold, GRUR 2019, 665 [672].

In HTC v Ericsson, Judge Gilstrap has collected useful facts on the industry standard of licensing at the terminal level and on the development of the ETSI IPR policy in order to support the court's decision historically and practically. His additional considerations concerning the product actually protected by the essential claims coincide with the considerations of the Federal Court of Justice in the decision on heat exchangers as to whether the infringing object concerns only a small but functionally essential component of a technically complex device,⁵⁶² other device components or the device as a whole. Kühnen supplements the facts established by Judge Gilstrap with a substantive justification according to the principle of fair inventor remuneration. The proposal to determine the license fee as a “transitory item” uniformly for the entire value chain creates an attractive change in practice: ⁵⁶² BGH, Urt. v. 10 May 2016, X ZR 114/13, Rz. 44=GRUR 2016, 1031—Heat exchanger.

Until now, a SEP holder who grants licenses at all levels of the value chain had to consider what value he could skim off at each level of the value chain (added value) and what causality share his invention(s) had in it. For this purpose, the SEP holder may be dealing with an industry in which he is not economically active other than in the licensing market itself. Since the European Court of Justice assigns him the obligation of the first FRAND offer,⁵⁶³ the SEP holder runs the risk of not hitting the⁵⁶⁴ FRAND corridor with his first offer in ignorance of the usual industry conditions and circumstances. The precise determination and updating of the respective conditions, however, increases the administrative effort and charges the license fee as transaction costs. ⁵⁶³ EuGH, Urt. v. 16 Jul. 2015 in the version passed on 15 Dec. 2015, C-170/13, Ls. 1, 1st indent=GRUR 2015, 764—Huawei Technologies./. ZTE et al.⁵⁶⁴ See also § 10 Section II.

Kühnen's approach, on the other hand, shifts the question of the distribution of the uniform (total) license fee to the recourse level within the value chain. For the SEP holder, it is therefore irrelevant who the addressee of his FRAND offer is and at what level of the value chain the company operates economically. The uniform reference value makes it easier for him to address a FRAND offer to the value chain. The companies that make up the value chain are very familiar with the conditions customary in the industry and the contractual terms of delivery in their respective markets. They are also better able to assess the share of their value added in the value of the end product than a company outside the value chain and possibly outside the industry could achieve. It is therefore reasonable for them to include the royalty demanded in the sales price of their intermediate product, possibly in proportion to their share of the value added.⁵⁶⁵ ⁵⁶⁵ Bold, GRUR 2019, 665 [671].

If the royalty is not allocated proportionately to the participating companies on the basis of the value added shares, but is simply priced in uniformly at all levels, it is actually a transitory item within the meaning of tax law⁵⁶⁶ and thus neutral to profits. This is because access to value and exit from value are the same at every level.⁵⁶⁷ However, it should also be possible to link the recourse mechanism to the share of value added.⁵⁶⁸ ⁵⁶⁶ See the definition under tax law in § 4 Para. 3 S. 2 EStG.⁵⁶⁷ BFH, judge of 4 Dec. 1996, I R 99/94, no. 9=BFHE 182, 131 m.V.a. BFH, judge of 4 Dec. 1996, I R 99/94, no. 9=BFHE 182, 131 m.V.a. BFH, judge of 20 Jul. 1982, VIII R 143/77=BFHE 136, 262.⁵⁶⁸ For more details see § 23.

On the basis of these practical considerations, which also lead to lower transaction costs, the calculation mechanism proposed in this paper is intended to link the reference value of the final product to the value of the final recovery stage, in accordance with industry practice. This also corresponds to the undisputed understanding of the parties in Unwired Planet v Huawei.⁵⁶⁹ ⁵⁶⁹ EWHC, Resolution v. 5 Apr. 2017, Az. [2017] EWHC 711 (Pat), Rz. 593.

If the value of the product distributed on the retail market is the royalty basis, the subsequent question arises as to whether the reference value is to be recorded specifically for each individual case or whether a uniform royalty basis can be defined for standard-compliant final products. This is because the reference value plays a different role in the valuation concept, depending on the settlement model used. In this paper, three different accounting models are discussed, which are used in practice in license agreements for standard essential patents:⁵⁷⁰ (a) flat-rate licenses, (b) quota licenses, and (c) unit licenses. ⁵⁷⁰ In addition also Haedicke/Timmann, § 4, Rz. 116.

⁵⁷¹ Flat-rate licenses are monetary amounts fixed in advance for a certain period of use; they are generally⁵⁷² independent of production or sales figures. To⁵⁷³ this end, the parties to the contract shall draw up a forecast at the time the contract is concluded of the expected production or sales figures during the period of use and shall determine a total license amount for the period of use that is appropriate from their ex ante point of view. The licensor, however, bears the risk that his invention will be undercompensated if the licensee sells more products during the period of use than the parties had forecast at the time the contract was concluded. The⁵⁷⁴ licensee, on the other hand, bears the risk of overcompensating the licensor, which happens when he (the licensee) sells fewer products than forecast during the period of use. If the flat-rate license is fixed in advance and does not contain a variable component, it is part of the licensee's fixed costs.⁵⁷⁵ ⁵⁷¹ Large/drink, Rz. 6 ff. m.w.N.⁵⁷² Flat-rate payments can basically also be staggered or provided with surcharges/bonuses in order to provide for a certain degree of flexibility.⁵⁷³ See Kilger, p. 383.⁵⁷⁴ The limit lies, of course, in § 313 BGB; in the event of a fundamental error on the part of both contracting parties, a claim for adjustment of the contract due to changed circumstances may be considered—at least under German law—if the forecast quota is exceeded to a significant extent.⁵⁷⁵ See Kilger, p. 383.

Unlike the flat-rate license, the quota license⁵⁷⁶ links as precisely as possible to a royalty base multiplied by the applicable royalty rate. With this billing method, the transaction costs are higher than with a flat-rate unit license, since the license fee basis must actually be determined and traced in each case. In the absence of a flat rate, the quota license fee accurately reflects the number and value of manufacturing and distribution activities during the useful life. The quota license is not billed from an ex ante point of view, but is determined retrospectively at regular intervals. It is a proportional cost item in the corporate balance sheet.⁵⁷⁷ ⁵⁷⁶ Large/drink, Rz. 11 ff. m.w.N.⁵⁷⁷ See Kilger, p. 383.

The licensor bears the risk that his invention will be undercompensated if the licensee sells licensed products at an unreasonable (dumping) price. The⁵⁷⁸ licensee, on the other hand, bears the risk of overcompensating the licensor if the percentage license siphons off other value-creating aspects embodied in the product but not related to the patent-protected standardised technology.⁵⁷⁹ A variant of the quota license therefore provides that fixed minimum and maximum unit licenses (so-called caps and floors) are to⁵⁸⁰ be agreed in addition to the quota license fee. This ensures that ‘where the selling price of the licensed product is unreasonably low, the licensor is not underpaid by participating in a [ . . . ] added value which has nothing to do with the technology he provides’.⁵⁸¹ The downward cap is based on the purchase price “which covers costs and bears at least minimal profit expectations”.⁵⁸² This mixed solution therefore refers to three different benchmarks ‘which are usefully based on the license amounts resulting from an average or normal selling price of the licensed product’.⁵⁸³ ⁵⁷⁸ On the subject of dumping prices as a reference, see Kühnen, Chapter E, paragraph 472 and Kühnen, GRUR 2019, 665, [670].⁵⁷⁹ For example, the intrinsic value of the brand, aspects of product design that are remote from technology, or technical functionalities outside the standard at the implementation level.⁵⁸⁰ Cf. in particular United States District Court Central District of California, Resolution of 8 Nov. 2018, SACV14-00341 JVS (DFMx), pp. 55, 62 and 68 et seq.; EWHC, Resolution of 5 Apr. 2017, ref. no. [2017], mentioned in paragraph 5 but not relevant to the decision.⁵⁸¹ Kühnen, Chap. E, Rz. 473.⁵⁸² Kühnen, Chap. E, Rz. 472.⁵⁸³ Kühnen, Chap. E, Rz. 473.

⁵⁸⁴ The unit license is in principle also a variant of the quota license, but with the difference that it directly fixes a (inevitably flat-rate) amount of money for each product or product category. Consequently, the royalty base as the reference value for the license is not determined on a case-by-case basis but on a flat-rate basis. Unit licenses are calculated by multiplying the number of units produced/sold by the unit license fee rate per unit. The three license fee billing models presented here are all used in practice, including FRAND licensing. Thus, none of the accounting modalities per se is “not FRAND”. ⁵⁸⁴ Large/drink, Rz. 14 m.w.N.

A particularly accurate—and from a substantive law point of view fair—settlement model is likely to be the percentage quota license with caps and floors, as the reference value is determined for each specific individual case and at the same time it is ensured that the SEP holder is neither overcompensated nor undercompensated.

However, the declared aim of this work is not to create a particularly fair valuation mechanism, but to find the right balance between material justice (FRAND) and the transaction costs that burden the license fee. The lowest transaction costs are triggered by the flat-rate license. As a matter of principle, it is settled with its conclusion and the payment of the agreed lump sum for the period of use. However, the flat-rate license also shows the greatest practical uncertainty in the determination of the individual license fee. There is a risk that the licensor may be massively overcompensated or undercompensated.⁵⁸⁵ ⁵⁸⁵ For example, in the practical example described in § 12, the Düsseldorf Higher Regional Court found that Haier had been discriminated against to a very considerable extent in relation to licensee X5, who had been granted a flat-rate license, § 12, Section III.3.

This will be illustrated by a calculation example in the following: At the time of the conclusion of the contract on a flat-rate license, the parties assume that the licensee will sell 1,000 terminals subject to license during the period of use. They therefore agree on a lump sum payment of EUR 2,000. According to the will of the contracting parties, a unit license fee of EUR 2.00 (=EUR 2,000.00:1,000 terminals) should therefore be charged for each terminal. However, if the licensee actually sells 1,500 terminal devices during the usage period, he effectively pays only EUR 1.33 per terminal device (=EUR 2,000:1,500 terminal devices). If he only sells 400 terminals, he effectively pays EUR 5.00 per terminal (=EUR 2,000.00:400 terminals).

Depending on the accuracy of the contracting parties' forecasts at the time the contract is concluded and the market development during the period of use, the effective license fee can therefore vary considerably. This uncertainty about the price of the license has so far been accepted by the contracting parties in order to save transaction costs and create legal certainty for their economic activities. The costs are clearly defined and are accounted for as fixed costs.

Between the overly complex percentage quota license and the overly simplified flat-rate license, the unit license offers a middle way for a flexible evaluation and licensing concept, which can also be presented well in practice. The fact that unit licenses can in principle be FRAND is recognised in case law⁵⁸⁶. They significantly reduce transaction costs by flattening the reference value but not the license volume. The⁵⁸⁷ flat-rate nature of the royalty as a certain amount of money decouples the amount of the royalty from the selling price of the specific item placed on the market and instead reflects an average value agreed between the parties to the license. ⁵⁸⁶ Cf. to unit license offers LG Düsseldorf, Urt. v. 31 Mar. 2016, 4a O 73/14, no. 280=BeckRS 2016, 131580—Pitch analysis device (unit license: 0.26 USD); judgment of 9 Nov. 2018, 4a O 16/17, no. 391 et seq.; United States District Court Eastern District of Texas, decision of 23 May 2019, 6:18-CV-00243-JRG (including unit license: USD 2.50); a.A. Kurtz/Straub, GRUR 2018, 136 [138]; United States District Court Central District of California, Dec. of 8 Nov. 2018, SACV14-00341 JVS (DFMx), p. 68 ff.⁵⁸⁷ Haedicke/Timmann/Bukow, § 9, marginal 261 m.V.a. LG Düsseldorf, judgment of the court of first instance 11 Sep. 2008, 4b O 78/07, marginal 114=BeckRS 2009, 10890—Video signal coding III.

The unit license makes it easy to calculate and track the license fees owed. At the same time, they remain more accurate than flat-rate licenses, as the license volume will continue to be tracked concretely. Until the information technology systems have been integrated and matured to such an extent that they can determine a percentage quota license quickly and at low transaction costs, the calculation mechanism proposed in this paper should therefore not be linked to the specific reference figure for each individual case, but should be based as a unit license on a uniform license fee basis for all comparable standard-compliant end products.

Section 21, Section IV of this paper deals with how this uniform license fee basis could be determined and established in practice. Once the reference value of the license and its accounting method have been determined, the question arises as to the choice of the valuation approach to be applied. It is only through the valuation approach that the actual value of a patent portfolio is determined, linked to the reference value and the settlement mode, and thus converted into a certain amount of money for patent rights usage actions.

In practice, two fundamentally different evaluation approaches are discussed: the so-called bottom-up approach and the so-called top-down approach.⁵⁸⁸ As their names already indicate, the valuation approaches differ primarily in terms of the total number of standard essential patents. Justice Birss has described the so-called top-down approach⁵⁸⁹ in Unwired Planet v Huawei as follows: ⁵⁸⁸ Picht, GRUR Int 2017, 569 [572]; Contreras, FRAND Rate Setting, p. 9 ff.⁵⁸⁹ Vgl. auch United States District Court Central District of California, Entsch. v. 8 Nov. 2018, SACV14-00341 JVS (DFMx), S. 3.
“One approach (referred to as “top down”) starts with a number representing what the appropriate total aggregate royalty burden should be for a given standard (call it T). [ . . . ]. Starting from this figure T one can then share out the royalty across all licensors in proportion to the value of each licensor's patent portfolio based on assessing that value as a share (call it S) of the total relevant patent portfolio essential to that standard. The FRAND rate is the product of the two (TxS)”.⁵⁹⁰ ⁵⁹⁰ EWHC, Resolution v. 5 Apr. 2017, Az. [2017] EWHC 711 (Pat), para. 178; see also United States District Court Central District of California, Resolution v. 8 Nov. 2018, SACV14-00341 JVS (DFMx), p. 14 f.

According to the top-down approach, the maximum license burden is first determined for the entire standard (T)⁵⁹¹ and then distributed on a value basis among the patent portfolios (S) essential for the standard (TxS). The perspective of the evaluation is based on the entire standard. The value component of a portfolio (referred to by Justice Birss as S) can be expressed either as a percentage or as an amount of money. At this valuation level, the way in which the share S is determined and mapped in concrete terms is not initially decisive. ⁵⁹¹ See also EWHC, Entsch. v. 5 Apr. 2017, Az. [2017] EWHC 711 (Pat), Rz. 263.

The top-down approach was applied⁵⁹² in practice, except in the aforementioned Judge Selna decision in TCL v Ericsson,⁵⁹³ for example in a case between Apple and Samsung before the Japanese Higher Intellectual Property Court⁵⁹⁴ and in a case between Huawei and Samsung before the Chinese Shenzhen Middle People's Court. Justice Birss proposed to use the top-down approach as a cross-check for his evaluation concept.⁵⁹⁵ ⁵⁹² Middle People's Court Shenzhen, judgment of 4 Nov. 2018, Huawei v. Samsung (2016), Guangdong 03 Minchu No. 816 and 840.⁵⁹³ United States District Court Central District of California, Entsch. v. 8 Nov. 2018, SACV14-00341 JVS (DFMx).⁵⁹⁴ Higher Court for Intellectual Property, Entsch. v. 16 May 2014=GRUR Int. 2015, 142—Apple v. Samsung I.⁵⁹⁵ EWHC, Resolution v. 5 Apr. 2017, Az. [2017] EWHC 711 (Pat), Rz. 806, Par. (10).

In patent infringement disputes, the top-down approach is particularly criticised for approaching the value of patents via quantitative aspects rather than via the quality of the patents offered for licensing. Mallinson criticizes the top-down approach used by Judge Selna in TCL v Ericsson, which ultimately amounts to patent counting, even though the patents offered for licensing—let alone⁵⁹⁶ all patents declared essential to the standard—would not be checked for being essential and legally valid.⁵⁹⁷ While the portfolio patents declared as essential by the plaintiff—e.g. on the basis of claim charts—would be examined summarily for their legal validity and their essentiality, the other patents declared as essential for the standard by other holders would be included in the overall view of the standard shares without any examination.⁵⁹⁸ ⁵⁹⁶ Mallinson, p. 16.⁵⁹⁷ Mallinson, p. 2.⁵⁹⁸ Mallinson, p. 16.

In TCL v Ericsson, Ericsson also criticized that a top-down approach based on an ex ante approach was inappropriate because it did not take into account later versions (releases) of the standard that could contain additional valuable functionality.⁵⁹⁹ ⁵⁹⁹ Vgl. auch United States District Court Central District of California, Entsch. v. 8 Nov. 2018, SACV14-00341 JVS (DFMx), S. 19.

The counter-proposal to the top-down approach is a so-called bottom-up approach, which does not focus on the standard as a whole, but reflects the appreciation of the portfolio by the license price actually called up on the market via comparative licenses⁶⁰⁰. The valuation approach therefore results in a relative valuation of the portfolio strength, which is carried out in practice during the license negotiations. This is⁶⁰¹ because comparative licenses, which are obtained from the totality of the licenses actually concluded for a comparable situation⁶⁰², are the result of real negotiations and thus the best data source on the market.⁶⁰³ ⁶⁰⁰ EWHC, Resolution v. 5 Apr. 2017, Az. [2017] EWHC 711 (Pat), Rz. 179.⁶⁰¹ EWHC, Resolution v. 5 Apr. 2017, Az. [2017] EWHC 711 (Pat), Rz. 181.⁶⁰² Cf. OLG Düsseldorf, judgment v. 22 Mar. 2019, I-2 U 31/16, Rz. 233=GRUR 2019, 725—Improving Handovers.⁶⁰³ Mallinson, S. 2 m.V.a. u.a. United States Court of Appeals, Federal Circuit, Entsch. v. 30 Aug. 2012, 694 F.3d 51 (Fed. Cir. 2012)—Laserdynamics, Inc. v Quanta Computer, Inc., S. 79: “Actual licenses to the patented technology are highly probative as to what constitutes a reasonable royalty for those patent rights because such actual licenses most clearly reflect the economic value of the patented technology in the marketplace”.

However, this supposed strength of the concept also offers the greatest surface for criticism. Kühnen notes that the ‘contracts taken into account [ . . . ] should not have come about through abuse of market power (e.g. tying transactions)’, since ‘contract contents disapproved by the law cannot form a basis for equal treatment of others’.⁶⁰⁴ They are therefore not suitable as settlement agreements—even if they have only been concluded “possibly” in an abusive manner. The⁶⁰⁵ same applies, according to the case-law of the Düsseldorf Higher Regional Court, to license conditions brought about by the courts, since these contracts are not based on a free entrepreneurial decision by the contracting parties.⁶⁰⁶ ⁶⁰⁴ Kühnen, Chap. E, Rz. 427.⁶⁰⁵ Kühnen, Kap. E, Rz. 427 m.V.A. a.A. LG Düsseldorf, Urt. v. 31 Mar. 2016, 4a O 73/14, no. 287 ff.=BeckRS 2016, 131580.⁶⁰⁶ OLG Düsseldorf, Urt. v. 22 Mar. 2019, I-2 U 31/16, Rz. 415=GRUR 2019, 725—Improving Handovers.

Judge Selnapoints out that the great advantage of the top-down approach is that it prevents royalty stacking⁶⁰⁷. Royalty stacking is a phenomenon discussed in practice and is based on the consideration that the sum of the individual SEP licenses of all holders can cumulatively result in an amount that is above the maximum total burden of licenses for the relevant standard for the licensed subject matter.⁶⁰⁸ Since the bottom-up valuation approach through comparative licenses does not focus on the standard as a whole, there is no mechanism in practice to prevent royalty stacking. ⁶⁰⁷ Vgl. auch United States District Court Central District of California, Entsch. v. 8 Nov. 2018, SACV14-00341 JVS (DFMx), S. 15.⁶⁰⁸ Haedicke/Timmann/Bukow, § 9, marginal 266; United States District Court Central District of California, Resolution of 8 Nov. 2018, SACV14-00341 JVS (DFMx), p. 15; also Kellenter, FS 80 Years Patent Jurisdiction in Düsseldorf, p. 279 f.

Armstrong, Mueller and Syrett come to the conclusion in a comprehensive study of the “Smartphone Royalty Stack” that the license fee burden for smartphones with a non-proprietary operating system (Microsoft Windows Phone, Android, etc.) is likely to be in the range of around USD 121 to USD 124 on the basis of the scarce publicly available data alone.⁶⁰⁹ The amount shall be broken down as follows: It is controversial whether the danger of royalty stacking exists in practice at all.⁶¹⁰ Cohen criticizes Armstrong/Mueller/Syrett's report as an interest-driven campaign by large standard implementers⁶¹¹. In Federal Trade Commission v Qualcomm, Apple's COO Jeff Williams told Judge Koh that Apple was⁶¹² paying $7.50 to Qualcomm for 4G-enabled phones, more than all other licensors combined⁶¹³. Cohen concludes that Apple's 4G-enabled phones with a total price of USD 800 are charged with cumulative SEP licenses of less than USD 15, which is less than 1.88% of the sales price.⁶¹⁴ ⁶⁰⁹ Armstrong/Mueller/Syrett, p. 68; quoted by EU Competition Commissioner Vestager, Chillin' Competition Conference 2016.⁶¹⁰ Mallinson, p. 3 m.V.a. Galetovic/Haber, George Mason University 2016 and Galetovic/Gupta.⁶¹¹ Cohen, kidonip.com.⁶¹² United States District Court Northern District of California, Entsch. v. 21 May 2019, 17-CV-00220-LHK, S. 85.⁶¹³ United States District Court Northern District of California, Entsch. v. 21 May 2019, 17-CV-00220-LHK, S. 174.⁶¹⁴ Cohen, kidonip.com.

Justice Birsspoints out, irrespective of the choice of valuation approach and the problem of royalty stacking, that in principle every patent offered for licensing should be valued according to the value of the invention claimed in the patent for standardization. With increasing portfolio size, however, this is no longer possible.⁶¹⁵ Kühnen also notes that it is difficult to achieve material justice with simultaneous rapid justiciability for an object of regulation that is “extraordinarily complex” because of the immense quantitative burden of patents on the standard.⁶¹⁶ Judge Selna notes in TCL v Ericsson's introduction: “The search for precision and absolute certainty is a doomed undertaking”.⁶¹⁷ Mallinson adds, agreeing in his discussion of the decision, that no methodology can quiet this down in the calculation of a FRAND license fee.⁶¹⁸ ⁶¹⁵ EWHC, Resolution v. 5 Apr. 2017, Az. [2017] EWHC 711 (Pat), Rz. 181.⁶¹⁶ Kühnen, Chap. E, Rz. 421 f.⁶¹⁷ United States District Court Central District of California, Entsch. v. 8 Nov. 2018, SACV14-00341 JVS (DFMx), S. 14.⁶¹⁸ Mallinson, p. 2.

This contrasts two fundamentally imperfect valuation approaches. However, they do not necessarily have to rival each other, but should ideally arrive at the same result. For this reason, Judge Selna in TCL v Ericsson used the comparative license approach as a cross-check for his top-down rating,⁶¹⁹ while Justice Birss in Unwired Planet v Huawei used the top-down approach as a cross-check for his comparative license rating⁶²⁰. Mallinson also acknowledges that a top-down approach would in principle pay royalties corresponding to the comparative license approach if the deficits he identified in Judge Selna's valuation approach in TCL v Ericsson were taken into account and resolved.⁶²¹ ⁶¹⁹ United States District Court Central District of California, Entsch. v. 8 Nov. 2018, SACV14-00341 JVS (DFMx), S.54.⁶²⁰ EWHC, Entsch. v. 5 Apr. 2017, Az. [2017] EWHC 711 (Pat), Rz. 263 and 268.⁶²¹ Mallinson, p. 4.

Such deficits are—as described above⁶²²—rooted in the portfolio valuation proposed by Judge Selna. They are expressed, for example, in the fact that a different yardstick is used for the assessment of the legal status and essentiality of the patents to be licensed, that later releases of the standard were not taken into account and that the same value was assigned to each SEP by the linear calculation of the license fee.⁶²³ ⁶²² See § 21 Section III.4.a).⁶²³ Mallinson, p. 16.

This central point of criticism is to be taken up and resolved. By using exponential IT analysis methods—such as artificial intelligence—all patents declared essential for a standard can be tested for their actual legal validity, their actual standard essentiality and thus for their actual value. This concept enables a “holistic” and continuous, value-based top-down view with moderate to low transaction costs. Comparative licenses can—especially in the initial phase of a valuation system operating in this way—be used in addition to checking the license fees calculated by the valuation algorithm in individual cases. Since there is a risk that the FRAND corridor, which is formed from the totality of comparable licenses according to the comparative license principle, will be⁶²⁴ omitted in a top-down evaluation, the quality concept behind this concept should also be taken into account elsewhere.⁶²⁵ ⁶²⁴ See in detail § 10 Section II.⁶²⁵ See also § 21 Section VII.

If the calculation mechanism proposed in this paper is not to be linked to the specific reference figure for each individual case, but is to be based as a unit license on a uniform royalty basis for all comparable standard-compliant end products, the⁶²⁶ question arises as to how the uniform royalty basis is to be determined and by whom. ⁶²⁶ See above § 21 Section III.3.c).

Kurtz and Straub point out, for example, that the retail price for smartphones can be between EUR 50 and EUR 1,150.⁶²⁷ If “all manufacturers/distributors of smartphones demanded a unit license based on what might still be appropriate for the iPhone X”, then “the burden of patent licenses on a smartphone would quickly amount to several hundred euros, so that cheaper smartphones could no longer legally exist”.⁶²⁸ These dangers of overcompensation—⁶²⁹ by including non-technology-relevant pricing factors in the complex reference figure—or of undercompensation of the value of the technology are taken into account in practical reality by “caps” and “floors”.⁶³⁰ ⁶²⁷ Kurtz/Straub, GRUR 2018, 136 [138].⁶²⁸ Kurtz/Straub, GRUR 2018, 136 [138].⁶²⁹ United States Court of Appeals, Federal Circuit, Entsch. v. 30 Aug. 2012, 694 F.3d 51 (Fed. Cir. 2012)—Laserdynamics, Inc. v Quanta Computer, Inc., S. 52: “Where small elements of multi-component products are accused of infringement, calculating a royalty on the entire product carries a considerable risk that the patentee will be improperly compensated for non-infringing components of that product”.⁶³⁰ See also § 21 Section III.2.b).

A uniform average royalty basis should therefore be provided as a reference for all FRAND licenses for an asset with a particular quality or within a particular product or service category. This license fee basis is fictitious because it is based on a mixed calculation and is universally applicable—e.g. uniform license fee basis for a 3G multimode smartphone: 300 EUR or for a luxury car with 3G multimode functionality: 50,000 EUR.⁶³¹ ⁶³¹ For the (causal) share of 3G technology in the respective license fee base, see Section 21, Section VI.

The agreement of different royalties for different fields of application of the same standardised technology on the basis of different royalty bases is generally permissible. This is because the license fee is intended to ensure that the SEP holder “receives an appropriate share of those revenues which the licensee is likely to realize with the inventions made available for use”.⁶³² ⁶³² Bold, GRUR 2019, 665 [672].

In order for the applicable license fee basis to be determined for a particular licensing issue, this value must be stored and updated in a database.⁶³³ ⁶³³ Collections of reference values for patent licenses are not unusual in practice, cf. Hellebrand/Rabe. In methodological terms, however, the database would be based purely on the so-called “Schwacke” list of values from automotive tort law and provide for flat-rate values for certain product categories.

The establishment of a uniform license fee basis for certain product and service categories is a precarious regulatory decision that requires both diplomatic sensitivity and in-depth knowledge of the industry. Uniform royalty base values should therefore be determined by a body that is respected in the market, which—like the SEP Expert Group of the European Commission—consists of service providers from the areas of antitrust supervision, industry and science. The standardisation organisations should also be involved as important knowledge carriers. The task of the panel is to⁶³⁴ develop reference values and to update them regularly in the database. ⁶³⁴ Picht assigns this task to an “agency”, but sees it confronted with similar challenges, cf. Picht, GRUR 2019, 1097 [1103].

The panel will be immediately confronted with the challenge that the customary market royalty basis can vary territorially, i.e. regionally or country-specifically.⁶³⁵ In TCL v Ericsson, for example, Judge Selna defined three zones with different license rates.⁶³⁶ As with the territorial scope of a FRAND license, at least two approaches with different levels of detail can be envisaged: ⁶³⁵ See Section 11.2 of Section 21 for more information.⁶³⁶ United States District Court Central District of California, Entsch. v. 8 Nov. 2018, SACV14-00341 JVS (DFMx), S. 17, 46 ff. und 114.
The average selling price could be a royalty basis linked to the price development in a given territory during a given period (e.g. 4G multimode smartphone, Africa, 5 years from 2020). This allows regional peculiarities to be taken into account and ensures that only lower license fees can be realised in less profitable regions of the world. In addition, an administrative mechanism as proposed in Section II1.c) of Section 21, which links the automated payment of annual fees for a country to license income in that country, could see the threshold of profitability exceeded earlier because of the lower license fees. If the mechanism allows patent protection to expire, technology in emerging countries will sooner become public domain—which can promote the activity of SMEs and technology start-ups in these regions.
Alternatively, the average selling price could (at least initially) reflect a global average. The territorial extension could then be taken into account elsewhere via an evaluation factor. Because in times of globalization, value-added and sales chains extend worldwide. If each patent user owes the license fee, calculated according to the final sales price of the end product,⁶³⁷ a regional license fee would not effectively relieve the patent user. In any case, he would have to pay the license fee for distribution in another region if he wanted to exempt his preliminary product from industrial property rights. Regional license fees are therefore only of interest to companies with limited regional economic activities.⁶³⁸ ⁶³⁷ Kühnen, GRUR 2019, 665 [672], more details in § 23.⁶³⁸ Sog. “local kings”, vgl. United States District Court Central District of California, Entsch. v. 8 Nov. 2018, SACV14-00341 JVS (DFMx), S. 58 f.

Linking regional rates with redress mechanisms within a distribution chain to ensure that the SEP holder receives a remuneration commensurate with the inventive value is a highly complex undertaking. The determination and updating of a comprehensive list of values for product and service groups is also relatively time-consuming in itself. If, per category, additional regional subcategories are to be provided which make the global calculation mechanism much more difficult, there is a risk of over-regulation which may result in the failure of practical feasibility. The transaction costs incurred as a result cannot currently be reduced to an appropriate level.

For these reasons, averaged global rates should first be used. In the exemplary calculation methodology presented in § 22, the average global terminal price is represented as the value “_{VDGW}”.

The net retail price will have to be used to determine the global royalty base, as wholesale prices would not require remuneration of the margin of the final distributor. Which currency should be chosen for the expression of the rate depends on the volatility of the price development; if necessary, a value protection mechanism should be provided.

It should be pointed out at this point that the problem of the pricing of variably applicable intermediate products can arise if the license fee, according to Kühnen⁶³⁹, regularly refers to the end product as the relevant reference value and the license fee is estimated irrespective of the exploitation stage. This is because the manufacturer of an input product that can be used in various ways (e.g. a baseband processor) can pay the full license fee in principle, but is not necessarily aware of its ultimate purpose.⁶⁴⁰ ⁶³⁹ See also § 21 Section IIcI.).⁶⁴⁰ Kühnen, GRUR 2019, 665 [672], more details in § 23.

Once the value of the reference value has been determined, the maximum license charge for standard bound IP rights must be determined⁶⁴¹. According to Kühnen, it depends on the technological weight of the product and is “typically ⅓ of the turnover”.⁶⁴² Only those standards which are absolutely necessary for market access, i.e. the competitiveness of the equipment, are likely to be relevant for the overall burden. ⁶⁴¹ Sidak, The Criterion, 2016 (Vol. 1) P. 701 ff.⁶⁴² Kühnen, Chapter E, paragraph 422; net sales from the retail business are probably meant, see above. § 21 Section IV.

In practice, this value should therefore also be determined and updated⁶⁴³ by a specialist committee respected by the market. Justice Birss points out in Unwired Planet v Huawei that there are various public statements by companies⁶⁴⁴ on this, such as the “total royalty burden for all the intellectual property relating to the standardised telecommunications technology in a handset”.⁶⁴⁵ It applies the “total royalty stack” as a cross-check for its result found through settlement licenses.⁶⁴⁶ In fact, license agreements concluded in the past can point to an industry practice for the evaluation of the total burden share. These findings must be taken into account when determining the total exposure share, as they are indicative of the appreciation of the technology on the market. ⁶⁴³ Described in § 21 Section IV.⁶⁴⁴ EWHC, Resolution v. 5 Apr. 2017, Az. [2017] EWHC 711 (Pat), Rz. 264 ff.⁶⁴⁵ EWHC, Resolution v. 5 Apr. 2017, Az. [2017] EWHC 711 (Pat), Rz. 178.⁶⁴⁶ EWHC, Resolution v. 5 Apr. 2017, Az. [2017] EWHC 711 (Pat), Rz. 475 ff.

At this level at the latest, it is clear that dealing with a global base royalty value is complex enough. This effort would multiply with regional values. In the exemplary calculation method presented in § 22, the total load of the average terminal device value is shown as the total load share factor “a”, the value of the total load share as “VGLB”.

Finally, it has to be examined what share the technical standard, for which the patents to be licensed are essential, has in the total load share—and thus indirectly in the end device price. This is the value in which the licensed SEP ultimately participates under⁶⁴⁷ the top-down approach. The significance of the “technical functionalities provided by the individual standards for the successful sale of an end product in the downstream product market in relation to each other” will also be decisive for this.⁶⁴⁸ ⁶⁴⁷ See § 21 Section III.4.⁶⁴⁸ Bold, GRUR 2019, 665 [672].

In practice, this value should also be determined and updated by a panel of experts respected on the market, and comparative licenses can also be significant for the determination of this absolute standard license, i.e. the cumulative value of all patents essential for a certain standard.⁶⁴⁹ ⁶⁴⁹ See also § 21 Section IV and § 21 Section V.

The share of the standard in the value of the total pollution share is shown as standard share factor “b” in the exemplary calculation method presented in § 22, the value of the absolute standard license is expressed as “V_{[STANDARD]-All}”.

It is internationally accepted that FRAND is not a concrete royalty, but that the FRAND terms form a corridor within which the holder of essential patents can grant licenses.⁶⁵⁰ In § 10II.3 it was explained that the corridor is basically a result of negotiations which is fed by the totality of comparable license agreements. ⁶⁵⁰ See also § 10 Section II.

This approach could be fruitful for a top-down approach to create incentives for SEP holders to invest in quality rather than quantity. Because a purely patent-related value means that the combined performance result of the standard is not taken into account in the valuation. Since it is extremely difficult to measure the added value the standard creates compared to alternatives or predecessor technologies (e.g. faster random access, lower latencies, larger transmission capacities, etc.), more valuable patent portfolios should receive a higher share of the absolute standard license “V_{[STANDARD]-All}”. If the SEP holder can access additional financial resources through higher average quality, he will have an entrepreneurial incentive for R&D activities and contributions to standardisation processes. In this way, the phenomenon of deliberate over-declaration for negotiation purposes (leverage) can be reduced. A smaller total number of high-quality patents also reduces the examination effort and in turn has a positive effect on the transaction cost burden.

To this end, the thesis is to be put forward that the assessment factor “a” presented above, which assesses the technological weight of the terminal device,⁶⁵¹ also reflects the scope for negotiation that the SEP holder could realize in actual contract negotiations on the market on the basis of qualitative aspects. The negotiating skills of the parties also play a role in contract negotiations. However, the basis for concessions made by the license seeker is probably primarily the quality of the patent. In the case of products with a particular affinity for technology—i.e. products with a high overall load factor of “a”—a considerable proportion of the value of the device lies in the technology focus. It can therefore be assumed that in these cases more valuable patents would bring more negotiating power, i.e. the FRAND corridor would be proportionately larger than for a product with a low technology burden. ⁶⁵¹ Total load share of average terminal equipment value, see Section 21, Section V.

Should the practical implementation of the thesis prove to be unstable or unilaterally favourable, the corridor share should be decoupled from the total pollution share factor “a” and replaced by an independent corridor share factor in order to refine the calculation system. The proportional value of the standard “V_{[STANDARD]-All}” in the device value is thus to be divided into two parts for which different valuation approaches can be used⁶⁵²: a basic value and a corridor value. ⁶⁵² See § 22.

In the exemplary calculation method presented in Section 22, the base unit value is expressed as ‘V_{[STANDARD]-GA}’ and the corridor unit value as ‘V_{[STANDARD]-KA}’. The value of a SEP (VSEP) is therefore divided into the values Share of the underlying value (SEP-VGA) and a share of the corridor value (SEP-VKA) calculated on the basis of portfolio membership. I.e., the value of a SEP (VSEP) is SEP-VGA+SEP-VKA.

After the preliminary work described in § 19 has been completed and the basic questions in § 21 have been answered, the factors determined can be used for the following exemplary calculation methodology: The Absolute Standard License is the share of V_{[STANDARD]-All} in the total burden VGLB and thus represents the value share of all patents reported as essential for a certain technical standard (S_{[STANDARD]-All}) in the average terminal equipment value _{VDGW} at a certain valuation date. The Absolute Standard License V_{[STANDARD]-All} is distributed among the patents contained in the sum S_{[STANDARD]-All}.

The first step is to determine the total license charge (VGLB), expressed in one currency, that can be assigned to an average terminal device. For this purpose, the average terminal equipment value (_{VDGW}) determined in § 21IV. is multiplied by the total pollution share factor a determined in § 21V., a value between 0 and 1:

ø Endgeritewert×Gesamtbelastungsanteit (0-1)=Gesamtlienzbelastung

V_{DGW}×a=V_{GLB}

The total license burden (VGLB) is the total economic burden of the average terminal with licenses for essential patents.

In a second step, the value ratios of the technical standards contained in the total license burden (VGLB) must be clarified. For this purpose, each standard contains the standard share factor determined in accordance with section 21, section VI. Multiply the Total License Expense Value (VGLB) determined after step 1 by a standard share factor b between 0 and 1 to obtain the Absolute Standard License Value (V_{[STANDARD]-All}) expressed in one currency:

Gesamtlizenzbelastung×Standardanteil (0-1)=Absolute Standardlizenz

V_{GLB}×b=(V_{[STANDARD]-All})

In a nutshell: _{VDGW}×a×b=V_{[STANDARD]-All}

The Absolute Standard License (V_{[STANDARD]-All}) is the total economic burden of the average terminal with licenses for essential patents belonging to a particular standard. The value V_{[STANDARD]-All} for the Absolute Standard License must then be divided into the base unit value V_{[STANDARD]-GA} and the corridor unit value V_{[STANDARD]-KA}. As explained in Section 21(VII), the value ratio of the corridor share (V_{[STANDARD]-KA}) is consequently determined by the importance of the licensed technology for the relevant reference value, as expressed by the total burden share factor a between 0 and 1:

Absolute Standardlizenz×Gesamtbelastungsanteil (0-1)=Korridoranteil

(V_{[STANDARD]-All})×a=V_{[STANDARD]-KA}

If the value of the corridor portion (V_{[STANDARD]-KA}) is subtracted from the value of the Absolute Standard License (V_{[STANDARD]-All}), the basic portion value (V_{[STANDARD]-GA}) is obtained:

Absolute Standardlizenz−Korridoranteil=Grundanteil

(V_{[STANDARD]-All)}−V_{[STANDARD]-KA}=V_{[STANDARD]-GA}

Thus, the value shares to be assigned are defined and calculable within the Absolute Standard License (V_{[STANDARD]-All}), expressed in one currency.

In order that the partial values V_{[STANDARD]-GA} and V_{[STANDARD]-KA} of the Absolute Standard License Value (V_{[STANDARD]-All}) can be divided and allocated pro rata to the portfolios of the various holders, the value of the portfolios for a standard must be determined according to the proposed calculation methodology partly at the level of the individual patents and partly at the level of the portfolio.

For the sake of better comprehensibility, the two levels will first be dealt with in general below. By linking the various databases into a global register database, as described in § 19 Section II.f, the valuation algorithm knows all patents declared to be essential. Each registered SEP is assigned to a specific holder by means of a membership stamp. Since patents are in practice held by different companies within a group, it should also be possible to combine individual portfolios to form a group portfolio. This facilitates portfolio management and in turn saves transaction costs.

The basic prerequisite for the relevance of an individual patent to valuation is that it is in effect at the time of the valuation snapshot⁶⁵³ and is declared as essential for a technical standard. ⁶⁵³ I.e. the timing of the changing portfolio, see above. § 21 Section II.1a).

The total number of patents assigned to a specific owner, in force and declared to be essential forms the latter's total portfolio at the time of valuation. The overall portfolio of an owner in turn consists of sub-portfolios for the individual technical standards. The proposed valuation approach addresses this level of sub-portfolios. The added value of the sub-portfolios results in the value of the total portfolio of an owner. Individual patents may be included in more than one sub-portfolio if they have (rightly) been declared essential for more than one standard.

The registered SEPs therefore have at least three attributes:
the territorial code of the SEP and its registration number ([TERR-CODE][REG-NUMBER]),
the standard membership of the SEP ([STANDARD]), depending on the technical standard for which an essentiality report was submitted, and
the current SEP holder ([OWNER]).

### #SEP=[TERR-CODE][REG-NUMBER][DEFAULT][OWNER]

### e.g. [EP][1222333][4G][NOKIA] or [US][1234567][4G][SONY]

It should already be noted at this point that at the level of the individual patent the determined and fixed legacy rank of the respective individual patent is recorded as an additional attribute.⁶⁵⁴ ⁶⁵⁴ See also § 22 Section III.2.b).

The valuation algorithm works on three valuation levels:
(1) If the algorithm selects all SEPs registered in the database of a specific holder, the total portfolio of the selected holder is calculated as the sum S_{[OWNER]-All} (e.g. S_{[HUAWEI]-All}). The value of the total portfolio is the value V_{[OWNER]-All}.
(2) If the algorithm adds a certain technical standard to the selection of the holder, the partial portfolio of the selected holder for this standard results as the sum S_{[OWNER][STANDARD]-All}. (e.g. S_{[HUAWEI][4G]-All}). The value of this sub-portfolio is the value V_{[OWNER][STANDARD]-All}. If the values of the sub-portfolios are added, this naturally results in the value of the total portfolio V_{[OWNER]-All} (e.g. V_{[HUAWEI]-All}=V_{[HUAWEI][4G]-All}+V_{[HUAWEI][3G]-All}+V_{[HUAWEI][2G]-All}+V_{[HUAWEI][WIFI]-All}+V_{[HUAWEI][NFC]-All}+ . . . ).
(3) If, on the other hand, the algorithm only selects a certain standard, the patents declared essential for this standard result as the sum S_{[STANDARD]-All} (e.g. S_{[4G]-All}) regardless of their owner.

The owner-independent valuation level of the individual patent is of fundamental importance in two respects. On the one hand, worthless patents are identified at this level and excluded from further evaluation. On the other hand, the individual patent valuation is decisive for the division of the basic share (V_{[STANDARD]-GA}).

At the owner-independent valuation level of the individual patents, the sum S_{[STANDARD]-All} is divided into the shares S_{[STANDARD]-Rel} and S_{[STANDARD]-Fail}. Decisive evaluation criteria are the essentiality and legal validity of the respective patent.

For this purpose, the individual patents are assigned ranking order values—the values SEP-ER and SEP-VR. The value ER expresses the essentiality rank, a value between 0 and 5. The value VR expresses the validity rank, also a value between 0 and 5.

All patents declared essential for the selected standard (S_{[standard]-All}) are subjected to this validity and essentiality test. The holistic view forms the basis for the applied top-down calculation approach. In contrast to contract negotiations, not only the SEP offered for license (usually only a selection of this SEP as a so-called “Proud List”) is checked against claim charts, but also all declared⁶⁵⁵ SEPs. It makes sense to use a valuation algorithm that either processes manually calculated values or—which is more obvious nowadays and causes less transaction costs—values determined by an AI-supported analysis. How this evaluation could be carried out in detail will not be discussed in this paper. ⁶⁵⁵ See in addition § 21 section III.4.d) and criticism of Mallinson.

However, a decisive criterion for the acceptance of the evaluation algorithm in practice is likely to be that decisions on legal status can also be fed in by specialist bodies, such as the European Patent Office (EPO) or the US Patent Trial and Appeal Board (PTAB). This should improve or worsen the SEP-VR legal standing of the patent affected by the decision.

A modified scope of protection also requires a new Essentiality Assessment (SEP-ER), as the patent in question may no longer read to the selected standard.

Essentiality assessments could be supplemented by the assessment of expert committees and courts on a sample basis in order to review and improve the assessment algorithm. The Japanese Patent Office (JPO), for example, offers essentiality opinions.⁶⁵⁶ ⁶⁵⁶ So-called “Hantei” (Advisory Opinion), cf. https://www.jpo.go.jp/e/support/general/sep_portal/index.html (downloaded on 27 Nov. 2019); cf. also reference in LG Mannheim, Urt. v. 27 Nov. 2015, ref. 14=BeckRS 2015, 20077—Stochastic noise, on the International Patent Evaluation Consortium (IPEC).

If a patent declared to a standardization organization as essential for a standard is granted, the evaluation algorithm checks the questions of essentiality and validity for each declared patent and assigns the values SEP-ER and SEP-VR to the respective patent. The value 5 is the highest achievable value. The value 0 means in the respective context that the examined patent is not standard essential or not legally valid.

The ranking values determined in this way are multiplied to a patent-specific ranking value (SEP-W1):

$$SEP \text{-} Essenzialit \ddot{a} tsrang \times SEP \text{-} Rechtsbestandrang = SEP \text{-} Rangfolgenwert$$

$$\begin{matrix}( 0 \text{-} 5 ) & & ( 0 \text{-} 5 ) \\ ( SEP \text{-} ER ) & \times & ( SEP \text{-} VR )\end{matrix} \begin{matrix} & ( 0 \text{-} 25 ) \\ = & SEP \text{-} {W}_{1}\end{matrix}$$

The patent specific ranking value (SEP-W1) is an indicator of how strong the evaluated patent is in relation to other patents declared essential for the selected standard. This ensures that not all patents filed for a standard are assigned the same value as a whole, but that all patents are examined and weighted according to a uniform standard.

As a result of the ranking evaluation it may turn out that a patent declared as essential is either obviously not essential (SEP-ER=0) or obviously not legally valid (SEP-VR=0). It then receives a multiplier with the value 0, which inevitably results in a ranking value (SEP-W1) of 0. The patent is worthless and must therefore in⁶⁵⁷ principle be excluded from the evaluation mechanism. All patents with a SEP-W1 of 0 form the share S_{[STANDARD]-Fail}. ⁶⁵⁷ The patent is still indirectly relevant for the calculation of the corridor share, cf. § 22 Section V.

For further evaluation, the total number of patents S_{[STANDARD]-All} declared essential for the relevant standard is adjusted by the size S_{[STANDARD]-Fail} to S_{[STANDARD]-Rel}:

S_{[STANDARD]-All}−S_{[STANDARD]-Fail}=S_{[STANDARD]-Rel}

Only the share of patents with an actual value (S_{[STANDARD]-Rel})—no matter how small (e.g. SEP-W1=1)—is taken into account for the allocation of the basic share (V_{[STANDARD]-GA}).⁶⁵⁸ ⁶⁵⁸ Justice Birss also prefers the term “relevant SEP” to the terms “truly essential patents” or “deemed essential patents”, cf. EWHC, Entsch. v. 5 Apr. 2017, Az. [2017] EWHC 711 (Pat), paragraph 186.

The patents contained in the S_{[STANDARD]-Fail} share shall be assigned the value 0 irrespective of their holder. It should already be pointed out at this point that this division may also have an effect on the owner-dependent valuation.⁶⁵⁹ This is indicated below by the use of the attributes (Rel), (Fail) and (All) of the respective calculation factors. ⁶⁵⁹ In particular, § 22 Section V thereof.

The fixed legacy rank is awarded to each individual patent as an additional evaluation attribute. It dogmatically follows the valuation concept of “standard contributions” and is based on the consideration that companies that are particularly active in the further development of standardization generally apply for patents with higher value⁶⁶⁰. According to German procedural law, this inner connection may constitute an actual presumption. It is assumed if “the presumed fact is based on a sentence of general life experience whose probability is so high that it permits a corresponding conclusion also in the concrete individual case”.⁶⁶¹ ⁶⁶⁰ Vary/Li/Yiu, twobirds.com.⁶⁶¹ Grunwald, GRUR 2016, 1126 m.V.a. Musielak, JA 2010, 561.

Since SEPs often prove to be unlawful⁶⁶² or non-essential in adversarial review, the Legacy Rank is intended to record the applicant's “DNA”. The rank forms a corrective for the evaluation by the algorithm (i.e. to the value SEP-W1). ⁶⁶² Cf. Ann, VPP Spring Symposium 2019, p. 6, refers to portfolio discounts of up to 80% due to latent patent invalidity.

The background for this valuation approach is that companies are increasingly filing patents and declaring them essential, even though they are hardly active in standardization or their contributions to standardization are not taken into account. A 2019 study by IPlytics⁶⁶³ on logon behavior for the 5G mobile communications standard illustrates this. For example, Samsung holds the largest number of patent families declared essential for 5G: Samsung holds nearly four times more essential patent families for 5G than Nokia (389.967%). ⁶⁶³ https://www.iam-media.com/who-leading-5g-patent-race (accessed 27 Nov. 2019).

The standardization contributions for 5G, on the other hand, show a completely different picture: Nokia is significantly more involved in the standardization of 5G than Samsung (168.455%). From this, it can be concluded either that:
Nokia's logon potential is unused and not as effective in width as Samsung's logins, or
Nokia concentrates its standardisation knowledge in fewer patent applications and therefore receives fewer but higher quality patents than Samsung.

The Shenzhen Middle People's Court follows the second alternative⁶⁶⁴. Also against the background of the problem of over-declaration,⁶⁶⁵ incentives for fewer but more valuable patent applications should be created rather than sanctions for allegedly cautious filing behaviour. Differences may arise, for example, precisely because one applicant applies for particularly many inventions for detailed improvements, while another applicant concentrates on pioneer inventions which concern and solve central problems in standardization. ⁶⁶⁴ Shenzhen Middle People's Court, dated 4 Nov. 2018, Huawei v. Samsung (2016), Guangdong 03 Minchu No. 816 and 840, Vary/Li/Yiu, twobirds.com.⁶⁶⁵ See § 3 Section IV.

According to the simplest variation of this valuation approach, standardisation contributions can be taken into account by considering the total number of standardisation contributions of an enterprise for an entire standard (absolute consideration) or for a specific period of standardisation (sequential consideration, e.g. annually) individually or relative to the contributions of other enterprises.

A more precise overview of the quality of the standardisation contributions can be obtained if only the standardisation contributions actually accepted by the standardisation body are taken into account (so-called approved contributions). Only by accepting the contribution does the teaching of the patent application concerning the contribution become a⁶⁶⁶ technical imperative, i.e. a standard essential. However, this additional condition should be applied with caution, as the assumption of a contribution to standardisation in practice is not necessarily based solely on technical considerations, but may also depend on the skill and influence of the participant in the standardisation process. ⁶⁶⁶ If the scope of protection actually covers the standardisation contribution.

If only the activity of a company in standardization is considered, however, no causal relationship is established between standardization contributions and patenting activity (“isolated” standard contributions approaches).

If the patenting activity is included in the evaluation, there are two possible starting points:
The number of SEP.
The number of SEP.

The closest qualitative link exists between (assumed) standardisation contributions and SEPs issued. However, despite the potential uncertainty arising from the fact that patent applications may be dropped for reasons other than lack of patentability during the examination procedure, the application figures are preferable to the grant figures. Because they are available immediately at the end of the year. The actual grant figures, on the other hand, are only available years later—partly after the peak of the standard implementation—and therefore only allow conclusions to be drawn for the past. They simply come too late for an efficient and fast calculation system.

The legacy rank should therefore be determined according to the valuation concept proposed here by linking logon numbers and standard contributions. For this purpose, a RankStandard_{Contributions} is created for each calendar year, which shows the annual Standard Contributions—determined by the standardization organizations (SSO)—in relation to patent applications declared as essential⁶⁶⁷. Depending on the placement of the SEP applicant in the application year, a legacy rank SEP-LR between 0-10 is already assigned to the patents in the application year. This value can no longer be changed subsequently and therefore continues to exist even if the SEP holder changes. ⁶⁶⁷ It is advisable to link the evaluation to the number of applications.

Section 22 (V.1(c)) explains how the SEP-LR value achieved is included in the distribution of the corridor share value V_{[STANDARD]-KA}.

The valuation level of the portfolio is used for the distribution of the corridor portion (V_{[STANDARD]-KA}). The calculation factors are all linked to the relative portfolio strength of the respective holders.

In the next step, the basic share (V_{[Standard]-GA}) of the Absolute Standard License (V_{[Standard]-All} determined in Section 22, Section II. is to be distributed over the total number of essential patents contained in the number S_{[Standard]-Rel}. The value thus determined for the respective patent is the relative basic value of this patent (SEP-VGA).

If the value V_{[standard]-GA} were simply divided by the number of patents contained in S_{[standard]-Rel}, a purely numerical valuation concept would result⁶⁶⁸—which would not do justice to the individual values of the patents (SEP-W1=1-25). ⁶⁶⁸ Vorgeschlagen etwa von Kurtz/Straub, GRUR 2018, 136 [139]; angewendet in Unwired Planet v Huawei, EWHC, Entsch. v. 5 Apr. 2017, Az. [2017] EWHC 711 (Pat), Rz. 377 und TCL v Ericsson, United States District Court Central District of California, Entsch. v. 8 Nov. 2018, SACV14-00341 JVS (DFMx), S. 16: “The Court adopts a simple patent counting system which treats every patent as possessing identical value [ . . . ]”.

The patents contained in S_{[standard]-Rel} are therefore to be sorted according to the respective individual values SEP-W1 and divided into rankings from RankW1 1 to RankW1 n. The patents are to be ranked according to the individual values SEP-W1. The result is a picture of the relative value ratios.

The value of RankW1 thus determines the proportional share of the individual patent in the standard basic share V_{[Standard]-GA}, its basic share value SEP-VGA.

If, for example, 1,250 patents are declared essential for a standard (S_{[Standard]-All}), only 1,000 of them reach the minimum score of essentiality and validity (i.e. SEP-W1; >1) and thus belong to the number of S_{[standard]-Rel}, i.e. S_{[Standard]-Rel}=1,000. These 1,000 individual patents can be awarded ranksW1 1 to 1,000, based on their values SEP-W1. Each patent would have a GA share (SEP-VGA) of 0.1% of the standard with linear calculation. If distributed according to the ranking, the patent with rankW1 1 would achieve a SEP VGA share of 0.19999%; the patent with rankW1 1000 would achieve a SEP VGA share of 0.0001%.

Patents belonging to the S_{[STANDARD]-Fail} group are assigned a SEP-VGA of 0.

If all individual patents have been assigned a specific base value, the SEP portfolio of a specific holder for that standard (S_{[OWNER][STANDARD]-All}) can also be assigned a specific base value (V-GA_{[OWNER][STANDARD]-All}). It s calculated as the sum of the SEP-VGA of all the SEPs in the portfolio.

In addition, the average value W1 of the portfolio patents contained in S_{[OWNER][STANDARD]-All} i determined and expressed as the value “Portfolio-W1” (a value between 1-25).⁶⁶⁹ ⁶⁶⁹ This value is important for the calculation of the corridor share value, cf. § 22 Section V.1.a).

The corridor share is an incentive to⁶⁷⁰ create patents that are as valuable as possible and to declare them essential in order to achieve the largest possible share of the corridor share V_{[STANDARD]-KA}. According to the comparative market concept, a patent holder with a stronger, i.e. valuable, portfolio can achieve higher royalties on the market. The corridor portion proposed in this paper therefore serves to promote competition within a standard and investment in the quality of portfolio patents. ⁶⁷⁰ For the background to the corridor portion, see § 21 Section VII.

In contrast to the share of an essential patent in the basic value (SEP-VGA, see § 22 Section IV.), the share of an essential patent in the corridor value (SEP-VKA) is therefore calculated on the basis of portfolio membership and thus on the relative portfolio strength of each holder (V_{[OWNER][STANDARD]-All}). This results in the immediate value V-KA_{[OWNER][STANDARD]-All}.

The value V-KA_{[OWNER][STANDARD]-All} can again—if desired—be allocated to the individual portfolio patents of the holder at the individual patent values SEP-VKA. Since the relative portfolio strength is fed by all valuable portfolio patents (S_{[OWNER][STANDARD]-Rel}), a linear⁶⁷¹ distribution of the value V-KA_{[OWNER][STANDARD]-All} to the patents contained in S_{[OWNER][STANDARD]-Rel} appears appropriate. The patents contained in S_{[OWNER][STANDARD]-Fail} are again disregarded in the value allocation. ⁶⁷¹ I.e. V-KA[OWNER][STANDARD]-All divided by the number of patents contained in S[OWNER][STANDARD]-Rel gives SEP-VKA.

In order to assign the corridor share value V_{[STANDARD]-KA} to the portfolios of the individual holders, each portfolio of a specific holder is assigned a specific portfolio score for a specific standard (i.e. S_{[OWNER][STANDARD]-All}), the score portfolio_{[OWNER][STANDARD]-KA}.

The score portfolio_{[OWNER][STANDARD]-KA} is in turn determined by certain valuation factors that are determined for the portfolio. Four valuation factors, the values Portfolio-W1 to Portfolio-W4, are proposed here as examples, which should have the following relationship to each other: The individual valuation factors are determined as follows: The value Portfolio-W1 follows on from the preparatory work of the algorithm for allocating the base unit value

Portfolio_{[OWNER][STANDARD]-KA} (2-120)=Portfolio-W1 (0-25)×Portfolio-W2 (1-4)]+Portfolio-W3 (0-10)+Portfolio-W4 (0-10)

(V_{[STANDARD]-GA}). There, an individual value SEP-W1 between 1 and 25 was assigned to each individual patent on the basis of the legal status and essentiality assessment. For⁶⁷² the value Portfolio-W1, the average value W1 of the portfolio patents contained in S_{[OWNER][STANDARD]-All} for a specific holder and a specific standard is calculated and also expressed as the (then average) value between 0 and 25.⁶⁷³ ⁶⁷² See § 22 Section IV.⁶⁷³ Portfolio-W1 [OWNER][STANDARD]=(SEP-W1 [OWNER]{STANDARD] 1+SEP-W1 [OWNER]{STANDARD] 2+ . . . +SEP-W1 [OWNER]{STANDARD] n) divided by the number of patents contained in S[OWNER][STANDARD]-All.

For the average value, conscious reference should not be made to the sum of the patents S_{[OWNER][STANDARD]-Rel} which retain their value, but to the sum of all patents declared to be essential. Because the share S_{[OWNER][STANDARD]-Fail} with the value W1=0 does not increase the counter when calculating the average, but the patent nevertheless appears in the denominator, the average value Portfolio-W1 decreases proportionately. This sanctions over-declaration and creates an incentive for SEP holders to invest in consistently high patent quality and in any case not to deliberately report patents as essential.

The value Portfolio-W2 is a multiplier between 1 and 4, through which the numerical size of the portfolio to be licensed is included in the valuation. This is necessary because smaller patent portfolios can more easily achieve a high average portfolio W1—which in turn would create an incentive to group the most valuable patents into highly valued micro-portfolios in order to participate as generously as possible in the corridor share value.

The Portfolio-W2 multiplier is intended to counteract such a strategic consideration from the outset. Large portfolios that nevertheless achieve a high portfolio value W1—because they achieve above-average quality with low/moderate over-declaration—are thus valued. If the portfolio owner transfers a large number of high-quality patents, for example to an NPE, he is threatened with the (at least proportionate) loss of his right to the corridor value share because his portfolio W1 and portfolio W2 values deteriorate. Even if he can realise higher royalties in individual cases through the use of an NPE, the economic impact on his own portfolio (loss of quality and thus value) is likely to erode this profit.

The value Portfolio-W2 should be a multiplier between 1 and 4, whereby the value 4 should be reserved for the licensors with the largest portfolios and also the multipliers 2 and 3 should not be assigned lightly. Finally, in individual cases this leverage can mean a drastic improvement of the score portfolio_{[OWNER] [STANDARD]-KA} and thus significantly increase the chance that the SEP holder concerned may participate in the corridor value share V_{[STANDARD]-KA}.

In the area of mobile communications, for example, this could apply (in relation to SEP issued, not families):

| | |
|---|---|
| Portfolio W2 = 1 | up to 1.000 SEP |
| Portfolio W2 = 2 | 1,000 to 3,000 SEP |
| Portfolio W2 = 3 | 3,000 to 6,000 SEP |
| Portfolio W2 = 4 | from 6.000 SEP |

The value Portfolio-W3 takes into account the origin of the portfolio patents and is based on their average legacy rank (SEP-LR). For⁶⁷⁴ the value Portfolio-W3, the average value SEP-LR between 0 and 10 is calculated for a certain holder and a certain standard⁶⁷⁵. This means that the sum of the portfolio patents contained in the portfolio (S_{[OWNER][STANDARD]-Rel}) can be assigned an (average) value between 0 and 10.⁶⁷⁶ ⁶⁷⁴ See Section III.2.b), section 22, fundamental.⁶⁷⁵ See also § 22 Section III.2.b)(3).⁶⁷⁶ Portfolio-W3 [OWNER][STANDARD]=(SEP-LR [OWNER][STANDARD] 1+SEP-W1 [OWNER][STANDARD] 2+ . . . +SEP-W1 [OWNER][STANDARD] n) divided by the number of patents contained in S[OWNER][STANDARD]-Rel.

In contrast to the value Portfolio-W1, the average value Portfolio-W3 should deliberately not refer to the sum of all patents S_{[OWNER][STANDARD]-All}, but only to the sum of all patents S_{[OWNER][STANDARD]-Rel}. This ensures that ineligible patents from the share S_{[OWNER][STANDARD]-Fail}, i.e. with a value W1 of 0, do not influence the average legacy rank SEP-LR when calculating the average. Otherwise, the average SEP-LR could be artificially influenced by non-legally binding and/or non-essential patents of companies active in standardisation, despite their worthlessness.

The value Portfolio-W4 takes into account the territorial extension of the SEP portfolio offered for licensing and is therefore comparable to the “regional strength ratio” mentioned by Judge Selna in TCL v Ericsson. The value Portfolio-W4 is a value between 0 and 10⁶⁷⁷ that territorially weights the portfolio patents contained in S_{[OWNER][STANDARD]-Rel} for a specific holder and standard. How the weighting can be carried out in detail should be worked out in coordination with the expert committee proposed in § 21IV. ⁶⁷⁷ See also § 22 Section III.2.b)(3).

Justice Birss proposes in Unwired Planet v Huawei for the differentiation of the “major markets” from the “other markets” for instance certain “thresholds”: “In my judgment a fair threshold for 2G or 3G would be 2 or more declared SEPs and for 4G would be 3 or more declared SEPs. Any country below the threshold would be OM [Other Market] for that standard.”⁶⁷⁸ The Via license pool, on the other hand, proceeds as follows⁶⁷⁹: 5,915 patent families in force are essential for the technical standards licensed by Via. Essential patent families without family members in the USA, Europe or after the PCT are eliminated for further calculation. Because only patent families with family members in these territories are “truly valuable”⁶⁸⁰ ⁶⁷⁸ EWHC, Resolution v. 5 Apr. 2017, Az. [2017] EWH C 711 (Pat), Rz. 587.⁶⁷⁹ Siino, iam Magazine, 2017, Vol. 84, p. 60.⁶⁸⁰ Siino, iam Magazine, 2017, Vol. 84, p. 60; according to this model, no evaluation zones are therefore formed, but in practice it should be easy to override them, e.g. by maintaining EP and US members or by always being able to bring further family members to the granting by so-called “sleeping divisionals”.

Once the valuation algorithm has determined the Portfolio-W1 to Portfolio-W4 valuation factors, it can calculate the Score Portfolio_{[OWNER][STANDARD]-KA} for each individual patent holder who is the holder of at least one essential patent to the rated standard according to the formula shown above.

Subsequently, the relative portfolio strength ratios for the standard are determined by the global comparison of the scores achieved Portfolio_{[OWNER][STANDARD]-KA} and reflected by the rank_{[STANDARD][OWNER]-KA}.

Only the portfolios with the highest rank_{[STANDARD][OWNER]-KA}, for example the five or ten best rated portfolios,⁶⁸¹ participate in the value V_{[STANDARD]-KA}. The value of the rank_{[STANDARD][OWNER]-KA} thus determines the proportional share of the individual portfolios in the value of V_{[STANDARD]-KA}, their concrete corridor value share (V-KA_{[OWNER][STANDARD]-All}). The dogmatic justification for this is that these portfolios would achieve a higher price in quality-based contract negotiations. For this reason, it must also be ensured that the Rank_{[STANDARD]-KA} does not only gain access to the corridor share value V_{[STANDARD]-KA} through a relative value ratio, but that the portfolio has exceeded an objective value limit, e.g. a score portfolio_{[OWNER][STANDARD]-KA} of more than 40. If the score portfolio_{[OWNER][STANDARD]-KA} is less than or equal to 40, there can be no question of a valuable portfolio. This means that access to the corridor share value V_{[STANDARD]-KA} has the cumulative prerequisite that a sufficiently high (relative) rank_{[STANDARD][OWNER]-KA} and at the same time a sufficiently high (absolute) score portfolio_{[OWNER][STANDARD]-KA} are achieved. ⁶⁸¹ I.e. Rank[STANDARD]-KA 1 to Rank[STANDARD]-KA 5 or 10.

Portfolios that do not meet these requirements only participate in the basic unit value V_{[STANDARD]-GA}. If, as a result, the corridor share value V_{[STANDARD]-KA} cannot be fully distributed among SEP holders, this should not result in the share of SEP holders whose portfolios have qualified for the corridor share value V_{[STANDARD]-KA} increasing automatically. This is because the corridor share value is basically intended to reward individual quality and would then possibly lead to (possibly random) overcompensation of individual SEP holders. If the corridor share value V_{[STANDARD]-KA} is not fully exhausted, the maximum license fee to be paid by the standard implementers decreases.

As outlined above, the value V-KA_{[OWNER][STANDARD]-All} can in principle be distributed linearly over the portfolio patents of the SEP holder of the S_{[OWNER][STANDARD]-Rel} category⁶⁸². From this the value SEP-VKA is calculated for these patents. The SEP-VKA of the patents contained in S_{[OWNER][STANDARD]-Fail} remains “0”—as is the case for patents whose holders have not qualified for the corridor value portion. The addition of the individual values SEP-VGA and SEP-VKA results in the value of the individual SEP (SEP-V) at the valuation point, expressed in one currency. ⁶⁸² I.e. V-KA[OWNER][STANDARD]-All divided by the number of patents contained in S[OWNER][STANDARD]-Rel gives SEP-VKA.

The added values V-GA_{[OWNER][STANDARD]-All} and V-KA_{[OWNER][STANDARD]-All} result in the total license for the SEP holder's portfolio for the verified standard at the Valuation Point, expressed in one currency—V_{[OWNER][STANDARD]-All}.

The functioning of the calculation methodology proposed here is illustrated below as an example for a portfolio license (V[Standard][Owner]-All) and a single SEP Y (SEP Y-V). The formulas are not represented in a specific programming language, but as chains of work steps.

For example, the value of a portfolio license (V[Standard][Owner]-All) could be calculated as follows.

select time interval (e.g. Q4 2014)

select [Owner]

select [default]

### Step 1: Calculation of the Basic Unit Value of the Portfolio V[Standard][Owner]-GA

determine V[default]-GA

determine V[default]-All

determine VGLB

determine VDGW; set VDGW
determine a; set a
calculate VDGW × a
set VGLB

determine b; set b
calculate VGLB × b
set V[default]-All

calculate V[default]-All − (V[default]-All × a)
set V[default]-GA

determine V[default][owner]-GA

determine SEP 1 [Standard]-VGA

determine SEP-W1

determine SEP-ER >= 0 <= 5
determine SEP-VR >= 0 <= 5
calculate SEP-ER × SEP-VR
set SEP-W1 >= 0 <= 25

if SEP-W1 = 0 set SEP-VGA = 0 and S[Standard]-Fail = TRUE
else set S[default]-Rel = TRUE
repeat for each SEP[Standard] until SEP n [Standard]

determine SEP 1 [Standard]-Rel-RankW1

repeat for each SEP[Standard]-Rel until SEP n [Standard]-Rel

calculate V[Standard]-GA × (S[Standard]-Rel − SEP 1 [Standard]-Rel-

| | |
|---|---|
| RankW1 + 1) : | {(S[default]-Rel × (S[default]-Rel + 1) : |

2}

set SEP 1 [Standard]-Rel-VGA

repeat for each SEP[Standard]-Rel until SEP n [Standard]-Rel

calculate SEP 1 [Standard][Owner]-VGA + [...] + SEP n
[Standard][Owner]-VGA
set V[default][owner]-GA

### Step 2: Calculation of the Corridor Share Value of the Portfolio V[Standard][Owner]-KA

determine V[Standard]-KA

calculate V[default]-All × a
set V[default]-KA

determine Portfolio[Standard][Owner]-KA

determine Portfolio-W1[Standard][Owner]

determine S-W1[default][owner]-All
calculate S-W1[default][owner]-All : S[default][owner]-All
set Portfolio-W1[default][owner] >= 0 and <=25

determine Portfolio-W2[Standard][Owner]

if (S[Standard][Owner]-Rel <= 1,000) set Portfolio-

W2[Standard][Owner] = 1

if (S[Standard][Owner]-Rel > 1,000 and <= 3,000) set Portfolio-

| | |
|---|---|
| W2[Standard] | [Owner] = 2 |

if (S[Standard][Owner]-Rel > 3,000 and <= 6,000) set Portfolio-

| | |
|---|---|
| W2[Standard] | [Owner] = 3 |

if (S[Standard][Owner]-Rel > 6,000) set Portfolio-

W2[Standard][Owner] = 4

determine Portfolio-W3[Standard][Owner]

determine S-LR[default][owner]-Rel
calculate S-LR[Standard][Owner]-Rel : S[Standard][Owner]-Rel
set Portfolio-W3 [default][owner] >= 0 and <= 10

determine Portfolio-W4[Standard] [Owner]

set Portfolio-W4[default][owner] >= 0 and <= 10

calculate Portfolio-W1[Standard][Owner] × Portfolio-
W2[Standard][Owner]) + Portfolio- W3[Standard][Owner] +
Portfolio-
W4[Standard][Owner]
set Portfolio[Standard][Owner]-KA >= 2 and <= 120

if Portfolio[Standard][Owner]-KA <= 40 set V-KA[Standard][Owner] = 0
else determine Rank[Standard][Owner]-KA
if Rank[Standard][Owner]-KA >= 6 set V-KA[Standard][Owner] = 0
else determine V-KA[default][owner]

calculate V[Standard]-KA × {(4 − Rank[Standard][Owner]-KA) : 15}
set V-KA[default][owner]

### Step 3: Calculating the Portfolio Value V[Standard][Owner]-All

determine V[default][owner]-All

calculate V[Standard][Owner]-GA + V[Standard][Owner]-KA
set V[default][owner]-All

```
For example, the value of a single SEP Y (SEP Y -V) could be calculated
as follows.
  select time interval (e.g. Q4 2014)
  select [Owner]
  select [default]
  select [SEP] Y
```

Step 1: Calculation of the Base Unit Value of SEP Y (SEP Y-VGA)

determine V[default]-GA

determine V[default]-All

determine VGLB

determine VDGW; set VDGW
determine a; set a
calculate VDGW × a
set VGLB

determine b; set b
calculate VGLB × b
set V[default]-All

calculate V[default]-All − (V[default]-All × a)
set V[default]-GA

determine V[default][owner]-GA
determine SEP 1 [Standard]-VGA

determine SEP-W1

determine SEP-ER >= 0 <= 5
determine SEP-VR >= 0 <= 5
calculate SEP-ER × SEP-VR
set SEP-W1 >= 0 <= 25

if SEP-W1 = 0 set SEP-VGA = 0 and S[Standard]-Fail = TRUE
else set S[default]-Rel = TRUE

repeat for each SEP[Standard] until SEP n [Standard]
determine SEP 1 [Standard]-Rel-RankW1
repeat for each SEP[Standard]-Rel until SEP n [Standard]-Rel

calculate V[Standard]-GA × (S[Standard]-Rel − SEP Y [Standard]-Rel-

| | |
|---|---|
| RankW1 + 1) : | {(S[default]-Rel × (S[default]-Rel + 1) : |

2}

set SEP Y [Standard]-Rel-VGA

### Step 2: Calculation of the Corridor Share Value of SEP Y (SEP Y-VKA)

determine V[Standard]-KA

calculate V[default]-All × a
set V[default]-KA

determine Portfolio[Standard][Owner]-KA

determine Portfolio-W1[Standard][Owner]

determine S-W1[default][owner]-All

calculate S-W1[default][owner]-All : S[default][owner]-All
set Portfolio-W1[default][owner] >= 0 and <=25

determine Portfolio-W2[Standard][Owner]

if (S[Standard][Owner]-Rel <= 1,000) set Portfolio-

W2[Standard][Owner] = 1

if (S[Standard][Owner]-Rel > 1,000 and <= 3,000) set Portfolio-

| | |
|---|---|
| W2[Standard] | [Owner] = 2 |

if (S[Standard][Owner]-Rel > 3,000 and <= 6,000) set Portfolio-

| | |
|---|---|
| W2[Standard] | [Owner] = 3 |

if (S[Standard][Owner]-Rel > 6,000) set Portfolio-

W2[Standard][Owner] = 4

determine Portfolio-W3[Standard][Owner]

determine S-LR[default][owner]-Rel

calculate S-LR[Standard][Owner]-Rel : S[Standard][Owner]-Rel
set Portfolio-W3[default][owner] >= 0 and <= 10

determine Portfolio-W4[Standard][Owner]

set Portfolio-W4[default][owner] >= 0 and <= 10
calculate Portfolio-W1[Standard][Owner] × Portfolio-W2[Standard][Owner]) +
Portfolio-W3[Stand- ard][Owner] + Portfolio-W4[Standard][Owner]
set Portfolio[Standard][Owner]-KA >= 2 and <= 120
if Portfolio[Standard][Owner]-KA <= 40 set V-KA[Standard][Owner] = 0
else determine Rank[Standard][Owner]-KA
if Rank[Standard][Owner]-KA >= 6 set V-KA[Standard][Owner] = 0
else determine V-KA[default][owner]
calculate V[Standard]-KA × {(4 − Rank[Standard][Owner]-KA) : 15}
set V-KA[default][owner]
determine SEP Y-VKA

if SEP Y-VGA = 0 and/or S[Standard]-Fail = TRUE set SEP-VKA = 0
else calculate V-KA[Standard][Owner] : S[Standard][Owner]-Rel
set SEP-Y VKA

### Step 3: Calculation of the SEP Value (SEP Y-V)

determine SEP Y-V

calculate SEP Y-VGA + SEP Y-VKA
set SEP Y-V

This enables the license owed during the valuation interval for the use of the SEP portfolio of a specific holder to be specifically determined, reproduced as a unit license amount in a specific currency, and finally settled.

If the licensed object is produced and distributed by several companies in a (usually global⁶⁸³) value-added and distribution chain, the question may arise in practice where and how the calculated royalty arises within the value-added chain. This is because every economic operator within a value chain has its own right to access the result of standardisation by granting a license under FRAND conditions. In⁶⁸⁴ TQ Delta v Zyxel, the England and Wales Court of Appeal also grants every company within the distribution chain a claim to licensing, even if the manufacturer/distributor declares that he does not (any longer) apply for a license under FRAND conditions—for a certain patent.^{685 686} ⁶⁸³ BeckOKPatR/Pitz, PatG, § 139, no. 156.⁶⁸⁴ Instruktiv Kühnen, GRUR 2019, 665 [666]; For the reference value of the license in the value chain, cf. in detail § 21 Section 111.1.⁶⁸⁵ These considerations should also apply if the manufacturer/supplier refuses to license an entire portfolio.⁶⁸⁶ EWCA, Dec. v. 18 Jul. 2019, Az. [2019] EWCA Civ 1277, Rz. 53.

If one understands the exploitation chain with Kühnen as a unit within which the fee is incurred only once—but in full at each stage and with⁶⁸⁷ an “exhaustion” effect under antitrust law —, the passing cost item and the extent of the effect of the payment of the fee could be recorded automatically and stored in the blockchain in a counterfeit-proof manner. In practice, for example, the defence argument could be substantiated in an infringement suit that⁶⁸⁸ concrete challenged embodiments were⁶⁸⁹ lawfully produced and/or marketed with the consent of the owner of the intellectual property right. The Blockchain Strategy of the Federal Government published on 18 Sep. 2019 explicitly stipulates that it is to be examined whether Blockchain technology can be admitted as evidence in civil proceedings.⁶⁹⁰ ⁶⁸⁷ Kühnen, GRUR 2019, 665 [671] f.⁶⁸⁸ Hohn-Hein/Barth, GRUR 2018, 1089 [1094]; in China secured data in the blockchain have meanwhile been admitted as evidence in court, cf. Andrieux, medium.com and https://egal-patent.com/intemational-intellectual-property/blockchain-based-evidence-approved-china/ (retrieved on 27 Nov. 2019); see also § 18.⁶⁸⁹ which may have to be simulated under antitrust law following Kühnen's approach.⁶⁹⁰ Blockchain Strategy of the Federal Government of 18 Sep. 2019, p. 13, available at: https://www.bmwi.de/Redaktion/DE/Publikationen/Digitale-Welt/blockchain-strategie.pdf?__blob=publicationFile=10 (accessed on 27 Nov. 2019).

If the exploitation chain is also stored in the system, double payments within the exploitation chain could be reliably excluded in the future and a recourse mechanism or distribution key for the license fee could be provided for within the exploitation chain. It is conceivable, for example, to break it down according to value added shares.

For future developments, the aspect of territorial linking of user action and regional validation of portfolio patents in particular still offers considerable potential.

Once the necessary interfaces have been created between the goods collection systems of manufacturers or distributors and the sensitive data on the territorial distribution routes of individual products can be exchanged in an appropriate way in anonymised form, it is conceivable that the SEP assessment could be more precisely territorialised. For the traceability of the licensed product, Kurtz proposes to use the IMEI numbers of smartphones.⁶⁹¹ The near-field communication technologies RFID and NFC are also likely to be considered in the future in order to make the licensed object sufficiently individual and territorially traceable. ⁶⁹¹ Kurtz, GRUR-Prax 2019, 91st place

This approach, however, requires further consideration of the legal framework to be applied to compensation,⁶⁹² the value of individual acts of use and how this can be subsumed separately for each country with low transaction costs. For example, Article 28 of the TRIPS Agreement, which is an international agreement between the members of the World Trade Organisation (WTO), currently comprising 164 states⁶⁹³, associations of states⁶⁹⁴ and special administrative zones, offers a common international definition of the “act of use” subject to licensing.⁶⁹⁵ In order to become a WTO member, the aspirant member must ratify the TRIPS Agreement.⁶⁹⁶ The TRIPS Agreement therefore applies in over 83% of the 193 Member States of the United Nations (UN). The TRIPS Agreement thus covers an overwhelming proportion of the world's national territories and establishes a common minimum level of protection. ⁶⁹² Nieder, GRUR 2018, 666 [668] offers first considerations on this subject.⁶⁹³ Current list of members available at https://de.wikipedia.org/wiki/Liste_der_Mitgliedstaaten_der_WTO (accessed 27 Nov. 2019).⁶⁹⁴ For example, the European Union is itself a territorial member of the WTO, see Article 1 of the Council Decision of 22 Dec. 1994 concerning the conclusion on behalf of the European Community, as regards matters within its competence, of the agreements reached in the Uruguay Round multilateral negotiations (1986-1994), OJ No L 336 of 23 Dec. 1994, p. 1 et seq.⁶⁹⁵ Hong Kong and Macao are themselves WTO members.⁶⁹⁶ Art. III para. 2 and Art. XII para. 1 p. 2 of the Agreement establishing the World Trade Organisation (WTO); the text of the Agreement is published in BGBl. II/1994, p. 1443 ff. [English] or 1625 ff. The TRIPS Agreement is listed in Annex 1 as Annex 1C (BGBL. II/1994, p. 1761).

Pursuant to Article 28(1) of the TRIPs Agreement, a patent grants its proprietor the following exclusive rights:
In the case of product claims, the patentee may prohibit third parties from manufacturing, using, offering for sale, selling or importing the product for these purposes (lit. a).
In the case of procedural claims, the patentee may prohibit third parties from using, offering for sale, selling or importing for such purposes at least the product obtained directly by the process (lit. b).

In practice, several user actions typically coincide. For example, products are offered for sale and subsequently sold as part of a domestic distribution activity. If they have previously been manufactured in Germany—possibly with additional use of a procedural right—or imported for sale in Germany, the products undergo three consecutive acts of use. Although in practice billing has not usually differentiated between user actions,⁶⁹⁷ not every user within a value chain (which typically forms⁶⁹⁸ a user chain in a globalized world) uses protected teaching with the same intensity. ⁶⁹⁷ In Unwired Planet v Huawei it is undisputed that only “products sold” should be invoiced, cf. EWHC, Entsch. v. 5 Apr. 2017, Az. [2017] EWHC 711 (Pat), Rz. 593.⁶⁹⁸ BeckOKPatR/Pitz, PatG, § 139, no. 156; see also § 21 Section § 21111. § 21111.1 and § 16.

Traditionally, the claim types (product and process claim) are divided into the following usage categories:
(1)⁶⁹⁹ Product claims concern the categories “manufacture”, “distribution” and “use” of the protected product as well as of the direct process product—whereby the category “use” is generally of no practical relevance in the⁷⁰⁰ case of claims directed to products because of the principle of exhaustion.^{701 702} ⁶⁹⁹ The device requirements also include system requirements, see BPatG, Beschl. v. 28 Aug. 2006, 9 W (pat) 16/04, p. 10=BIPMZ 2007, 285—Antriebsvorrichtung.⁷⁰⁰ On procedural claims, cf. BGH, judgment v. v. 24 Sep. 1979, KZR 14/78=GRUR 1980,38—Full plastic procedure.⁷⁰¹ See Art. 6 of the TRIPS Agreement.⁷⁰² Osterrieth, Rz. 694 ff.
(2) Process claims concern the categories “distribution” and “use” of the protected process (as well as of the direct process product).

If, in future, a distinction is to be made between different categories, it will also be necessary to analyse what value the categories of use have in relation to each other⁷⁰³. Aspects such as the indirect use of a patent for alternative non-infringing uses,⁷⁰⁴ the demarcation between the manufacture and repair of a device⁷⁰⁵ and the interesting question as to whether in future the fundamental objective suitability of a device⁷⁰⁶—irrespective of the question of its specific purpose—is still sufficient for the assumption of an act of use⁷⁰⁷ must also be taken into consideration at this level of assessment. ⁷⁰³ For the assessment of a claim for damages according to the method of license analogy, the Düsseldorf Higher Regional Court has shown, for example, that the claim for the use of a device does not in principle have to be higher than the claim for the manufacture of the device, see OLG Düsseldorf, Urt. v. 29 Oct. 1981, 2 U 4/81=GRUR 1982, 35, 37—Plastic hoses.⁷⁰⁴ Kühnen, Kap. A, Rz. 449 ff. m.w.N.⁷⁰⁵ Kühnen, Chap. E, Rz. 627 ff. m.w.N.⁷⁰⁶ Kühnen, Kap. A, Rz. 110 m.V.a. BGH, Urt. v. 13 Dec. 2005, X ZR 14/02=GRUR 2006, 399 [401]—shunting trolley.⁷⁰⁷ Considerations in this regard in OLG Düsseldorf, Urt. v. 19 Feb. 2015, I-15 U 39/14=GRUR-RR 2016, 97—Primary encryption logic.

It is likely to be a challenge in the future to create such a finely calibrated valuation system, which at the same time produces industry-wide accepted results and can operate with at most the same transaction cost burden as the basic system proposed in this paper.

The parforce ride in § 21 shows that a whole series of central decisions regarding the calculation of FRAND licenses are still controversial in practice. The proposed solutions are primarily based on the dogma of avoiding transaction costs and provide a consistent solution within the existing regulatory framework.

On this basis an exemplary calculation methodology was developed in § 22, which is suitable as basis for an automated calculation and administration of FRAND licenses on the basis of already available data.

The calculation example in § 23 shows which steps the valuation algorithm could follow and how in individual cases a portfolio license fee and the value of an individual patent could be calculated. The portfolio royalty owed is the amount accrued for a specified time interval for the worldwide use of the SEP portfolio of a specified holder for a specified standard. The value of the individual SEP is only a summand. Nevertheless, the fundamental possibility of assigning a concrete monetary value to a SEP for a certain period of time in practice opens up a bouquet of further economic exploitation possibilities for the SEP concerned. Licensing is only an economic possibility of exploitation.

Due to the individual valuation of patents, it appears possible to⁷⁰⁸ use them as collateral for loans. The lender has a concrete countervalue as collateral. With the newly opened access to the SEP as an intangible asset, the SEP holder can bridge short-term liquidity bottlenecks and is more able to act on the market than competitors without their own portfolio due to its IP portfolio.

The problem area identified in Unwired Planet v Huawei, namely that a SEP holder remains bound to the licensing practice of his predecessor in principle because of the prohibition of discrimination as long as old contracts are still in force, is also⁷⁰⁹ mitigated if a concrete value can be attributed to the individual patents transferred. The new holder can then explain in a comprehensible manner how he has incorporated the newly acquired patents into his licensing practice in a non-discriminatory manner.⁷¹⁰ The conflict of objectives between individual contract design and administration and the avoidance of transaction costs in FRAND licensing is a matter of concern to courts worldwide, especially since the decision of the European Court of Justice in Huawei v ZTE. The SEP holders and implementation companies active in the licensing market for essential patents have been trying for decades to master the phenomenon of transaction costs through contractual regulation approaches. There is a widespread approach in the industry to agreeing on flat rates for potentially transaction cost-intensive regulatory complexes. Now, the SEP licensing industry is trying to cautiously address the changes brought about by case law and the competition authorities and integrate them into its licensing practice. In practice, this has led to an environment in which essential patents can only be enforced in court with an immense amount of effort. ⁷⁰⁸ On the previous practical adversities, see Haedicke/Timmann, § 1, margin no. 227.⁷⁰⁹ OLG Düsseldorf, Urt. v. 22 Mar. 2019, I-2 U 31/16, margin no. 203 et seq., in particular margin no. 212=GRUR 2019, 725—Improving Handovers; Vetter, GRUR 2019, 704 [706]; for more details see § 10 Section II.2 and § 21 Section I; Hauck, W R P 2013, 1446; Haedicke/Timmann, § 1, margin no. 222 provides possible background for the transfer of a portfolio.⁷¹⁰ OLG Düsseldorf, Urt. v. 22 Mar. 2019, I-2 U 31/16, marginal 216=GRUR 2019, 725—Improving Handovers; cousin, GRUR 2019, 704 [706].

The commercial enterprises operating in practice do not demand an “unassailable” FRAND license fee in every respect, but want to see their interests reflected in the license conditions and need the necessary legal certainty for their licensing practice or license acceptance decisions in order to be able to make entrepreneurial decisions—for example in product development and placement—as reliably and calculably as possible. The aim is to minimise transaction costs and maintain existing efficiency gains.

The two goals can be achieved without compromise if the license rate calculation, the necessary patent evaluation and the license contract administration following the conclusion of the contract are carried out under the supervision of a professional committee and through an open evaluation algorithm using exponential technologies in the field of information technology.

As already announced in the introduction to this paper, the evaluation mechanism presented in this paper is certainly not perfect in every respect and can certainly be criticised. Its decisive advantage, however, is that it is legally and technically feasible with today's equipment and does not have to remain an academic utopia. In the meantime, technical development has progressed so far that self-executing contracts can operate independently on the basis of databases, which in turn are forgery-proof through the use of block-chain technology and approach the status of a public register. The transparency and flexibility created by these technologies is particularly beneficial for SMEs, which, due to the low transaction costs, achieve a better contractual result than they could in real contract negotiations with their limited resources. In addition, the high level of detail of the evaluation mechanism (granularity of consideration) creates new possibilities for exploiting individual patents—e.g. use as collateral for loans—and improves or maintains the marketability of SEP despite the binding nature of the FRAND commitment.

It is explicitly mentioned in several places in the work that corrections and improvements can of course be made in the ongoing operation of the licensing system in order to improve the evaluation concept and (even) to adapt it more closely to market conditions. This conclusion should therefore at the same time be an invitation to interested circles to follow the path of the future and to take up the points of discussion in this work and to submit proposals for solutions.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof, the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

While the present invention has been described with reference to one or more preferred embodiments, which embodiments have been set forth in considerable detail for the purposes of making a complete disclosure of the invention, such embodiments are merely exemplary and are not intended to be limiting or represent an exhaustive enumeration of all aspects of the invention.

The scope of the invention, therefore, shall be defined solely by the following claims. Further, it will be apparent to those of skill in the art that numerous changes may be made in such details without departing from the spirit and the principles of the invention.

In the foregoing specification, the invention has been described with reference to specific examples of embodiments of the invention. It will, however, be evident that various modifications and changes may be made therein without departing from the broader spirit and scope of the invention as set forth in the appended claims.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Any reference to “having”, “including” or “comprising” should be applied mutatis mutandis to “consisting” and/or “consisting essentially of”

What is claimed is:

1. A method of operating an apparatus that is configured to manage a licensable item, comprising:
determining a first fair and reasonable license term and a second fair and reasonable license term;
accessing a licensing policy related to whether an action is permitted to be taken with the licensable item and if said action is in accord with said first fair and reasonable license term and in accord with said second fair and reasonable license term, and wherein the licensing policy corresponds to a client version of a license for the licensable item that is maintained on the apparatus and is configured to be synchronized with a server version of the license for the licensable item that is maintained on a server; making a determination, by a license agent, first attempt to communicate, by the apparatus, with the server in order to synchronize the client and server versions of the license before acting to enforce the licensing policy for the action;
attempting to communicate, by the apparatus, with the server in order to synchronize the client and server versions of the license before acting to enforce the licensing policy for the action in response to the determination to first attempt to communicate with the server in order to synchronize the client and server versions of the license before acting to enforce the licensing policy for the action, wherein synchronization of the client and server versions of the license produces a synchronized client version of the license by updating the client version of the license to include one or more changes made to one or more licensing policies in the server version of the license that occurred after a previous synchronization of the client version of the license with the server version of the license; and
enforcing the licensing policy for the action based on the non-synchronized version of the license in response to the attempt to communicate by the apparatus with the server being unsuccessful, wherein accessing the licensing policy includes accessing a first licensing policy related to a first licensable item in a first runtime and accessing a second licensing policy related to a second licensable item in a second runtime, and wherein enforcing the licensing policy includes enforcing the first licensing policy for the first licensable item executed in the first runtime and enforcing the second licensing policy for the second licensable item executed in the second runtime, and then making available said server versions of the license available to third party databases for transacting commercial activity including buying and selling said server versions of said license and providing licenses pertaining to said server versions of said licenses to third parties and in turn payment for said licenses to holders said server versions of said licenses.

2. The method of claim 1, wherein accessing the licensing policy includes accessing an enforcement rule associated with the licensing policy, and wherein enforcing the licensing policy includes determining a constraint imposed by the enforcement rule on the action taken with the licensable item.

3. The method of claim 1, wherein the action is providing a license to a third party in response to a device controlled by said third party automatically requesting said license.

4. The method according to claim 1, wherein the server version of the license is maintained as a record on the basis of distributed ledger technology.

5. The method according to claim 2, wherein the server version of the license is maintained as a record on the basis of distributed ledger technology.

6. The method according to claim 3, wherein the server version of the license is maintained as a record on the basis of distributed ledger technology.

7. An apparatus for managing a licensable item, comprising:
at least one processing circuit configured to:
access a licensing policy related to whether an action is permitted to be taken with the licensable item, wherein the licensing policy corresponds to a client version of a license for the licensable item that is maintained on the apparatus and is configured to be synchronized with a server version of the license for the licensable item that is maintained on a server;
make a determination to first attempt to communicate with a server in order to synchronize the client and server versions of the license before acting to enforce the licensing policy for the action;
attempt to communicate with a server in order to synchronize the client and server versions of the license before acting to enforce the licensing policy for the action in response to the determination to first attempt to communicate with a server in order to synchronize the client and server versions of the license before acting to enforce the licensing policy for the action, wherein synchronization of the client and server versions of the license produces a synchronized client version of the license by updating the client version of the license to include one or more changes made to one or more licensing policies in the server version of the license that occurred after a previous synchronization of the client version of the license with the server version of the license; and
enforce the licensing policy for the action based on the non-synchronized version of the license in response to the attempt to communicate by the apparatus with a server being unsuccessful, wherein the at least one processing circuit is configured to access the licensing policy by accessing a first licensing policy related to a first licensable item in a first runtime and accessing a second licensing policy related to a second licensable item in a second runtime, and wherein the at least one processing circuit is configured to enforce the licensing policy by enforcing the first licensing policy for the first licensable item executed in the first runtime and enforcing of the second licensing policy for the second licensable item executed in the second runtime, and wherein first and second fair and reasonable license terms are established and included within said server versions of said licenses.

8. The apparatus according to claim 7, wherein the licensing policy includes accessing an enforcement rule associated with the licensing policy, and wherein enforcing the licensing policy includes determining a constraint imposed by the enforcement rule on the action taken with the licensable item.

9. The apparatus of claim 7, wherein a license is provided to a third party in response to a device controlled by said third party automatically requesting said license.

10. The apparatus according to claim 7, wherein the server version of the license is maintained as a record on the basis of distributed ledger technology.

11. The apparatus according to claim 8, wherein the server version of the license is maintained as a record on the basis of distributed ledger technology.

12. The apparatus according to claim 9, wherein the server version of the license is maintained as a record on the basis of distributed ledger technology.
